(19) United States
(12) Patent Application Publication
(10) Pub. No.: US 2020/0311559 A1
(43) Pub. Date: Oct. 1, 2020

(54) OPTIMIZED DECISION TREE MACHINE LEARNING FOR RESOURCE-CONSTRAINED DEVICES

(71) Applicants: Rita Chattopadhyay, Chandler, AZ (US); Rajesh Bansal, Sengkang (SG); Yuming Ma, Portland, OR (US); Mrittika Ganguli, Chandler, AZ (US)

(72) Inventors: Rita Chattopadhyay, Chandler, AZ (US); Rajesh Bansal, Sengkang (SG); Yuming Ma, Portland, OR (US); Mrittika Ganguli, Chandler, AZ (US)

(21) Appl. No.: 16/902,063

(22) Filed: Jun. 15, 2020

Related U.S. Application Data
(63) Continuation-in-part of application No. 15/628,123, filed on Jun. 20, 2017, now Pat. No. 10,685,081.

(51) Int. Cl. G06N 5/00; G06N 5/04; G06N 20/00

(52) U.S. Cl. CPC G06N 5/003; G06N 20/00; G06N 5/04

(57) ABSTRACT

In one embodiment, an edge computing device for performing decision tree training and inference includes interface circuitry and processing circuitry. The interface circuitry receives training data and inference data that is captured, at least partially, by sensor(s). The training data corresponds to a plurality of labeled instances of a feature set, and the inference data corresponds to an unlabeled instance of the feature set. The processing circuitry: computes a set of feature value checkpoints that indicate, for each feature of the feature set, a subset of potential feature values to be evaluated for splitting tree nodes of a decision tree model; trains the decision tree model based on the training data and the set of feature value checkpoints; and performs inference using the decision tree model to predict a target variable for the unlabeled instance of the feature set.

### CROSS-REFERENCE TO RELATED APPLICATIONS

This patent application is a continuation-in-part of U.S. patent application Ser. No. 15/628,123, filed on Jun. 20, 2017, and entitled “OPTIMIZED DATA DISCRETIZATION,” the contents of which are hereby expressly incorporated by reference.

### FIELD OF THE SPECIFICATION

This disclosure relates in general to the field of artificial intelligence and machine learning, and more particularly, though not exclusively, to optimized decision tree machine learning for resource-constrained devices.

### BACKGROUND

Machine learning algorithms are widely used for a variety of applications and use cases. However, due to the demanding compute and memory requirements of machine learning algorithms, along with the quality of service and latency requirements of many applications and use cases, it can be challenging to implement machine learning algorithms on resource-constrained devices, such as edge computing devices.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates a schematic diagram of an example computing system in accordance with certain embodiments.

FIG. 2 illustrates an example of data discretization.

FIG. 3 illustrates a block diagram for an example embodiment of optimized data discretization.

FIG. 4 illustrates a flowchart for an example embodiment of optimized data discretization.

FIGS. 5A-E provide a comparison of various data discretization approaches in a variety of use cases.

FIG. 6 illustrates an example embodiment of an electronic device with data discretization functionality.

FIG. 7 illustrates an example embodiment of an edge device with an optimized decision tree machine learning (ML) engine.

FIGS. 8A-B illustrate an overview of a random forest machine learning (ML) algorithm.

FIGS. 9A-C illustrate an example of using automated data binning to compute feature value checkpoints for training a decision tree model.

FIG. 10 illustrates a process flow for efficiently training a random forest machine learning (ML) model in accordance with certain embodiments.

FIG. 11 illustrates an example embodiment of an artificial intelligence (AI) accelerator implemented with an optimized decision tree machine learning (ML) engine.

FIGS. 12A-G illustrate a performance comparison of an optimized random forest versus a traditional random forest.

FIG. 13 illustrates a flowchart for performing decision tree training and inference in accordance with certain embodiments.

FIG. 14 illustrates an example edge computing environment in accordance with various embodiments.

FIG. 15 illustrates an example arrangement of interconnections between Internet and IoT networks in accordance with various embodiments.

FIG. 16 illustrates an example domain topology for multiple interconnected IoT networks in accordance with various embodiments.

FIG. 17 illustrates an example of a cloud computing network in communication with multiple IoT devices in accordance with various embodiments.

FIG. 18 illustrates an example of a cloud computing network in communication with a mesh network of IoT devices at the edge in accordance with various embodiments.

FIG. 19 illustrates an example of a computing platform in accordance with various embodiments.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Optimized Data Discretization and Binning

Data analytics has a wide range of applications in computing systems, from data mining to machine learning and artificial intelligence, and has become an increasingly important aspect of large-scale computing applications. Data preprocessing, an important initial step in data analytics, involves transforming raw data into a suitable format for further processing and analysis. For example, real-world or raw data is often incomplete, inconsistent, and/or error prone. Accordingly, raw data may go through a series of preprocessing steps, such as data cleaning, integration, transformation, reduction, and/or discretization or quantization. Data discretization, for example, may involve converting or partitioning a range of continuous raw data into a smaller number of intervals or values. For example, data binning is a form of data discretization that involves grouping a collection of continuous values into a smaller number of “bins” that each represent a particular interval or range. The original data values may each be grouped into a defined interval or bin, and thus may be replaced by a value representative of that interval or bin, such as a center or boundary value of the interval. As an example, a collection of data identifying the age of a group of people may be binned into a smaller number of age intervals. In this manner, the raw data values are aggregated and the size of the dataset is reduced, and the resulting binned dataset may then be used for further analysis and processing, such as for data mining or machine learning and artificial intelligence (e.g., computer vision, autonomous navigation, computer or processor optimizations, speech and audio recognition, natural language processing). A histogram is an example of data binning that may be used for analyzing the underlying data distribution of the raw data. A histogram, for example, may be a representation of a data distribution that provides an estimate of the probability distribution of a continuous variable. A histogram may be represented in various forms, such as a data structure and/or a graphical representation. Moreover, a histogram may be constructed, for example, by “binning” a range of values into a series of smaller intervals, and then counting the number of values in each bin or interval. Histograms are powerful tools for categorizing or discretizing real-world data for further processing and analysis.

A significant challenge of data discretizing and binning is selecting the optimal bin size, such as a bin size that is sufficiently large but also preserves the original data distribution. For example, a binned dataset or histogram should provide meaningful binning of data into fewer categories for efficient data correlation and association (e.g., as required for many data mining and/or machine learning techniques), while also accurately representing the original data distribution. For advanced data processing techniques (e.g., clustering and pattern matching for data mining and/or machine learning purposes), it may be ideal for raw data to be binned into fewer bins with a larger bin size, as that may result in the raw data being summarized into meaningful segments, which may be particularly beneficial for datasets that span a large range of data and/or contain a large volume of data samples. On the other hand, however, decreasing the number of bins, and thus increasing the bin size, may cause the histogram or binned dataset to deviate from the inherent data distribution of the original raw dataset. Thus, the bin size should not be so small that the histogram loses its purpose, but should not be so large that the histogram significantly deviates from the original data distribution. Accordingly, determining the optimal bin size or bin width for performing data discretization and binning may be challenging.

Many approaches to selecting a bin size for data discretization and binning suffer from various drawbacks. For example, the bin size could be determined arbitrarily, but an arbitrary bin size may fail to provide a meaningful summarization of data and/or may fail to preserve the original data distribution, thus reducing overall performance. As another example, the bin size could be determined manually, but a manual approach can be a tedious and daunting task and may be prone to error. As another example, the bin size could be determined using certain formulas, such as the Freedman-Diaconis formula. However, those formulas often result in bin sizes that are too small to provide a meaningful summarization of data, and thus are not very useful for practical purposes, particularly when the dataset covers a large range of data and when developing a meaningful histogram is crucial to the success of the subsequent data processing methods (e.g., data mining and machine learning).

Accordingly, this disclosure describes various embodiments for selecting an optimal bin size for data discretization and binning. The described embodiments can be used to identify a bin size that provides a meaningful categorization or summarization of raw data without significantly deviating from the original data distribution. For example, the optimal bin size may be large enough to provide a meaningful summarization of the raw data, but small enough to preserve the original data distribution. In this manner, the described embodiments provide an optimal balance between these competing factors. Moreover, the described embodiments can be used to automatically discretize or bin data in a manner that is optimal for subsequent processing and analysis. Accordingly, the described embodiments can be used to improve the performance of large-scale applications or solutions (e.g., Internet-of-Things (IoT) applications) that depend on advanced data processing techniques, such as data mining, cognitive learning, machine learning, associative memory techniques, and artificial intelligence (e.g., using artificial neural networks), among other examples. Moreover, by automating the data discretization and binning process, the described embodiments reduce the analytics development time and the time-to-market for analytics applications. Finally, because the described embodiments are also computationally efficient, they are optimal even for resource-constrained devices (e.g., edge devices).

The described embodiments are particularly beneficial for use cases where developing a meaningful histogram is crucial to the success of the subsequent data processing methods, such as data mining or machine learning and artificial intelligence (e.g., computer vision, autonomous navigation, computer or processor optimizations, associative memory, speech and audio recognition, natural language processing). As an example, the described embodiments can be utilized with associative memory techniques that track co-occurrences of data values or data elements in order to identify associations and relationships between them.

Example embodiments that may be used to implement the features and functionality of this disclosure will now be described with more particular reference to the attached FIGURES.

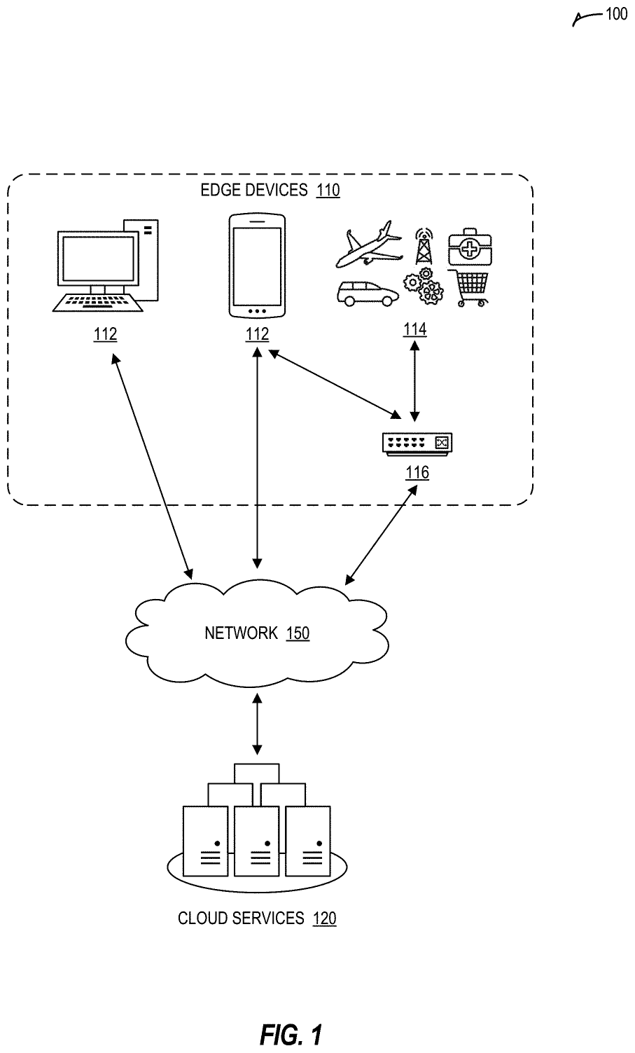

FIG. 1 illustrates a schematic diagram of an example computing system 100. In various embodiments, system 100 and/or its underlying components may include functionality described throughout this disclosure for performing data discretization and binning using an optimal bin size. For example, data discretization functionality may be used in system 100 for a wide range of applications and/or use cases, from data mining to machine learning and artificial intelligence, among other examples. Moreover, data discretization functionality may be implemented by any component of system 100, such as edge devices 110, cloud services 120, and communications network 150. These various components of system 100, for example, could be implemented with data discretization functionality using optimal bin sizes, as described further throughout this disclosure in connection with the remaining FIGURES.

The various components in the illustrated example of computing system 100 will now be discussed further below.

Edge devices 110 may include any equipment and/or devices deployed or connected near the “edge” of a communication system 100. In the illustrated embodiment, edge devices 110 include end-user devices 112 (e.g., desktops, laptops, mobile devices), Internet-of-Things (IoT) devices 114, and gateways and/or routers 116, among other examples. Edge devices 110 may communicate with each other and/or with other remote networks and services (e.g., cloud services 120) through one or more networks and/or communication protocols, such as communication network 150. Moreover, in some embodiments, certain edge devices 110 may include the data discretization functionality described throughout this disclosure.

End-user devices 112 may include any device that enables or facilitates user interaction with computing system 100, including, for example, desktop computers, laptops, tablets, mobile phones and other mobile devices, and wearable devices (e.g., smart watches, smart glasses, headsets), among other examples.

IoT devices 114 may include any device capable of communicating and/or participating in an Internet-of-Things (IoT) system or network. IoT systems may refer to new or improved ad-hoc systems and networks composed of multiple different devices (e.g., IoT devices 114) interoperating and synergizing for a particular application or use case. Such ad-hoc systems are emerging as more and more products and equipment evolve to become “smart,” meaning they are controlled or monitored by computer processors and are capable of communicating with other devices. For example, an IoT device 114 may include a computer processor and/or communication interface to allow interoperation with other components of system 100, such as with cloud services 120 and/or other edge devices 110. IoT devices 114 may be “greenfield” devices that are developed with IoT capabilities from the ground-up, or “brownfield” devices that are created by integrating IoT capabilities into existing legacy devices that were initially developed without IoT capabilities. For example, in some cases, IoT devices 114 may be built from sensors and communication modules integrated in or attached to “things,” such as equipment, toys, tools, vehicles, living things (e.g., plants, animals, humans), and so forth. Alternatively, or additionally, certain IoT devices 114 may rely on intermediary components, such as edge gateways or routers 116, to communicate with the various components of system 100.

IoT devices 114 may include various types of sensors for monitoring, detecting, measuring, and generating sensor data and signals associated with characteristics of their environment. For instance, a given sensor may be configured to detect one or more respective characteristics, such as movement, weight, physical contact, biometric properties, temperature, wind, noise, light, position, humidity, radiation, liquid, specific chemical compounds, battery life, wireless signals, computer communications, and bandwidth, among other examples. Sensors can include physical sensors (e.g., physical monitoring components) and virtual sensors (e.g., software-based monitoring components). IoT devices 114 may also include actuators to perform various actions in their respective environments. For example, an actuator may be used to selectively activate certain functionality, such as toggling the power or operation of a security system (e.g., alarm, camera, locks) or household appliance (e.g., audio system, lighting, HVAC appliances, garage doors), among other examples.

Indeed, this disclosure contemplates use of a potentially limitless universe of IoT devices 114 and associated sensors/actuators. IoT devices 114 may include, for example, any type of equipment and/or devices associated with any type of system 100 and/or industry, including transportation (e.g., automobile, airlines), industrial manufacturing, energy (e.g., power plants), telecommunications (e.g., Internet, cellular, and television service providers), medical (e.g., healthcare, pharmaceutical), food processing, and/or retail industries, among others. In the transportation industry, for example, IoT devices 114 may include equipment and devices associated with aircrafts, automobiles, or vessels, such as navigation systems, autonomous flight or driving systems, traffic sensors and controllers, and/or any internal mechanical or electrical components that are monitored by sensors (e.g., engines). IoT devices 114 may also include equipment, devices, and/or infrastructure associated with industrial manufacturing and production, shipping (e.g., cargo tracking), communications networks (e.g., gateways, routers, servers, cellular towers), server farms, electrical power plants, wind farms, oil and gas pipelines, water treatment and distribution, wastewater collection and treatment, and weather monitoring (e.g., temperature, wind, and humidity sensors), among other examples. IoT devices 114 may also include, for example, any type of “smart” device or system, such as smart entertainment systems (e.g., televisions, audio systems, videogame systems), smart household or office appliances (e.g., heat-ventilation-air-conditioning (HVAC) appliances, refrigerators, washers and dryers, coffee brewers), power control systems (e.g., automatic electricity, light, and HVAC controls), security systems (e.g., alarms, locks, cameras, motion detectors, fingerprint scanners, facial recognition systems), and other home automation systems, among other examples. IoT devices 114 can be statically located, such as mounted on a building, wall, floor, ground, lamppost, sign, water tower, or any other fixed or static structure. IoT devices 114 can also be mobile, such as devices in vehicles or aircrafts, drones, packages (e.g., for tracking cargo), mobile devices, and wearable devices, among other examples. Moreover, an IoT device 114 can also be any type of edge device 110, including end-user devices 112 and edge gateways and routers 116.

Edge gateways and/or routers 116 may be used to facilitate communication to and from edge devices 110. For example, gateways 116 may provide communication capabilities to existing legacy devices that were initially developed without any such capabilities (e.g., “brownfield” IoT devices). Gateways 116 can also be utilized to extend the geographical reach of edge devices 110 with short-range, proprietary, or otherwise limited communication capabilities, such as IoT devices 114 with Bluetooth or ZigBee communication capabilities. For example, gateways 116 can serve as intermediaries between IoT devices 114 and remote networks or services, by providing a front-haul to the IoT devices 114 using their native communication capabilities (e.g., Bluetooth, ZigBee), and providing a back-haul to other networks 150 and/or cloud services 120 using another wired or wireless communication medium (e.g., Ethernet, Wi-Fi, cellular). In some embodiments, a gateway 116 may be implemented by a dedicated gateway device, or by a general purpose device, such as another IoT device 114, end-user device 112, or other type of edge device 110.

In some instances, gateways 116 may also implement certain network management and/or application functionality (e.g., IoT management and/or IoT application functionality for IoT devices 114), either separately or in conjunction with other components, such as cloud services 120 and/or other edge devices 110. For example, in some embodiments, configuration parameters and/or application logic may be pushed or pulled to or from a gateway device 116, allowing IoT devices 114 (or other edge devices 110) within range or proximity of the gateway 116 to be configured for a particular IoT application or use case.

Cloud services 120 may include services that are hosted remotely over a network 150, or in the “cloud.” In some embodiments, for example, cloud services 120 may be remotely hosted on servers in datacenter (e.g., application servers or database servers). Cloud services 120 may include any services that can be utilized by or for edge devices 110, including but not limited to, data storage, computational services (e.g., data analytics, searching, diagnostics and fault management), security services (e.g., surveillance, alarms, user authentication), mapping and navigation, geolocation services, network or infrastructure management, IoT application and management services, payment processing, audio and video streaming, messaging, social networking, news, and weather, among other examples. Moreover, in some embodiments, certain cloud services 120 may include the data discretization functionality described throughout this disclosure.

Network 150 may be used to facilitate communication between the components of computing system 100. For example, edge devices 110, such as end-user devices 112 and IoT devices 114, may use network 150 to communicate with each other and/or access one or more remote cloud services 120. Network 150 may include any number or type of communication networks, including, for example, local area networks, wide area networks, public networks, the Internet, cellular networks, Wi-Fi networks, short-range networks (e.g., Bluetooth or ZigBee), and/or any other wired or wireless networks or communication mediums.

Any, all, or some of the computing devices of system 100 may be adapted to execute any operating system, including Linux or other UNIX-based operating systems, Microsoft Windows, Windows Server, MacOS, Apple iOS, Google Android, or any customized and/or proprietary operating system, along with virtual machines adapted to virtualize execution of a particular operating system.

While FIG. 1 is described as containing or being associated with a plurality of elements, not all elements illustrated within system 100 of FIG. 1 may be utilized in each alternative implementation of the present disclosure. Additionally, one or more of the elements described in connection with the examples of FIG. 1 may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

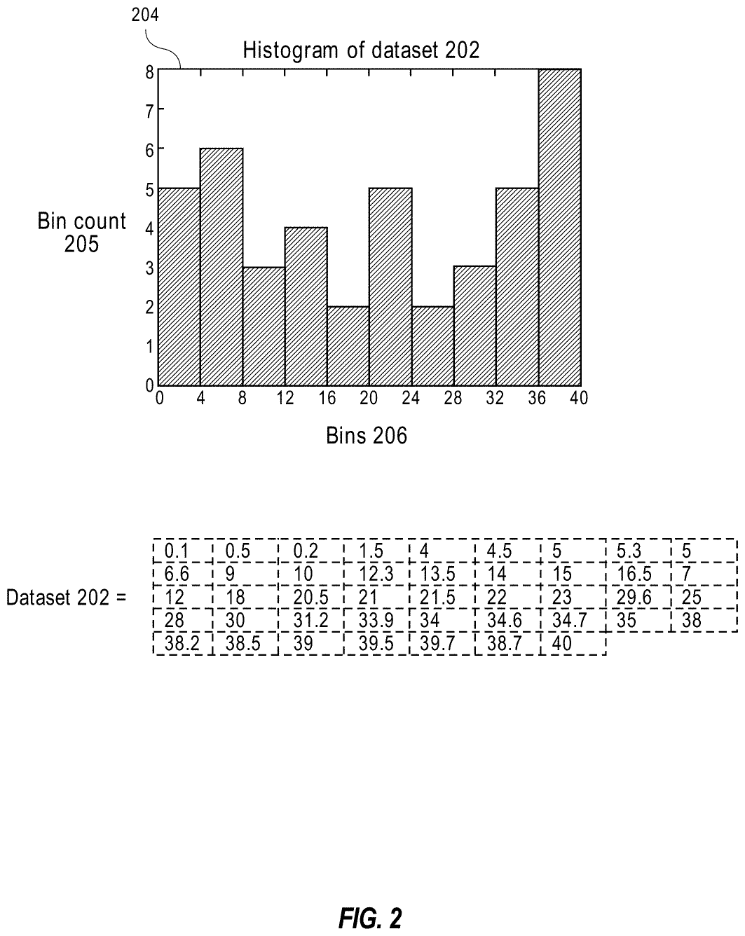

FIG. 2 illustrates an example 200 of data discretization. In the illustrated example, a histogram 204 is created for a dataset 202 by performing data discretization using an arbitrary bin size of 4. Dataset 202 is an array of example numerical data, which contains 43 total data elements with values ranging between 0 and 40. Using an arbitrary bin size or bin width of 4, the entire range of values of dataset 202 (from 0 to 40) is broken down into intervals of 4, and each interval is represented by a separate bin, resulting in a total of 10 bins. The data elements of dataset 202 are then grouped into the appropriate bin, and the number of data elements in each bin are counted. A histogram 204 is then used to represent the number of data elements in each bin. In the illustrated example, the y-axis of histogram 204 represents the bin count 205 (e.g., the number of data elements in a bin), and the x-axis represents the various bins 206. For example, bin 12 has a bin count of 3, which means there are 3 data elements in dataset 202 that are greater than 8 and less than or equal to 12 (e.g., data values 9, 10, and 12 in dataset 204).

The resulting histogram 204 represents an approximation of the data distribution of dataset 202. The granularity or precision of the approximated data distribution of a histogram is based on the bin size. While smaller bin sizes may result in a more precise representation of the original data distribution, larger bin sizes may result in fewer bins or categories which may be more efficient for subsequent analysis and processing. Thus, although an arbitrary bin size of 4 was used in the illustrated example, the optimal bin size for a given dataset may vary. Accordingly, it may be beneficial to determine an optimal bin size for a given dataset to ensure that the discretized data provides a useful summary of the dataset without significantly deviating from the original data distribution. In some embodiments, for example, an optimal bin size can be determined using the cost function described throughout this disclosure in connection with the remaining FIGURES.

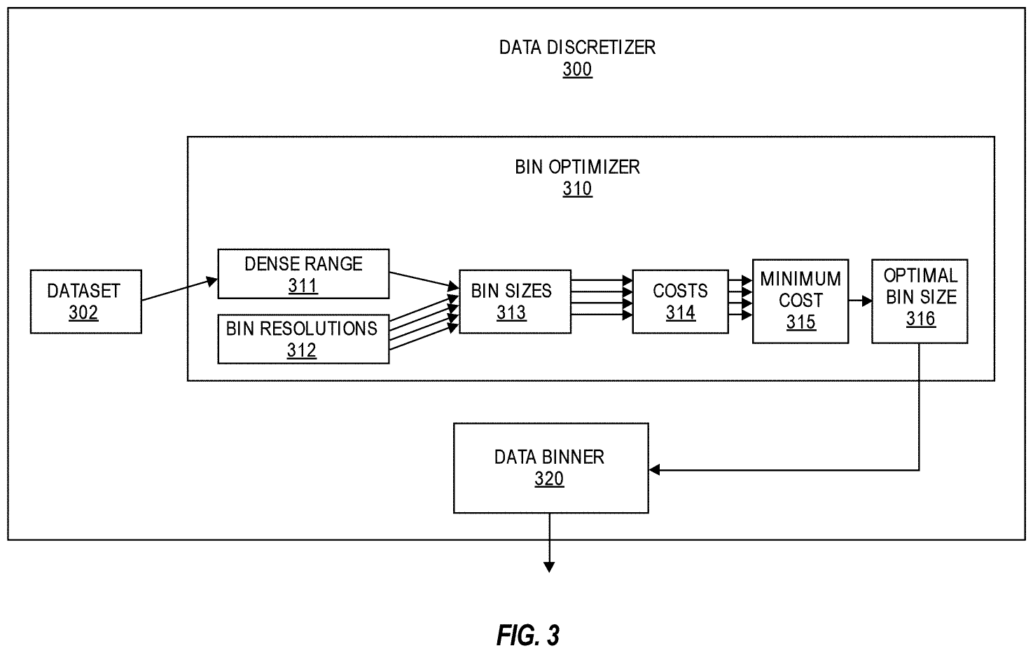

FIG. 3 illustrates a block diagram for an example embodiment of optimized data discretization. The illustrated embodiment includes a data discretizer 300 for automatically performing data discretization on a particular dataset using an optimal bin size. For example, data discretizer 300 may determine an optimal bin size that ensures the discretized data provides a meaningful summary of the dataset without significantly deviating from the original data distribution. For example, the optimal bin size may be large enough to provide a meaningful summarization of the dataset, but small enough to preserve the original data distribution. In various embodiments, functionality of data discretizer 300 may be implemented using any type or combination of hardware and/or software logic, such as a processor (e.g., a microprocessor), application specific integrated circuit (ASIC), field programmable gate array (FPGA), or another type of integrated circuit or computing device or data processing device, and/or any associated software logic, instructions, or code.

In the illustrated embodiment, data discretizer 300 determines the optimal bin size using a cost function to minimize the difference in data distribution (before and after discretization) while maximizing the bin size. The cost function C can be represented using the following equation:

$$cost C = \frac{max ( differences between adjacent bin counts )}{bin size} \qquad ( 1 )$$

In the above cost function C from equation (1), “bin counts” refers to the number of data elements that fall into each discretized bin for a particular bin size, and the “differences between adjacent bin counts” refers to the difference in bin count between each pair of adjacent bins. In some embodiments, for example, the differences between adjacent bin counts may be determined by subtracting the n^{th} bin count from the (n-1)^{th} bin count. Accordingly, the cost C for a particular bin size may be calculated by identifying the maximum value of the differences between adjacent bin counts, and dividing that by the particular bin size. The optimal bin size for a particular dataset is the bin size with the smallest cost value C. Accordingly, the optimal bin size can be determined by solving for the particular bin size that minimizes the value of cost function C, for example, over a particular range of bin sizes.

Minimizing the cost function C in this manner effectively minimizes the maximum difference between adjacent bin counts (since that value is in the numerator), while simultaneously favoring larger bin sizes (since the bin size is in the denominator). This ensures that the resulting histogram provides the optimal balance between preserving the original data distribution while maximizing the bin size.

In the illustrated embodiment, data discretizer 300 includes a bin optimizer 310 that can be used to identify the optimal bin size for binning dataset 302. Bin optimizer 310 first identifies a dense range 311 of the dataset 302. In some embodiments, for example, the mean and standard deviation of the dataset 302 may be computed, and then dense range 311 may be identified as a range that is within a particular number of standard deviations from the mean. For example, in some embodiments (e.g., for datasets with Gaussian distributions), the dense range 311 may be +−2 standard deviations from the mean. Accordingly, identifying the dense data range in this manner ensures that outliers or data with long tails do not impact the optimal bin size.

Next, bin optimizer 310 identifies a range of potential bin resolutions 312 for the optimal bin size. In some embodiments, for example, the range of bin resolutions 312 may be identified based on configurable parameters, such as a start resolution, stop resolution, and step. For example, if the start resolution, stop resolution, and step are respectively set using default values of 0.1, 0.2, and 0.001, the resulting bin sizes will range from 10% to 20% of the size of the dense range 311, and in increments of 0.1%. In this manner, the range of potential bin resolutions 312 are used to calculate a range of corresponding bin sizes 313, for example, by multiplying each bin resolution 312 by the size of the dense range 311.

A cost value 314 may then be computed for each bin size 313. For example, for a particular bin size, first the boundaries or center values of the bins may be computed. The bin boundaries for a particular bin size 313 may be computed, for example, by enumerating the dense data range 311 from lowest end to highest end using a step or interval equal to the particular bin size 313. A histogram can then be created for the particular bin size 313, for example, by counting the number of data elements of dataset 302 that fall into each bin. The histogram can then be used to compute the differences in bin count for adjacent bins. For example, for each bin other than the 1^{st} bin, the bin count of the particular bin may be subtracted from the bin count of the preceding bin, and the absolute value of the result may be returned as the difference between those respective bin counts. The maximum value of these differences in adjacent bin count can then be identified. The cost value 314 for the particular bin size 313 can then be computed, for example, using the cost function C identified above (e.g., by dividing the maximum difference in adjacent bin counts by the particular bin size). This process can be repeated in order to compute cost values 314 for all potential bin sizes 313.

The cost values 314 of the respective bin sizes 313 are then used to identify the minimum cost value 315, and the optimal bin size 316 is then identified as the bin size associated with the minimum cost value 315.

The optimal bin size 316 can then used by data binner 320, for example, to perform binning on dataset 302 and/or generate a histogram. For example, the optimal bin size can be used to determine the total number of bins and the interval or range of each bin, and dataset 302 can then be partitioned into the respective bins. The total number of bins, for example, can be computed by dividing the size of the dense data range 311 by the optimal bin size 316 and rounding up the result.

Example pseudocode for implementing the functionality of data discretizer 300 is provided below:

```
// Step 1: Identify dense range of dataset
      mean = mean(dataset); // Compute mean of dataset
      std_dev = std_dev(dataset); // Compute standard deviation of dataset
      dense_range = mean +− 2*std_dev; // Compute dense range as +− 2 standard deviations
      from the mean
// Step 2: Identify range of potential bin resolutions
      // Initialize the bin size resolutions array based on the configuration parameter values
      for start_resolution, step, and end_resolution. Default values of start_resolution, step,
      and end_resolution are 0.1, 0.001, and 0.2, respectively. These default values produce
      bin sizes ranging from 10% to 20% of the dense range, with increments of 0.1%.
      bin_resolution = start_resolution: step : end_resolution;
// Step 3: Calculate cost function (C) for each potential bin size
      for each element [i] in the bin_resolution array:
            // Create a binsize iterator to store the bin size computed using the resolution
            from the current iteration of the bin_resolution array
            binsize_iterator = size of dense_range * bin_resolution[i];
            // Save the computed bin size from the current iteration in an array
            computed_binsizes[i] = binsize_iterator;
            // Create an array of the bin boundary or center values
            bin_boundaries = min(dense_range) : binsize_iterator : max(dense_range);
            // Create a histogram based on the bin boundaries
            [counts, bins] = hist(dataset, bin_boundaries);
            // Compute the absolute values of the differences between adjacent bin counts,
            and save them in the diffs_adj_bincount array
            diffs_adj_bincount = abs(differences between adjacent bin counts);
            // Find the maximum difference between adjacent bin counts, and save in the
            max_diff_adj_bincount array
            max_diff_adj_bincount[i] = max(diffs_adj_bincount);
            // Compute the Cost function for this bin size:
            cost[i] = max_diff_adj_bincount[i] / computed_binsizes[i];
// Step 4: Find the optimal bin size with the minimum cost
      [value, index] = min(cost);
      optimal_binsize = computed_binsizes[index]; // optimal_binsize is the optimal
      discretization bin size for the data
// Step 5: Compute the total number of bins
      optimal_number_of_bins = ceiling(dense_range / optimal_binsize);
```

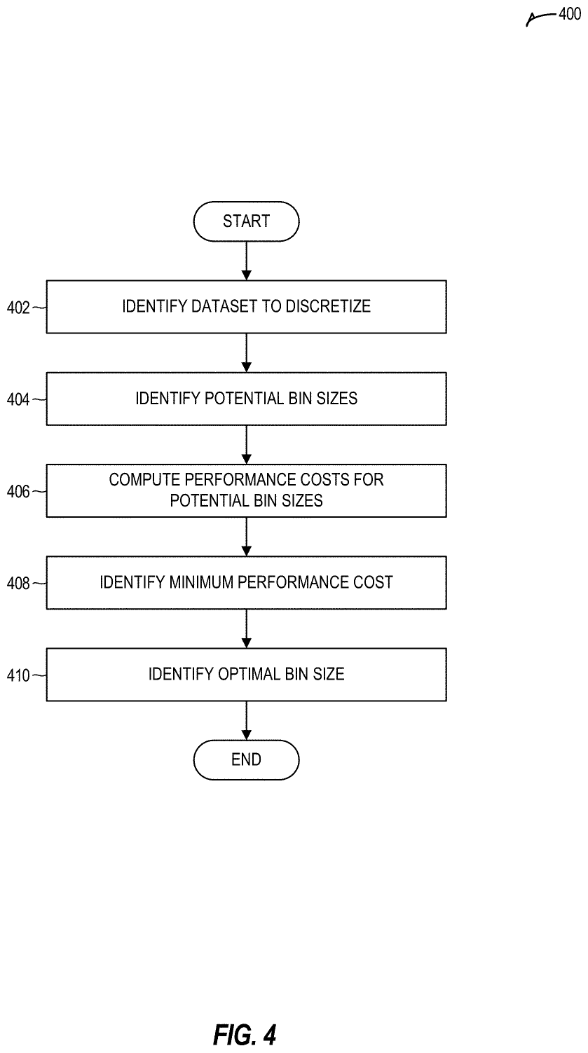

FIG. 4 illustrates a flowchart 400 for an example embodiment of optimized data discretization. Flowchart 400 may be implemented, in some embodiments, using the embodiments and functionality described throughout this disclosure.

The flowchart may begin at block 402 by identifying a dataset for performing data discretization or data binning. The dataset, for example, may be identified based on a plurality of data values or data elements associated with, or provided by, a computing device. In some embodiments, for example, the data values may be provided, generated, and/or obtained by a sensor device (e.g., a sensor associated with an IoT device 114 of FIG. 1), or another type of data processing device.

Moreover, in some embodiments, the dataset may be identified based on a dense data range of a parent dataset. In some embodiments, for example, the mean and standard deviation of a parent dataset may be computed, and the dense data range may be identified as a range that is within a particular number of standard deviations from the mean. For example, in some embodiments (e.g., for datasets with Gaussian distributions), the dense range may be +−2 standard deviations from the mean.

The flowchart may then proceed to block 404 to identify potential bin sizes for binning the dataset. In some embodiments, for example, the potential bin sizes may be based on a range of bin resolutions that are each associated with a percentage of the size of the dataset range. In some embodiments, for example, the range of bin resolutions may be identified based on configurable parameters, such as a start resolution, stop resolution, and step. For example, if the start resolution, stop resolution, and step are respectively set using default values of 0.1, 0.2, and 0.001, the resulting bin sizes will range from 10% to 20% of the size of the data range, and in increments of 0.1%. In this manner, the range of potential bin resolutions are used to calculate a range of corresponding bin sizes, for example, by multiplying each bin resolution by the size of the data range.

The flowchart may then proceed to block 406 to compute a performance cost for each potential bin size. For example, for a particular bin size, first the boundaries or center values of the bins may be computed. The bin boundaries for a particular bin size may be computed, for example, by enumerating the data range of the dataset from lowest end to highest end using a step or interval equal to the particular bin size. A histogram can then be created for the particular bin size, for example, by counting the number of data elements of dataset that fall into each bin. The histogram can then be used to compute the differences in bin count for adjacent bins. For example, for each bin other than the 1^{st} bin, the bin count of the particular bin may be subtracted from the bin count of the preceding bin, and the absolute value of the result may be returned as the difference between those respective adjacent bin counts. The maximum value of these differences in adjacent bin counts can then be identified. The performance cost for the particular bin size can then be computed, for example, by dividing the maximum difference in adjacent bin counts by the particular bin size. This process can be repeated in order to compute performance costs for all potential bin sizes.

The flowchart may then proceed to block 408 to identify the minimum performance cost of the various performance costs for the potential bin sizes.

The flowchart may then proceed to block 410 to identify the optimal bin size. The optimal bin size may be identified, for example, as the bin size associated with the minimum performance cost. Accordingly, the optimal bin size is selected in a manner that maximizes the bin size while minimizing the difference in data distribution.

Moreover, in some embodiments, the optimal bin size may then be used to identify a binned dataset or histogram, for example, by partitioning or binning the original dataset based on the optimal bin size. The binned dataset or histogram may then be used for further processing and analysis, such as for machine learning, neural network, and/or data mining operations.

At this point, the flowchart may be complete. In some embodiments, however, the flowchart may restart and/or certain blocks may be repeated. For example, in some embodiments, the flowchart may restart at block 402 to continue performing data discretization on additional datasets.

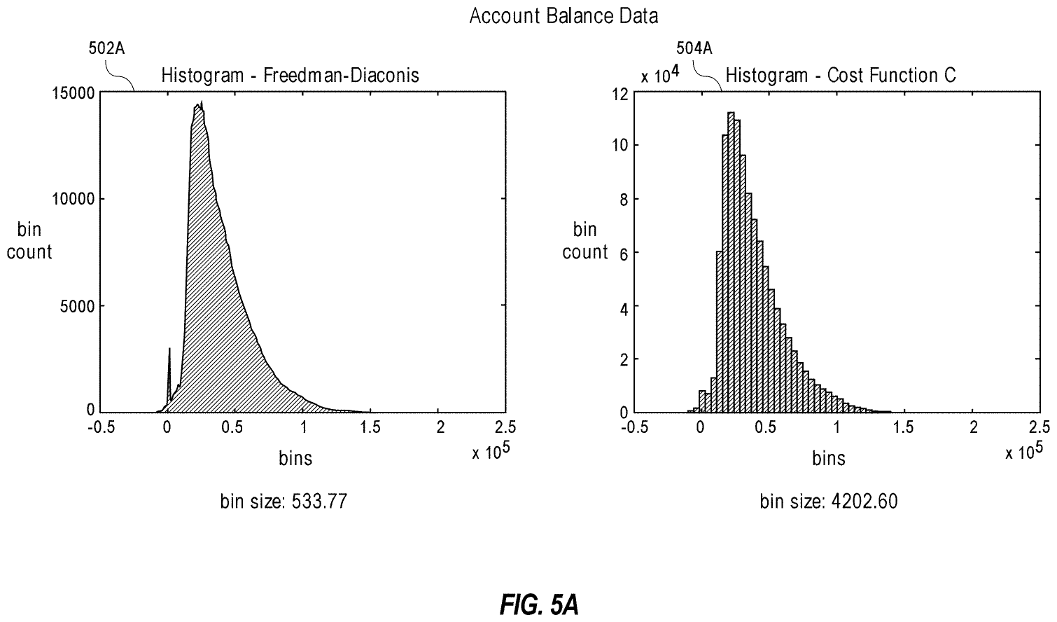

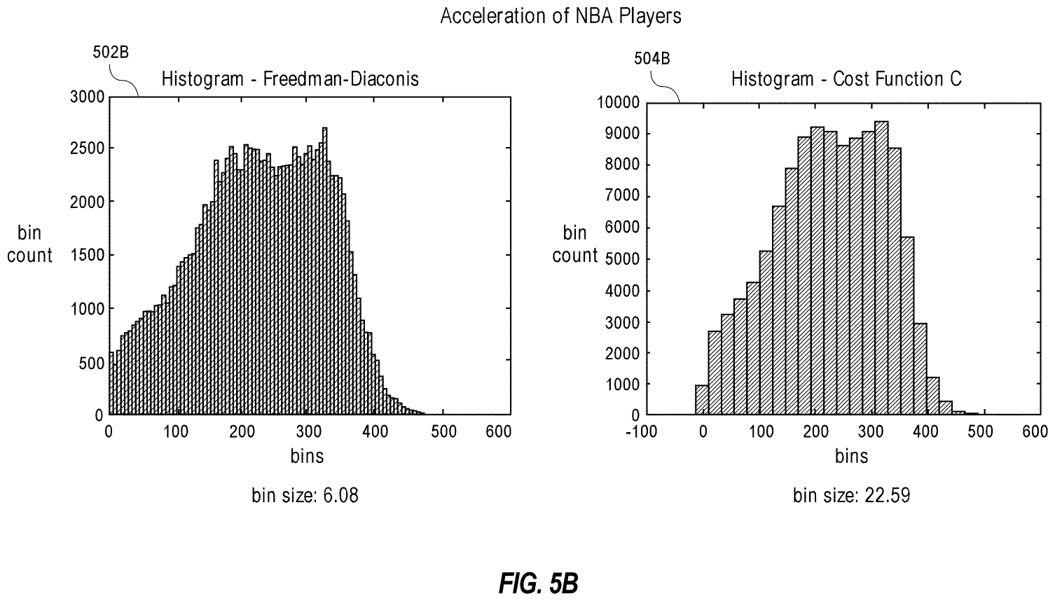

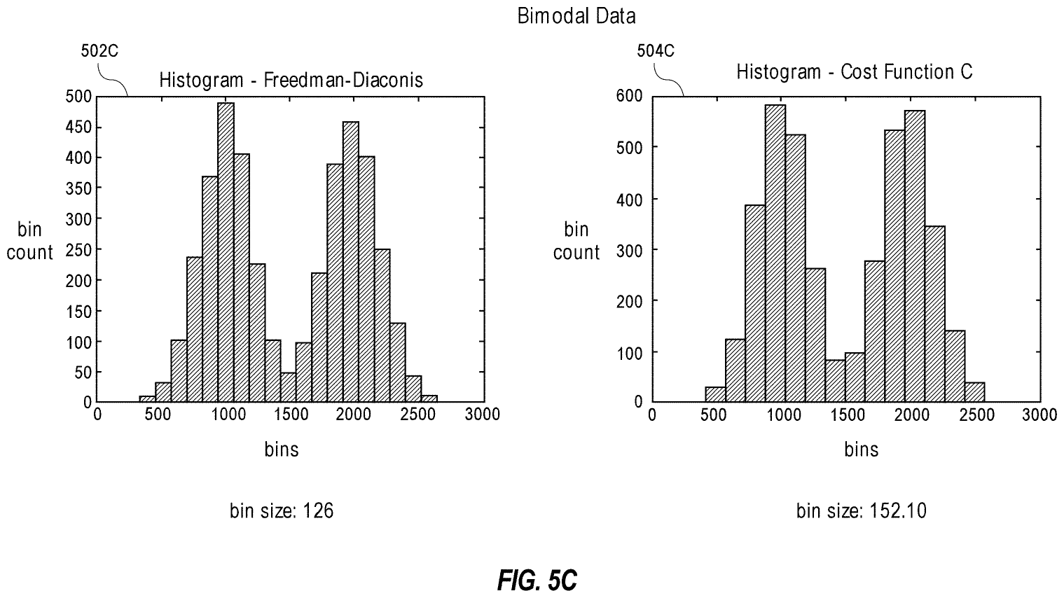

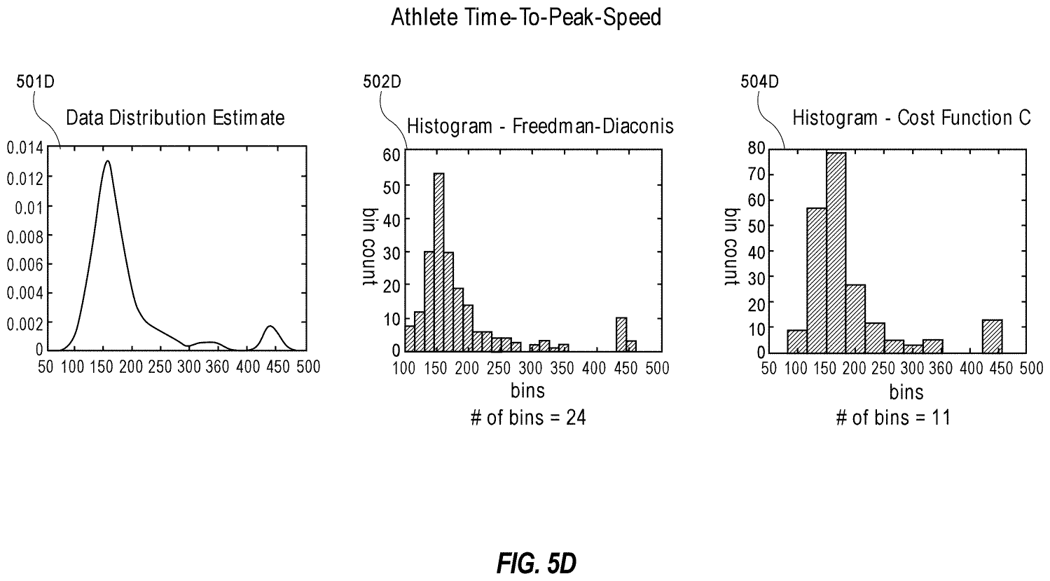

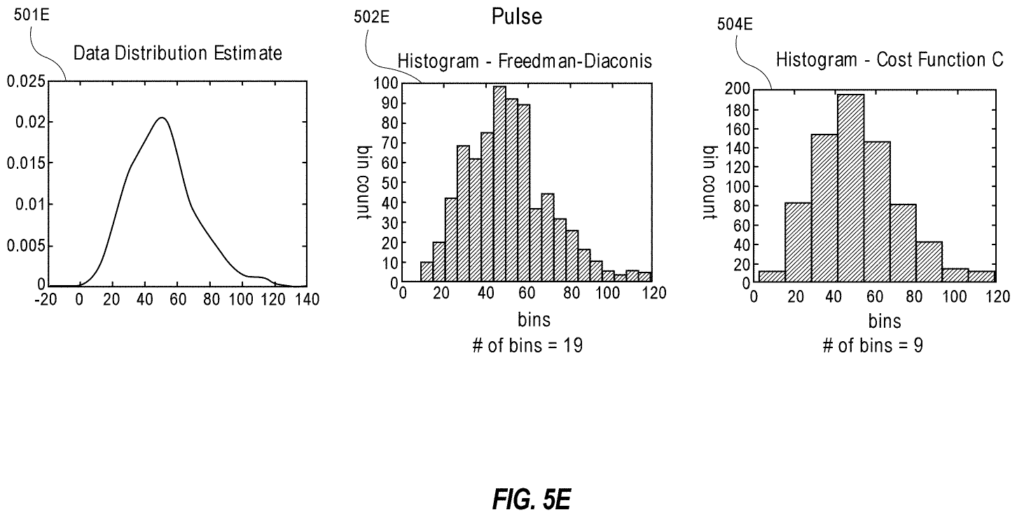

FIGS. 5A-E provide a comparison of various data discretization approaches in a variety of use cases. In particular, FIGS. 5A-E each represent a particular use case, and each use case compares histograms created by discretizing a particular dataset using the Freedman-Diaconis approach versus the cost function approach described throughout this disclosure. The use cases of FIGS. 5A-E respectively illustrate bank account balances (FIG. 5A), acceleration of NBA players (FIG. 5B), bimodal data (FIG. 5C), athlete time-to-peak-speed (FIG. 5D), and pulse (FIG. 5E).

In each example, the histogram created using the Freedman-Diaconis approach is identified by reference numeral 502 (e.g., 502A-E), and the histogram created using the cost function approach is identified by reference numeral 504 (e.g., 504A-E). Moreover, FIGS. 5A-C identify the bin size for each histogram, and FIGS. 5D-E identify the total number of bins for each histogram. FIGS. 5D-E also illustrate a data distribution estimate 501 (e.g., 501D-E) for comparison with the associated histograms.

As shown by these use cases, the bin sizes of the histograms are significantly larger-and similarly the total number of bins is significantly smaller-when using the cost function approach compared to the Freedman-Diaconis approach. In addition, the data distribution is still preserved when using the cost function approach. Accordingly, these use cases demonstrate that the cost function approach described throughout this disclosure provides the optimal balance between maximizing the bin size while minimizing the difference in data distribution.

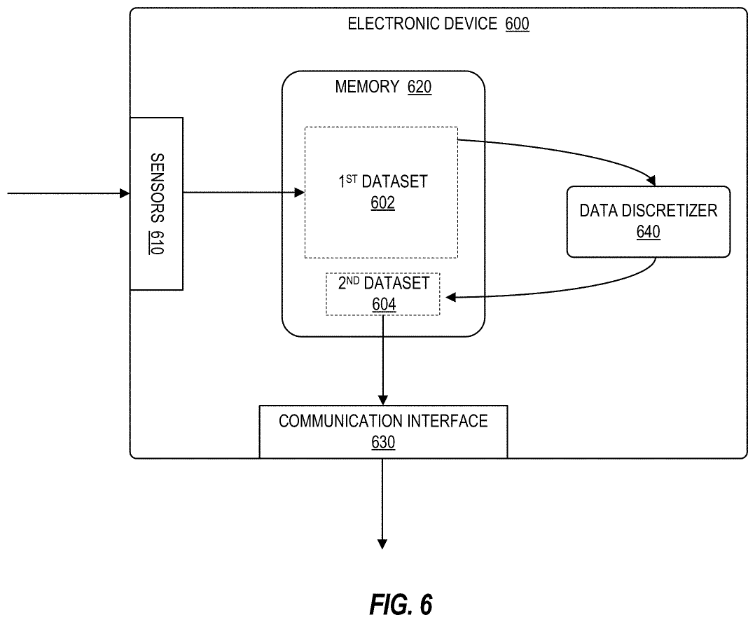

FIG. 6 illustrates an example embodiment of an electronic device 600 with data discretization functionality. In the illustrated embodiment, electronic device 600 includes sensors 610, memory 620, communication interface 630, and data discretizer 640, as described further below.

Sensor(s) 610 may include any type of sensor for monitoring, detecting, measuring, and generating sensor data and signals associated with characteristics of their environment. For instance, a given sensor 610 may be configured to detect one or more respective characteristics, such as movement, weight, physical contact, biometric properties, temperature, wind, noise, light, position, humidity, radiation, liquid, specific chemical compounds, battery life, wireless signals, computer communications, and bandwidth, among other examples. Sensors 610 can include physical sensors (e.g., physical monitoring components) and virtual sensors (e.g., software-based monitoring components).

Memory 620 may include any type or combination of components capable of storing information, including volatile and/or non-volatile storage components, such as random access memory (RAM) (e.g., dynamic random access memory (DRAM), synchronous dynamic random access memory (SDRAM), static random access memory (SRAM)), dual in-line memory modules (DIMM), read only memory (ROM), logic blocks of a field programmable gate array (FPGA), erasable programmable read only memory (EPROM), electrically erasable programmable ROM (EEPROM), flash or solid-state storage, non-volatile dual in-line memory modules (NVDIMM), storage class memory (SCM), direct access storage (DAS) memory, and/or any suitable combination of the foregoing.

Communication interface 630 may be an interface for communicating with any type of networks, devices, and/or components, including any wired or wireless interface, network, bus, line, or other transmission medium operable to carry signals and/or data. In some embodiments, for example, communication interface 630 may be an interface for communicating over one or more networks, such as local area networks, wide area networks, public networks, the Internet, cellular networks, Wi-Fi networks, short-range networks (e.g., Bluetooth or ZigBee), and/or any other wired or wireless networks or communication mediums.

Data discretizer 640 may be any component used for processing and/or discretizing datasets. In some embodiments, for example, functionality of data discretizer 640 may be implemented using any type or combination of hardware and/or software logic, such as a processor (e.g., a microprocessor), application specific integrated circuit (ASIC), field programmable gate array (FPGA), or another type of integrated circuit or computing device or data processing device, and/or any associated software logic, instructions, or code. In some embodiments, for example, data discretizer 640 may be similar to data discretizer 300 of FIG. 3.

In the illustrated example, a first dataset 602 is obtained initially. Dataset 602 may include any type of data used for any purpose, including data analytics (e.g., data mining, machine learning and artificial intelligence). In the illustrated embodiment, dataset 602 is obtained based on data generated by sensors 610. In other embodiments, however, dataset 602 can be obtained based on data provided by any source, including other devices, databases, users, networks, and so forth. For example, in some embodiments, dataset 602 may be obtained over a network (e.g., via communication interface 630).

In some embodiments, some or all of dataset 602 may initially be stored in memory 620. For example, in some cases, the entire dataset 602 may be stored in memory 620 (e.g., if sufficient memory capacity is available and/or dataset 602 is not excessive in size), while in other cases, only the portion of dataset 602 currently being processed may be stored in memory 620 (e.g., if memory capacity is limited and/or dataset 602 is excessive in size).

Dataset 602 may then be processed by data discretizer 640, for example, by performing data binning to reduce the size of the dataset. Data discretization or data binning, for example, may involve converting or partitioning a range of continuous raw data into a smaller number of “bins” that each represent a particular interval or range, and then maintaining only the bin counts, or the number of data elements in each bin. In this manner, the raw data values are aggregated and the size of the dataset is reduced or compressed. Accordingly, in the illustrated embodiment, data discretizer 640 performs data binning to reduce the size and/or compress the first dataset 602 into a second “binned” dataset 604. Moreover, in some embodiments, data discretizer 640 may determine an optimal bin size for performing the data binning, as described throughout this disclosure. For example, data discretizer 640 may identify an optimal bin size for generating a binned dataset 604 that provides a meaningful summary of the first dataset 602 without significantly deviating from the original data distribution of the first dataset 602. In this manner, the first dataset 602 is converted into a smaller compressed second dataset 604, or an efficiency vector, which can be stored and/or processed more efficiently and still maintains the important characteristics of the original dataset 602 (e.g., data distribution). Accordingly, the second dataset 604 removes a level of precision of the original dataset 602 that is both unnecessary and counterproductive to any subsequent processing and analysis.

The second binned dataset 604 may then be stored, transmitted, and/or used for further analysis and processing (e.g., or data mining or machine learning and artificial intelligence). For example, in some embodiments, the second dataset 604 may be stored in memory 620 using less memory space than would be required for the first dataset 602. The second dataset 604 may be transmitted over a network (e.g., via communication interface 630) using less transmission bandwidth than would be required for the first dataset 602. Moreover, the second dataset 604 can also be processed and/or analyzed more efficiently. In this manner, data binning can be used to increase memory availability for a device and/or reduce its memory requirements, preserve network bandwidth, and/or process data more efficiently.

Optimized Decision Tree Machine Learning

Machine learning (ML) classifiers can be leveraged for a variety of applications and use cases. In some cases, for example, ML classifiers may be used to detect or predict failures in various types of devices and equipment (e.g., industrial, enterprise, and/or consumer-grade), such as heating, ventilation, and air conditioning (HVAC) systems (e.g., fans and compressors), robots (e.g., industrial robots used for inventory management, manufacturing, and/or semiconductor production), vehicles (e.g., cars, buses, trains, airplanes), computers and other electronic devices (e.g., computer hardware, communication networks, sensors), and so forth. It is crucial to perform fault detection as fast and reliably as possible to ensure that appropriate mitigating actions can be performed in a timely manner (e.g., to avoid any sudden failure or downtime that may cause customer dissatisfaction, physical harm, and/or associated economical losses).

This is particularly true for edge devices, which typically rely on a remote server (e.g., in the cloud) to host the ML algorithms used for fault detection. For example, the underlying hardware of compute devices at or near the edge is often resource constrained. ML classifiers used for fault detection, however, are typically highly compute- and memory-intensive. As a result, data is typically collected from edge devices (e.g., sensor/performance data) and sent to a centralized compute center with high-powered servers (e.g., a datacenter), where the data is then analyzed using ML classifiers that have been trained to perform fault detection. The outputs of the ML classifiers (e.g., fault/failure predictions) are then sent back to the edge devices over a network.

Solutions that use this approach suffer from numerous disadvantages, however, including: (i) dependency on a datacenter for monitoring device health; (ii) dependency on a reliable network connection or Internet Service Provider (ISP) to transport device data from the edge to a remote datacenter; (iii) consumption of expensive network bandwidth for transmitting large volumes of device data and/or telemetry data to the datacenter, which decreases the available bandwidth for real workloads; and (iv) increased latency for obtaining the response or output from an ML classifier due to network delays, which increases the risk of device failures and may lead to sudden interruptions in service.

Further, training a general-purpose ML model in a generic manner for all deployments of a particular edge device does not provide optimal performance. For example, individual deployments of an edge device typically vary from one deployment to another, as each deployment may have variations in the device make/model, sensor accuracies and precision, configuration, deployment conditions, and so forth. Moreover, any change in the edge deployment (e.g., changes in configuration, device, sensor type, or wear and tear due to age) requires the ML model to be retrained to ensure optimal performance. As a result, a “one size fits all” general-purpose ML model trained and hosted in the cloud does not provide optimal performance across a diverse universe of edge deployments. Further, scalability is also crucial for mass deployment of ML inference engines on edge devices of different types (e.g., makes/models) running under different environmental and operational conditions. However, using existing solutions, individually training a ML model for each specific edge deployment, along with updating/retraining the model whenever the deployment changes, is often infeasible or impractical. As a result, existing solutions are not suitable for large-scale training and deployment of custom ML models across many different edge deployments in a highly efficient and scalable manner.

Accordingly, this disclosure presents embodiments of an optimized decision tree ML classifier (e.g., a random forest classifier) that is suitable for large-scale training and deployment on resource-constrained devices, such as edge devices, as described further below.

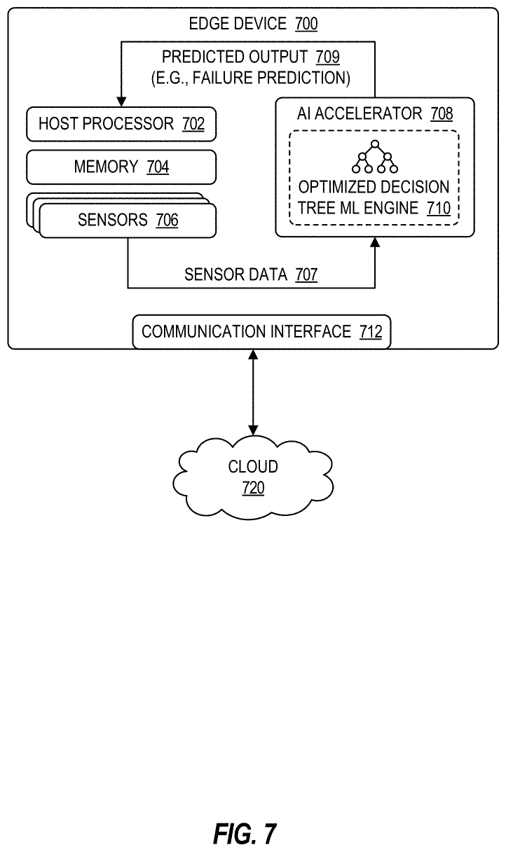

FIG. 7 illustrates an example embodiment of an edge device 700 with an optimized decision tree machine learning (ML) engine 710. The optimized decision tree ML engine 710 enables machine learning training and inference algorithms to be efficiently performed at the edge for a variety of applications and use cases, such as fault detection, as described further below.

Edge device 700 may be or may include any type of device or equipment deployed at or near the edge of a network or system (e.g., HVAC equipment, manufacturing equipment, medical devices, computing and/or networking equipment, cameras). In the illustrated embodiment, edge device 700 includes a host processor 702, a memory and/or data storage 704, a collection of sensors 706, an artificial intelligence (AI) accelerator 708, and a communication interface 712.

The collection of sensors 706 is used to capture sensor data 707 associated with the operating environment of the edge device 700, such as data associated with the operation or health of the device 700 itself and/or its underlying components, its physical environment, and so forth.

Moreover, the AI accelerator 708 is implemented with an optimized decision tree machine learning (ML) engine 710, which is used to detect or predict failures associated with the edge device 700 based on the sensor data 707 captured by the sensors 706 (either alone or in conjunction with other types of data). In particular, the decision tree ML engine trains a decision tree machine learning model, such as a random forest model, to predict the health of the edge device 700 based on past sensor data 707 captured for various known or “ground truth” health states of the device 700 (e.g., device healthy, present failure of component X/Y/Z, imminent failure of component X/Y/Z, etc.). The decision tree ML engine can then use the trained decision tree model to classify or infer the current health of edge device 700 based on newly captured sensor data 707. In this manner, the decision tree ML engine can detect or predict failures 709 associated with the edge device 700 in real time based on its current health as determined based on the decision tree ML model.

When a failure is predicted by the decision tree ML engine, the AI accelerator 708 provides the failure prediction 709 to the processor 702, which may then perform and/or trigger any appropriate mitigating or remedial actions in response to the predicted failure (e.g., notifying a cloud-based server 720 and/or other edge devices of the failure via communication interface 712, activating redundant or backup devices or components, migrating workloads to other edge devices).

In the illustrated embodiment, the optimized decision tree ML engine 710 performs training and inference using decision tree machine learning algorithms (e.g., random forest) implemented in a highly efficient manner, which reduces compute cycle requirements and memory resource requirements by manifolds. As a result, the decision tree machine learning algorithms are suitable for deployment at the edge and/or on resource-constrained devices (e.g., on FPGAs, ASICs, co-processors, smartNlCs, and so forth). In particular, the decision tree ML engine 710 leverages the optimized data quantization and data binning method described throughout this disclosure (particularly in connection with FIGS. 1-6) to significantly reduce the training time for training a decision tree machine learning model, such as a random forest model. The training time is reduced by 3×-5× both in the cloud and at the edge, the number of parallel compute blocks is reduced on the order of more than 100×, and memory requirements are reduced by ˜1000× in a fixed memory architecture (e.g., on an FPGA).

Further, this solution provides a way of deploying ML classifiers at FPGAs or at any edge device without the need to host them on a remote server (e.g., in the cloud) and communicate over already overloaded network bandwidth. This solution also reduces the response time of the machine learning models, enabling real time operation and mitigation of risks and failures on time. For example, the solution enables an edge-based architecture utilizing the adjacent acceleration or a smartNlC device to provide analytics functionality (e.g., failure prediction/fault detection) using telemetry data available at the edge without sending it to a central office or cloud. Having the analytics and inference engine at the edge reduces the latency of failure prediction and mitigation as a result of usage of local telemetry data without traversing it to and from the cloud-based management stack. The edge-based solution leveraging predictive analytics can be deployed as a stand-alone solution for self-managing devices, or can be deployed with a datacenter management stack to achieve a self-driving datacenter. Further, the solution enables models to be individually or custom trained per-device rather than generically training general-purpose models for many different devices. This solution also provides fast results and closed-loop mitigation.

The decision tree ML engine 710 is suitable for deployment on edge devices and other resource-constrained devices, or in the cloud, using FPGAs, ASICs, coprocessors, smartNlCs, and/or any other general-purpose and/or special-purpose processors and accelerators. In some embodiments, for example, the decision tree ML engine 710 may be deployed on an FPGA (with an on-board edge memory) of an edge computing device 700.

Moreover, the decision tree ML engine 710 can be used to implement any machine learning application or use case that relies on decision tree machine learning (e.g., fault detection, medical diagnostics, etc.). The decision tree ML engine 710 may be implemented using any type or combination of decision tree machine learning algorithms, including random forests, centered forests, uniform forests, rotation forests, ensemble decision trees, boosting trees, bagging trees, classification and regression trees (CART), conditional inference trees, fuzzy decision trees (FDT), decision lists, iterative dichotomiser 3 (ID3), C4.5, chi-square automatic interaction detection (CHAID), and multivariate adaptive regression splines (MARS), among other examples.

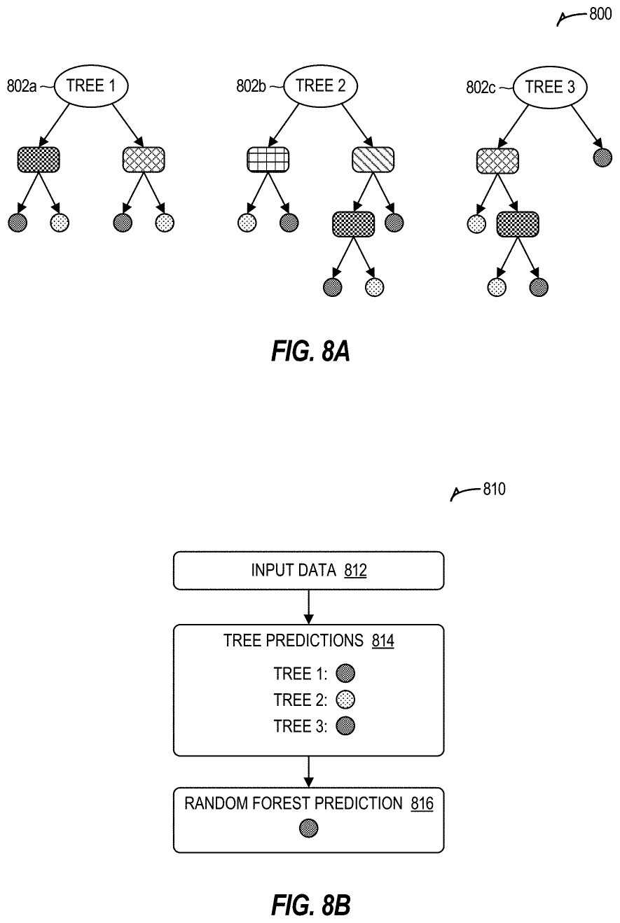

The optimized decision tree machine learning solution is described further in connection with FIGS. 8-13.

FIGS. 8A-B illustrate an overview of a random forest machine learning (ML) algorithm. In particular, FIG. 8A illustrates an example of a trained random forest model 800, and FIG. 8B illustrates an example process flow 810 for performing inference (e.g., classification and/or regression) using the trained random forest model 800.

A random forest algorithm is a supervised machine learning algorithm that trains or generates multiple individual decision trees (e.g., binary trees) using some level of randomization and then uses them together as an ensemble to perform inference (e.g., classification and/or regression). For example, to perform inference, each individual tree of the random forest generates a prediction, and the random forest then uses the respective predictions from the individual trees to determine and output a final prediction. In some embodiments, for example, a random forest trained to perform classification may output the predicted class or label corresponding to the mode of the classes predicted by the individual trees (e.g., the class with the most predictions), while a random forest trained to perform regression may output a predicted numerical value corresponding to the mean (e.g., average) of the values predicted by the individual trees. The fundamental concept behind a random forest is that ensemble predictions from a large number of relatively uncorrelated decision trees will be more accurate than predictions from any of the individual trees. The number of trees in the random forest can be configurable, and the accuracy of the ensemble predictions will typically increase and decrease with the number of trees (e.g., the more trees in the random forest, the higher the accuracy of the ensemble predictions).

An example of a trained random forest model 800 is shown in FIG. 8A. In the illustrated example, the random forest model 800 only includes three decision trees 802a-c for the sake of simplicity. In actual embodiments, however, a random forest model may contain any number of decision trees (e.g., 50-100 trees in some cases).

An example process flow 810 for performing inference (e.g., classification or regression) using the trained random forest model 800 is shown in FIG. 8B. In the illustrated example, at block 812, the random forest model 800 is supplied with new input data on which inference is to be performed. For example, the input data may include newly captured, previously unseen, and/or unlabeled sensor data that needs to be classified or labeled. At block 814, each tree 802a-c of the random forest model 800 performs inference on the input data to generate a corresponding prediction associated with the input data. In the illustrated example, trees 1 and 3 generated the same prediction while tree 2 generated a different prediction. At block 816, the random forest outputs a final prediction based the underlying predictions from the respective trees. In the illustrated example, the random forest outputs the prediction generated by trees 1 and 3since it received the most votes.

The training algorithm for a traditional random forest model performs the following steps to generate each individual tree of the model:
1. Create multiple training sets of size N by sampling the original training data according to some sampling distribution (e.g., bagging or boosting).
   a. The same number of data points is used to create multiple trees (this is more of CART (Classification and Regression Trees)).
2. Choose a particular number of features (e.g., two features) at random from M features in the feature set in the training/child node data.
   a. Sort the training set with respect to the feature value.
   b. For each value of the feature, divide or partition the training set/child node data into greater and lesser value child datasets.
   c. For each child dataset, compute the child and total Gini index based on the labels of the data in the child dataset (see equation (2) below for computing a Gini index).
   d. Repeat the steps 2(b)-(c) for each value of each randomly selected feature, and select the corresponding feature and cutoff value having the best Gini index.
   e. Based on the selected cutoff value of the selected feature, divide the feature data set for the current node into two child node data sets whose values are respectively less than, and greater than or equal to, the cutoff value of the selected feature.
3. Repeat step 2 until all data points in the child data set have the same label or there is only one data point remaining in the child data set. These nodes are called leaf nodes.

For example, after the training data is sampled into multiple groups (e.g., each group for generating a different tree of the random forest), a certain number of features (e.g., two features) is chosen randomly from the M features in the feature set. For each randomly selected feature, each value of the feature is tested to determine if it is a good cutoff point for splitting the data. The goodness of the cutoff point is measured using a Gini index measure (equation (2)). The cutoff point with the highest Gini index is chosen. The creation of new nodes continues in this manner until each leaf node only has data of the same class/label or only has one data point.

The Gini index for training data Twith n classes is defined as:

Gini(T)=1-Σⱼ₌₁ⁿ(pⱼ)² (2)

where pⱼ is the relative frequency of class j in data T.

The traditional random forest method described above sorts each attribute and computes Gini indexes (children Gini and Total Gini) for each value of the attribute to identify the best cutoff point. For example, if there are 12,000 samples in a training set, the traditional method computes Gini for each of the 12,000 values, irrespective of its value, to identify the best cutoff value which divides the data best into two different classes or labels. This process is very compute intensive and requires significant computation time, particularly in view of the large sizes of training data that are typically used to train machine learning models. Additionally, sorting is a highly compute intensive and serial function, and thus does not benefit much from the parallel computation capabilities of FPGAs that are generally used to accelerate machine learning applications.

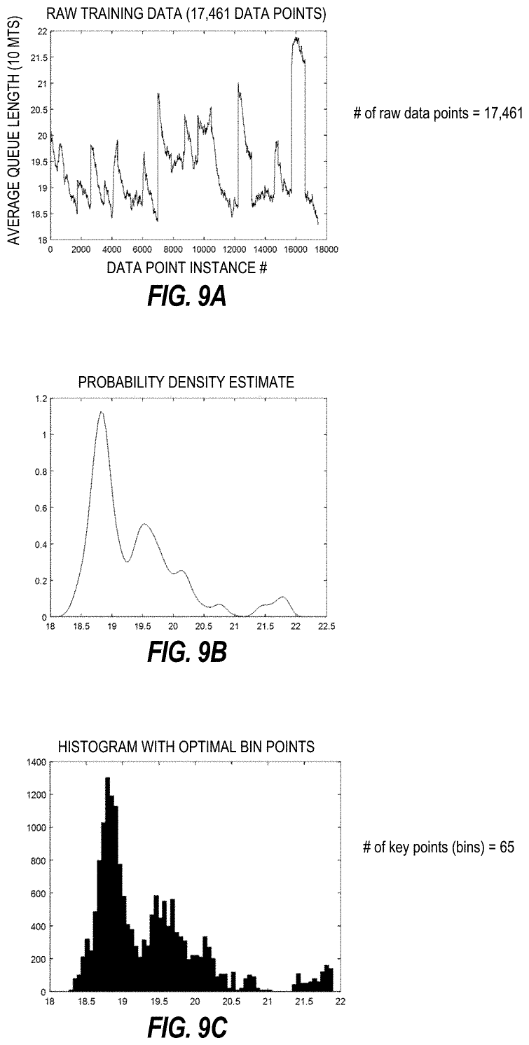

Accordingly, this disclosure presents an efficient training algorithm for a decision tree (e.g., a random forest) that optimizes the best cutoff point selection process. In particular, only a few key predetermined points are examined for the cutoff point selection process, which are determined using the automated data discretization and binning algorithm described above in connection with FIGS. 1-6. For example, the algorithm does not compute Gini for each and every value of a feature to identify the best cutoff point; instead, it computes Gini for specific values of a feature, which are predetermined using the automated quantization, discretization, and data binning method discussed above. An example of using this automated binning method to determine the key check points (or bins) is shown in FIGS. 9A-C.

As a result, this solution reduces the execution time by ˜5× for the root node and ˜4× for an entire tree without any meaningful performance hit to the resulting tree. It also reduces the compute resources required for parallelizing the best cutoff point selection algorithm by over 100× since the number of Gini computations is limited to a few key points (e.g., ˜65 points instead of 17,461) and thus so are the comparisons for a multiple feature set. Moreover, this solution removes the need for sorting each feature, which consumes significant compute resources (e.g., O(n*n) to O(n*log(n)) CPU cycles based on the implementation), and alleviates a highly serial method that consumes exclusive hardware. As a result, this solution enables efficient implementations of decision tree machine learning algorithms (e.g., random forest) in parallel architectures such as FPGAs. For example, by using the binning algorithm, the number of Gini computations is very minimal and can be further sped up by parallelism, as each computation of Gini is independent. Moreover, the binning algorithm just needs a comparator to generate a histogram. By comparison, for the traditional random forest algorithm, parallelism is impractical because the number of Gini computations is equivalent to the number of data points in the training data, which is often very large. Further, in this solution, the Gini coefficient is used to calculate entropy rather than information gain-no log values are required and Gini is simple in terms of multiplication and addition.

Moreover, in addition to the benefits of removing the sorting requirement and reducing the number of Gini computations, the termination criteria for declaring a leaf node can also be optimized in this solution. For example, this solution enables the minimum number of samples in a leaf to be optimized (which is fixed at 1 in the traditional random forest algorithm), along with the minimum number of samples in an impure node for it to be considered for splitting (which is fixed at 2 in the traditional random forest algorithm).

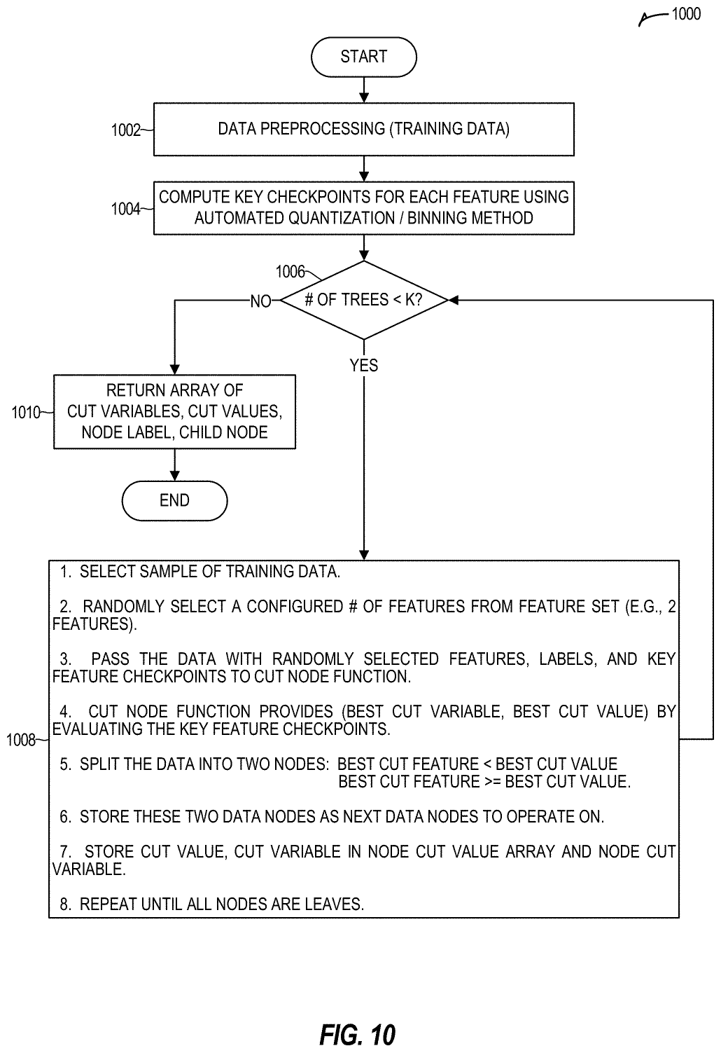

FIG. 10 illustrates a process flow 1000 for efficiently training a random forest machine learning (ML) model in accordance with certain embodiments.

The process flow begins at block 1002, where data preprocessing is performed on the training data (e.g., data filtering, denoising, normalization, interpolation, extrapolation).

The process flow then proceeds to block 1004 to compute key checkpoints for each feature using the automated quantization/binning algorithm described throughout this disclosure.

The process flow then proceeds to block 1006 to determine if the number of decision trees that have been generated is less than the required number of trees (K) for this particular random forest model (e.g., K=50 for a random forest with 50 trees).

If the requisite number of trees (K) have been generated, training is complete and the process flow proceeds to block 1010 to return a representation of the random forest (e.g., an array of cut variables, cut values, node label, child node).

If the requisite number of trees (K) have not yet been generated, the process flow proceeds to block 1008 to generate another decision tree for the random forest by performing the following steps:
1. Select a sample of training data.
2. Randomly select a configurable number of features (X) from the feature set (e.g., for X=2, two features will be randomly selected).
3. Pass the data with the randomly selected features, labels, and key feature checkpoints to a cut node function.
4. The cut node function outputs (best cut variable, best cut value) by evaluating the key feature checkpoints.
5. Split the data into two nodes: best cut feature <best cut value best cut feature >=best cut value.
6. Store these two data nodes as the next data nodes to operate on.
7. Store the cut value, cut variable in node cut value array and node cut variable.
8. Repeat until all nodes are leaves.

The process flow repeats in this manner until the required number of trees for the random forest model have been generated.

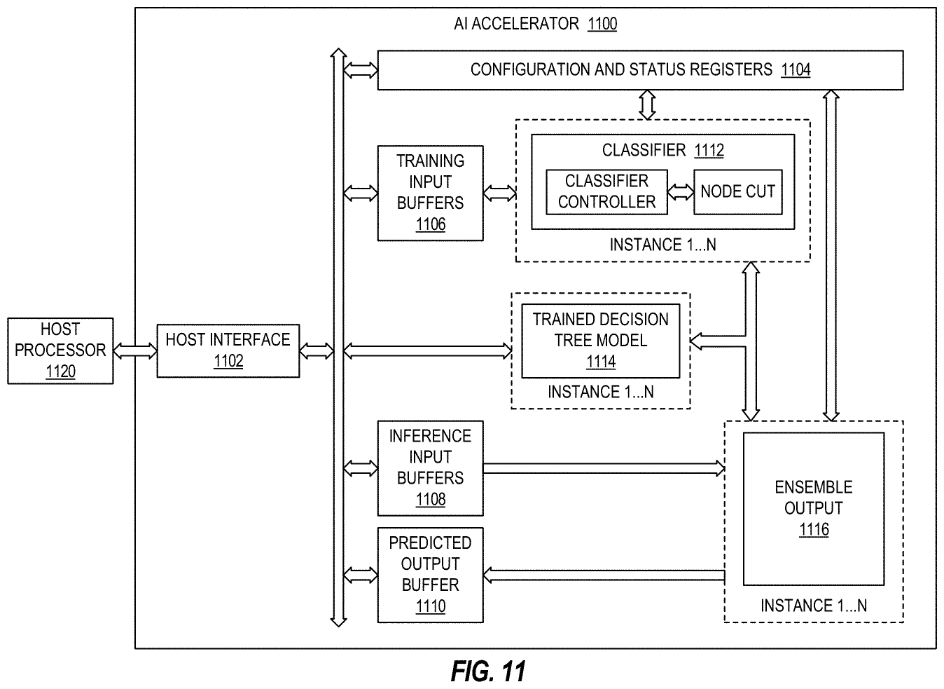

FIG. 11 illustrates an example embodiment of an artificial intelligence (AI) accelerator 1100 implemented with an optimized decision tree machine learning (ML) engine. AI accelerator 1100 may be a special-purpose processor or accelerator implemented on an FPGA, ASIC, and/or any other suitable type of integrated circuit or processing circuitry. In some embodiments, for example, the components of AI accelerator 1100 may correspond to the compute blocks of an FPGA implemented with an optimized decision tree ML engine. Moreover, in some embodiments, AI accelerator 1100 may be used to efficiently implement a decision tree machine learning (ML) model, such as a random forest model, for an edge device and/or other resource-constrained or resource-sensitive device (e.g., similar to AI accelerator 708 of edge device 700 from FIG. 7).

In the illustrated embodiment, AI accelerator 1100 includes host interface 1102, configuration and status registers 1104, training input buffers 1106, inference input buffers 1108, predicted output buffer 1110, classifier 1112, trained decision tree ML model 1114, and ensemble output module 1116.

The host interface 1102 enables the AI accelerator 1100 to communicate with a host processor 1120 (such as processor 702 of edge device 700 from FIG. 7). For example, the host interface 1102 may be used to read and write configuration and status information via the configuration/status registers 1104, read and write training and inference data via the training input buffers 1106 and inference input buffers 1108, read and write inference predictions and outputs via the predicted output buffer 1110, and so forth.

In some embodiments, for example, the training data used to generate the decision tree ML model 1114 may be sent from the host processor 1120 to the AI accelerator 1100 via the host interface 1102, and then stored in the training input buffers 1106 of the AI accelerator 1100.

Further, in some embodiments, the optimal bin cutoff points for each feature of the training data (e.g., to be evaluated during generation of the decision tree) may be computed by the host processor 1120, sent to the AI accelerator 1100 via the host interface 1102, and stored in the configuration/status registers 1104 and/or training input buffers 1106 of the AI accelerator 1100. In other embodiments, however, the AI accelerator 1100 may directly compute the optimal bin cutoff points (e.g., via logic/circuitry implemented by the classifier module 1112) using the training data supplied by the host processor 1120 and stored in the training input buffers 1106.

The configuration and status registers 1104 may further be used to store any other configurable parameters or status information associated with training the decision tree ML model 1114 and/or performing inference/classification using the model 1114.

The classifier 1112 includes a main classifier controller and a node cut module, which are collectively used to efficiently generate a trained decision tree ML model 1114 in the manner described throughout this disclosure (e.g., using the training data from the host processor 1120 and the optimal bin cutoff points computed for each feature of the training data). In some embodiments, for example, the trained decision tree ML model 1114 may be a random forest model.

The trained decision tree model 1114 can then be used to perform inference and/or generate predictions for new data supplied by the host processor 1120 via the inference input buffers 1108. In some embodiments, for example, the new data may include newly captured and/or previously unseen data that has not yet been classified or labeled. Accordingly, the ensemble output module 1116 may use the trained decision tree model 1114 to classify or label the new data. For example, with respect to a random forest model 1114, the ensemble output module 1116 obtains a prediction regarding the class or label of the new data from each decision tree in the random forest, and the ensemble output module 1116 then determines a final prediction based on the collective predictions from the various trees. The final prediction from the ensemble output module 1116 is then stored in the predicted output buffer 1110 for subsequent retrieval by the host processor 1120 via the host interface 1102.

In some embodiments, multiple instances of certain components may be implemented on AI accelerator 1100 in order to parallelize training and/or inference computations. In the illustrated embodiment, for example, AI accelerator 1100 includes multiple instances (e.g., instances 1 . . . N) of classifier 1112, decision tree model 1114, and ensemble output module 1116.

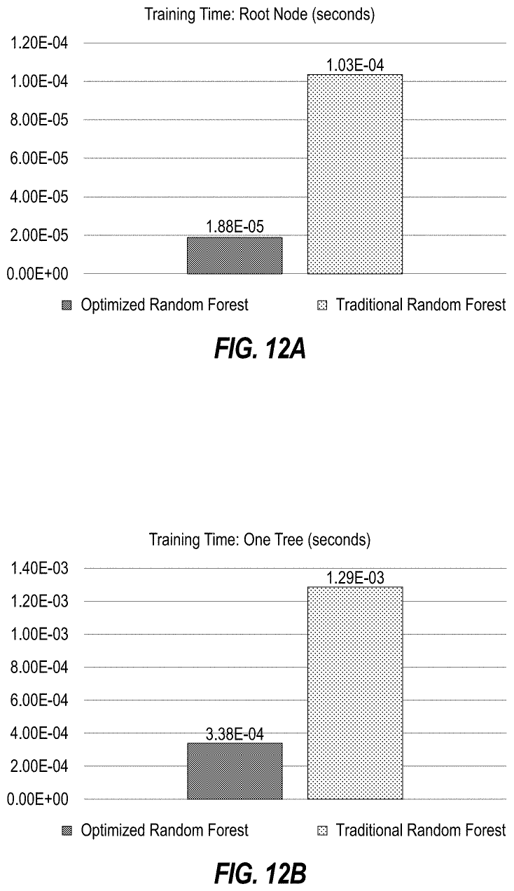

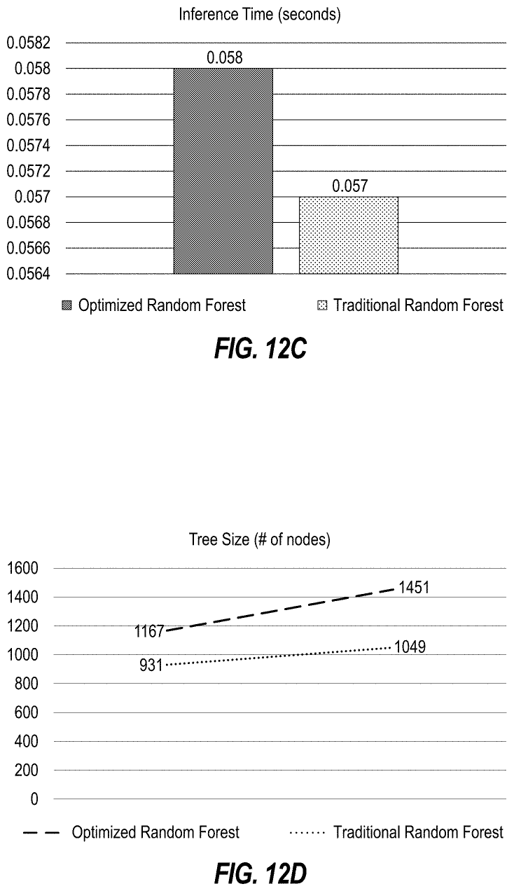

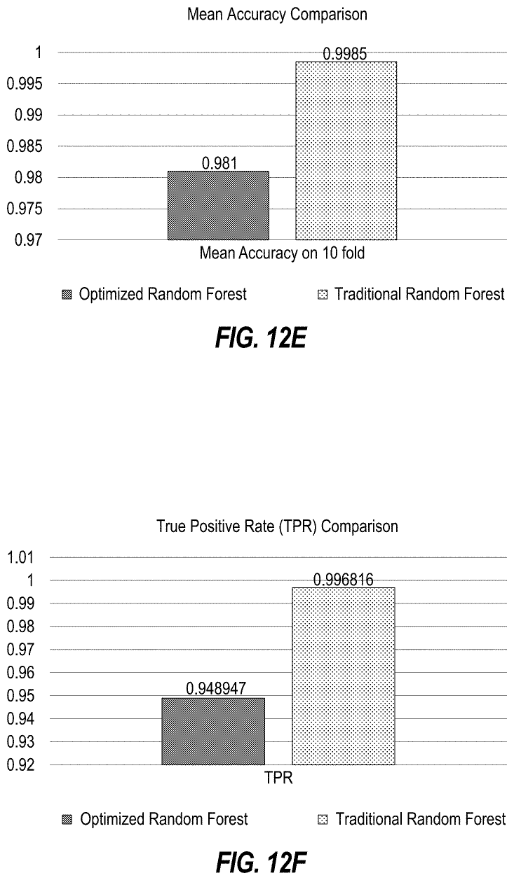

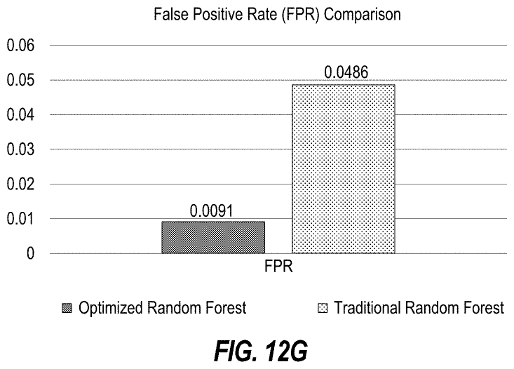

FIGS. 12A-G illustrate a performance comparison of an optimized random forest versus a traditional random forest implemented with sorting. In particular, FIG. 12A illustrates a graph comparing the training time for a root node of a tree, FIG. 12B illustrates a graph comparing the training time for an entire tree, FIG. 12C illustrates a graph comparing the inference time, FIG. 12D illustrates a graph comparing the tree size (e.g., the number of tree nodes), FIG. 12E illustrates a graph comparing the mean inference accuracy, FIG. 12F illustrates a graph comparing the true positive rate (TPR) for inference, and FIG. 12G illustrates a graph comparing the false positive rate (FPR) for inference.

The illustrated performance comparison is based on a training dataset of 12,222 data elements with five features or attributes. Tree formation (e.g., training) for the traditional random forest involved 12,222 Gini computations, while tree formation for the optimized random forest involved only 65 Gini computations. This reduced the training execution time (e.g., tree formation) by a factor of approximately five (˜5× reduction) for a root node and a factor of approximately four (˜4× reduction) for an entire tree. The inference time and the size of the tree were comparable for both random forest models. The inference performance was also comparable for both random forest models: the classification accuracy was 98% for the optimized random forest and 99% for the traditional random forest, the true positive rate (TPR) was 94% for the optimized random forest and 99% for the traditional random forest, and the false positive rate (FPR) was less than 1% for the optimized random forest and 4% for the traditional random forest.

Overall, the optimized random forest significantly reduces the execution time for tree formation and training due to the reduced number of Gini computations and elimination of the sorting step, which similarly reduces the hardware resource requirements and costs for hardware-based implementations on FPGAs, ASICs, and/or other types of compute hardware. These performance and cost benefits of the optimized random forest significantly outweighs its slight reduction in inference accuracy compared to the traditional random forest. Further, due to the significantly reduced number of Gini computations (e.g., from 12,222 down to 65), the optimized random forest method makes it feasible to parallelize the Gini computations on hardware-based implementations (e.g., FPGAs), which further reduces the execution time for training the model.

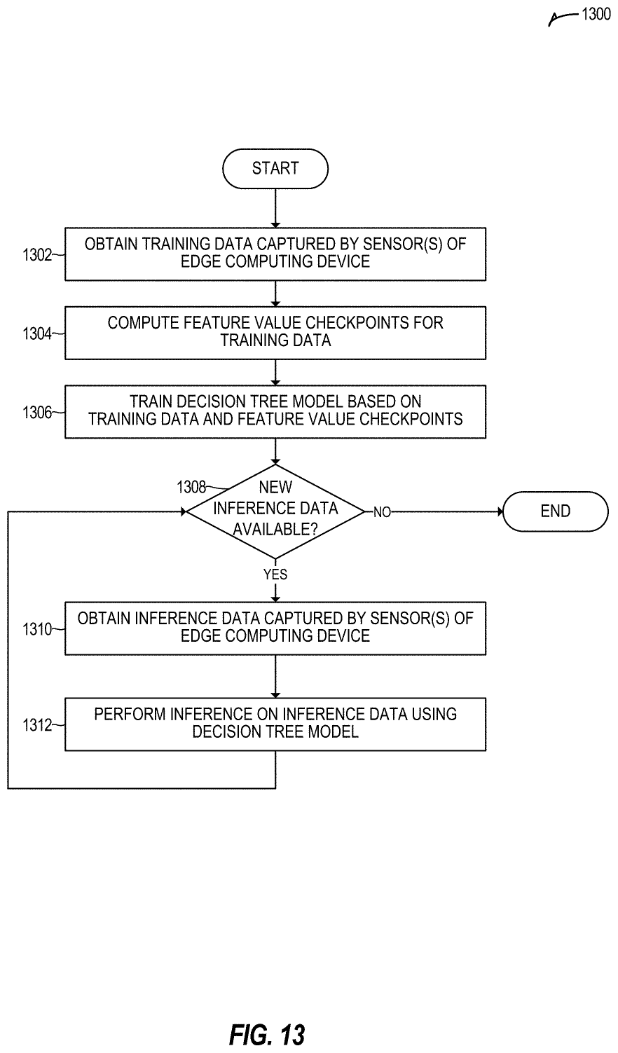

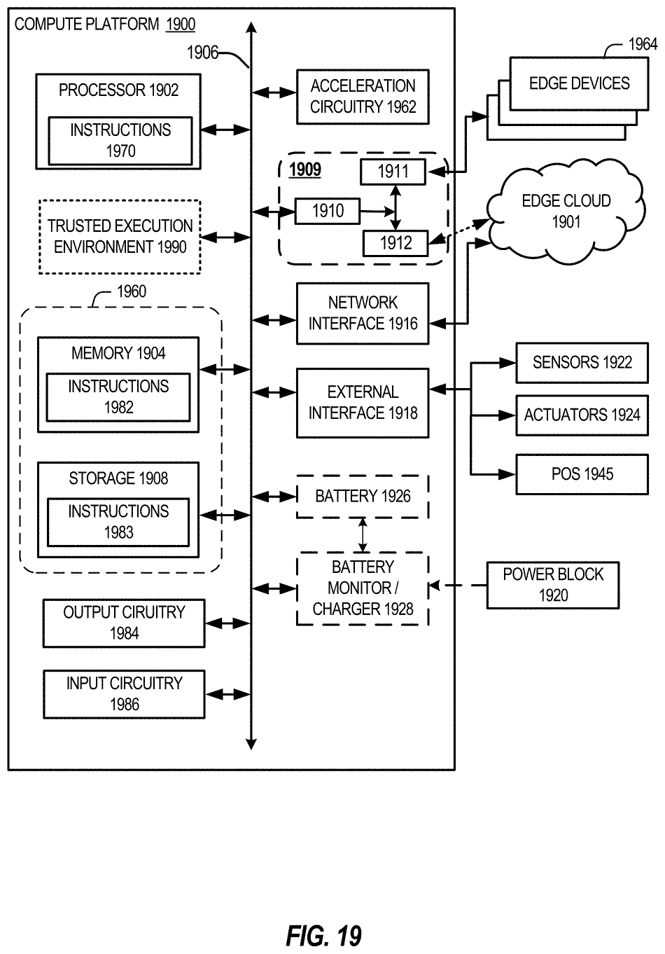

FIG. 13 illustrates a flowchart 1300 for performing decision tree training and inference in accordance with certain embodiments. In some embodiments, flowchart 1300 may be implemented and/or performed by or using the computing devices, systems, and/or platforms described throughout this disclosure (e.g., edge device 700 of FIG. 7, AI accelerator 1100 of FIG. 11, compute platform 1900 of FIG. 19, and so forth).

The flowchart begins at block 1302 to obtain training data for an edge computing device. The training data corresponds to a plurality of labeled instances of a feature set, which may be captured at least partially by one or more sensors of the edge computing device. In some embodiments, the training data may be received over an interface, such as a host interface between an artificial intelligence accelerator and a host processor of the edge computing device, a network interface, a sensor interface, and so forth.

The flowchart then proceeds to block 1304 to compute or obtain feature value checkpoints for the training data, which will be used to train a decision tree model (e.g., a random forest model). For example, the feature value checkpoints may indicate, for each feature of the feature set in the training data, a subset of potential feature values to be evaluated for splitting tree nodes of a decision tree model during training.

In some embodiments, for example, the feature value checkpoints may be computed for each feature of the feature set by: determining an optimal bin size for binning a set of feature values contained in the training data for a corresponding feature of the feature set; binning the set of feature values into a plurality of bins based on the optimal bin size; and identifying feature value checkpoints for the corresponding feature based on the plurality of bins.

Moreover, the optimal bin size may be determined by: identifying a plurality of possible bin sizes for binning the set of feature values; computing a plurality of performance costs for the plurality of possible bin sizes; and selecting the optimal bin size from the plurality of possible bin sizes, wherein the optimal bin size corresponds to a lowest performance cost of the plurality of performance costs.

The flowchart then proceeds to block 1306 to train the decision tree model (e.g., a random forest model) based on the training data and the feature value checkpoints. For example, the decision tree model may be trained to predict a target variable corresponding to the feature set (e.g., a class label for classification, a numerical value or range for regression, and so forth). In some embodiments, for example, the decision tree model may be trained to predict failures associated with the edge computing device, and thus the target variable may indicate whether or not a failure is predicted for the edge computing device.

In some embodiments, the decision tree model may be a random forest model with a plurality of decision trees. Thus, the random forest model may be trained by generating a plurality of decision trees based on the training data and the set of feature value checkpoints.

In some embodiments, for example, each decision tree may be generated by: extracting, from the training data, a random training sample for generating a corresponding decision tree of the plurality of decision trees; generating a root node for the decision tree based on the random training sample; selecting, from the feature set, a random subset of features to be evaluated for splitting the root node; obtaining, from the set of feature value checkpoints, a subset of feature value checkpoints for the random subset of features; computing a plurality of impurity values for the subset of feature value checkpoints; selecting, from the subset of feature value checkpoints, a corresponding feature value for splitting the root node, wherein the corresponding feature value is selected based on the plurality of impurity values; and splitting the root node into a set of child nodes based on the corresponding feature value; and repeating the process for the child nodes in a recursive manner until each remaining child node is a leaf node (e.g., a node with either a single data point or multiple data points that all share the same label). In some embodiments, the plurality of impurity values may include, or be based on, a plurality of Gini indexes or computations.

The flowchart then proceeds to block 1308 to determine if new inference data is available. If no new inference data is available, the flowchart may wait at block 1308 until new inference data becomes available, or alternatively, the flowchart may end.

If new inference data is available, the flowchart then proceeds to block 1310 to obtain the inference data (e.g., received via an interface). The inference data corresponds to an unlabeled instance of the feature set, which may be captured at least partially by one or more sensors of the edge computing device.

The flowchart then proceeds to block 1312 to perform inference on the inference data using the trained decision tree model. For example, the decision tree model may be used to predict the target variable for the unlabeled instance of the feature set in the inference data.

The flowchart repeats blocks 1308-1312 in this manner to continue performing inference using the trained decision tree model as new inference data becomes available.

At this point, the flowchart may be complete. In some embodiments, however, the flowchart may restart and/or certain blocks may be repeated. For example, in some embodiments, the flowchart may restart at block 1302 to update and/or retrain the decision tree model based on new training data, and/or the flowchart may proceed to block 1308 to continue performing inference using the decision tree model as new inference data becomes available.

Example Computing Environments

The following sections present examples of computing devices, platforms, systems, and architectures that may be used to implement the optimized decision tree ML functionality described throughout this disclosure.

Edge Computing Architectures

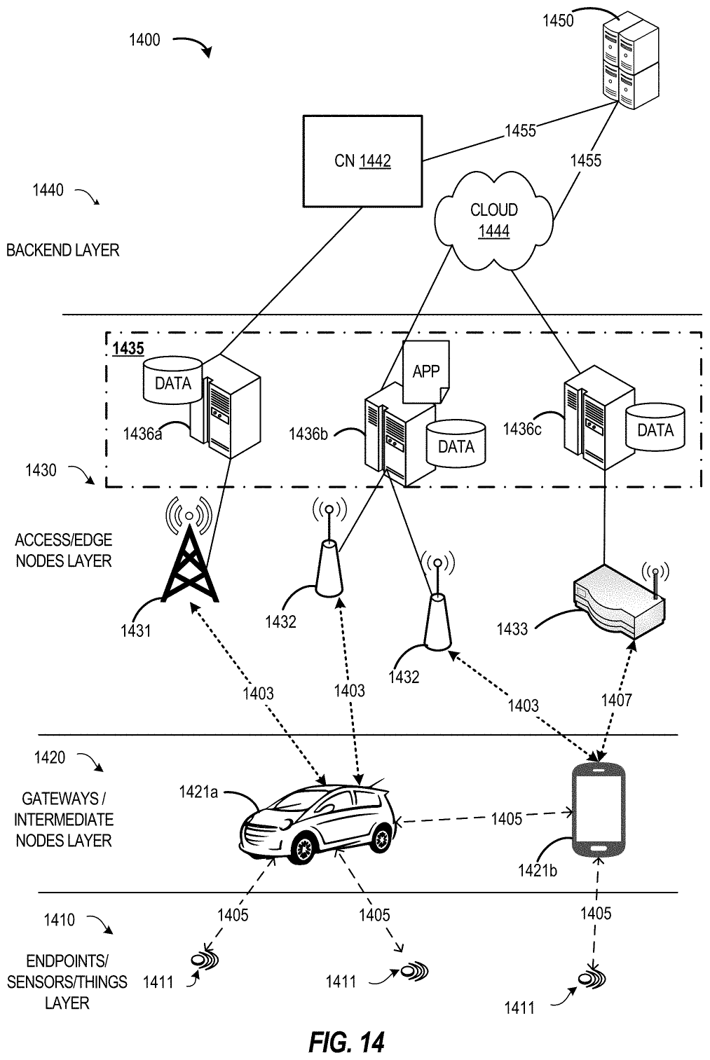

FIG. 14 illustrates an example edge computing environment 1400 in accordance with various embodiments. FIG. 14 specifically illustrates the different layers of communication occurring within the environment 1400, starting from endpoint sensors or things layer 1410 (e.g., operating in an Internet of Things (IoT) network topology) comprising one or more IoT devices 1411 (also referred to as edge endpoints 1410 or the like); increasing in sophistication to gateways or intermediate node layer 1420 comprising one or more user equipment (UEs) 1421a and 1421b (also referred to as intermediate nodes 1420 or the like), which facilitate the collection and processing of data from endpoints 1410; increasing in processing and connectivity sophistication to access node layer 1430 (or “edge node layer 1430”) comprising a plurality of network access nodes (NANs) 1431, 1432, and 1433 (collectively referred to as “NANs 1431-1433” or the like) and a plurality of edge compute nodes 1436a-c (collectively referred to as “edge compute nodes 1436” or the like) within an edge computing system 1435; and increasing in connectivity and processing sophistication to a backend layer 1410 comprising core network (CN) 1442 and cloud 1444. The processing at the backend layer 1410 may be enhanced by network services as performed by a remote application server 1450 and/or other cloud services. Some or all of these elements may be equipped with or otherwise implement some or all aspects of the LPP embodiments discussed infra.

The environment 1400 is shown to include end-user devices, such as intermediate nodes 1420 and endpoints 1410, which are configured to connect to (or communicatively couple with) one or more multiple communication networks (also referred to as “access networks,” “radio access networks,” or the like) based on different access technologies (or “radio access technologies”) for accessing application services. These access networks may include one or more of NANs 1431, 1432, and/or 1433. The NANs 1431-1433 are arranged to provide network connectivity to the end-user devices via respective links 1403, 1407 between the individual NANs and the one or more UEs 1411, 1421.

As examples, the communication networks and/or access technologies may include cellular technology such as LTE, MuLTEfire, and/or NR/5G (e.g., as provided by Radio Access Network (RAN) node 1431 and/or RAN nodes 1432), WiFi or wireless local area network (WLAN) technologies (e.g., as provided by access point (AP) 1433 and/or RAN nodes 1432), and/or the like. Different technologies exhibit benefits and limitations in different scenarios, and application performance in different scenarios becomes dependent on the choice of the access networks (e.g., WiFi, LTE, etc.) and the used network and transport protocols (e.g., Transfer Control Protocol (TCP), Virtual Private Network (VPN), Multi-Path TCP (MPTCP), Generic Routing Encapsulation (GRE), etc.).

The intermediate nodes 1420 include UE 1421a and UE 1421b (collectively referred to as “UE 1421” or “UEs 1421”). In this example, the UE 1421a is illustrated as a vehicle UE, and UE 1421b is illustrated as a smartphone (e.g., handheld touchscreen mobile computing device connectable to one or more cellular networks). However, these UEs 1421 may comprise any mobile or non-mobile computing device, such as tablet computers, wearable devices, PDAs, pagers, desktop computers, laptop computers, wireless handsets, unmanned vehicles or drones, and/or any type of computing device including a wireless communication interface.

The endpoints 1410 include UEs 1411, which may be IoT devices (also referred to as “IoT devices 1411”), which are uniquely identifiable embedded computing devices (e.g., within the Internet infrastructure) that comprise a network access layer designed for low-power IoT applications utilizing short-lived UE connections. The IoT devices 1411 are any physical or virtualized, devices, sensors, or “things” that are embedded with hardware and/or software components that enable the objects, devices, sensors, or “things” capable of capturing and/or recording data associated with an event, and capable of communicating such data with one or more other devices over a network with little or no user intervention. As examples, IoT devices 1411 may be abiotic devices such as autonomous sensors, gauges, meters, image capture devices, microphones, light emitting devices, audio emitting devices, audio and/or video playback devices, electro-mechanical devices (e.g., switch, actuator, etc.), EEMS, ECUs, ECMs, embedded systems, microcontrollers, control modules, networked or “smart” appliances, MTC devices, M2M devices, and/or the like. The IoT devices 1411 can utilize technologies such as M2M or MTC for exchanging data with an MTC server (e.g., a server 1450), an edge server 1436 and/or edge computing system 1435, or device via a PLMN, ProSe or D2D communication, sensor networks, or IoT networks. The M2M or MTC exchange of data may be a machine-initiated exchange of data.

The IoT devices 1411 may execute background applications (e.g., keep-alive messages, status updates, etc.) to facilitate the connections of the IoT network. Where the IoT devices 1411 are, or are embedded in, sensor devices, the IoT network may be a WSN. An IoT network describes an interconnecting IoT UEs, such as the IoT devices 1411 being connected to one another over respective direct links 1405. The IoT devices may include any number of different types of devices, grouped in various combinations (referred to as an “IoT group”) that may include IoT devices that provide one or more services for a particular user, customer, organizations, etc. A service provider (e.g., an owner/operator of server 1450, CN 1442, and/or cloud 1444) may deploy the IoT devices in the IoT group to a particular area (e.g., a geolocation, building, etc.) in order to provide the one or more services. In some implementations, the IoT network may be a mesh network of IoT devices 1411, which may be termed a fog device, fog system, or fog, operating at the edge of the cloud 1444. The fog involves mechanisms for bringing cloud computing functionality closer to data generators and consumers wherein various network devices run cloud application logic on their native architecture. Fog computing is a system-level horizontal architecture that distributes resources and services of computing, storage, control, and networking anywhere along the continuum from cloud 1444 to Things (e.g., IoT devices 1411). The fog may be established in accordance with specifications released by the OFC, the OCF, among others. In some embodiments, the fog may be a tangle as defined by the IOTA foundation.

The fog may be used to perform low-latency computation/aggregation on the data while routing it to an edge cloud computing service (e.g., edge nodes 1430) and/or a central cloud computing service (e.g., cloud 1444) for performing heavy computations or computationally burdensome tasks. On the other hand, edge cloud computing consolidates human-operated, voluntary resources, as a cloud. These voluntary resource may include, inter-alia, intermediate nodes 1420 and/or endpoints 1410, desktop PCs, tablets, smartphones, nano data centers, and the like. In various implementations, resources in the edge cloud may be in one to two-hop proximity to the IoT devices 1411, which may result in reducing overhead related to processing data and may reduce network delay.

In some embodiments, the fog may be a consolidation of IoT devices 1411 and/or networking devices, such as routers and switches, with high computing capabilities and the ability to run cloud application logic on their native architecture. Fog resources may be manufactured, managed, and deployed by cloud vendors, and may be interconnected with high speed, reliable links. Moreover, fog resources reside farther from the edge of the network when compared to edge systems but closer than a central cloud infrastructure. Fog devices are used to effectively handle computationally intensive tasks or workloads offloaded by edge resources.

In embodiments, the fog may operate at the edge of the cloud 1444. The fog operating at the edge of the cloud 1444 may overlap or be subsumed into an edge network 1430 of the cloud 1444. The edge network of the cloud 1444 may overlap with the fog, or become a part of the fog. Furthermore, the fog may be an edge-fog network that includes an edge layer and a fog layer. The edge layer of the edge-fog network includes a collection of loosely coupled, voluntary and human-operated resources (e.g., the aforementioned edge compute nodes 1436 or edge devices). The Fog layer resides on top of the edge layer and is a consolidation of networking devices such as the intermediate nodes 1420 and/or endpoints 1410 of FIG. 14.

Data may be captured, stored/recorded, and communicated among the IoT devices 1411 or, for example, among the intermediate nodes 1420 and/or endpoints 1410 that have direct links 1405 with one another as shown by FIG. 14. Analysis of the traffic flow and control schemes may be implemented by aggregators that are in communication with the IoT devices 1411 and each other through a mesh network. The aggregators may be a type of IoT device 1411 and/or network appliance. In the example of FIG. 14, the aggregators may be edge nodes 1430, or one or more designated intermediate nodes 1420 and/or endpoints 1410. Data may be uploaded to the cloud 1444 via the aggregator, and commands can be received from the cloud 1444 through gateway devices that are in communication with the IoT devices 1411 and the aggregators through the mesh network. Unlike the traditional cloud computing model, in some implementations, the cloud 1444 may have little or no computational capabilities and only serves as a repository for archiving data recorded and processed by the fog. In these implementations, the cloud 1444 centralized data storage system and provides reliability and access to data by the computing resources in the fog and/or edge devices. Being at the core of the architecture, the Data Store of the cloud 1444 is accessible by both Edge and Fog layers of the aforementioned edge-fog network.

As mentioned previously, the access networks provide network connectivity to the end-user devices 1420, 1410 via respective NANs 1431-1433. The access networks may be Radio Access Networks (RANs) such as an NG RAN or a 5G RAN for a RAN that operates in a 5G/NR cellular network, an E-UTRAN for a RAN that operates in an LTE or 4G cellular network, or a legacy RAN such as a UTRAN or GERAN for GSM or CDMA cellular networks. The access network or RAN may be referred to as an Access Service Network for WiMAX implementations. In some embodiments, all or parts of the RAN may be implemented as one or more software entities running on server computers as part of a virtual network, which may be referred to as a cloud RAN (CRAN), Cognitive Radio (CR), a virtual baseband unit pool (vBBUP), and/or the like. In these embodiments, the CRAN, CR, or vBBUP may implement a RAN function split, wherein one or more communication protocol layers are operated by the CRAN/CR/vBBUP and other communication protocol entities are operated by individual RAN nodes 1431, 1432. This virtualized framework allows the freed-up processor cores of the NANs 1431, 1432 to perform other virtualized applications, such as virtualized applications for LPP embodiments discussed herein.

The UEs 1421, 1411 may utilize respective connections (or channels) 1403, each of which comprises a physical communications interface or layer. The connections 1403 are illustrated as an air interface to enable communicative coupling consistent with cellular communications protocols, such as 3GPP LTE, 5G/NR, Push-to-Talk (PTT) and/or PTT over cellular (POC), UMTS, GSM, CDMA, and/or any of the other communications protocols discussed herein. In some embodiments, the UEs 1411, 1421 and the NANs 1431-1433 communicate data (e.g., transmit and receive) data over a licensed medium (also referred to as the “licensed spectrum” and/or the “licensed band”) and an unlicensed shared medium (also referred to as the “unlicensed spectrum” and/or the “unlicensed band”). To operate in the unlicensed spectrum, the UEs 1411, 1421 and NANs 1431-1433 may operate using LAA, enhanced LAA (eLAA), and/or further eLAA (feLAA) mechanisms. The UEs 1421, 1411 may further directly exchange communication data via respective direct links 1405, which may be LTE/NR Proximity Services (ProSe) link or PC5 interfaces/links, or WiFi based links or a personal area network (PAN) based links (e.g., IEEE 802.15.4 based protocols including ZigBee, IPv6 over Low power Wireless Personal Area Networks (6LoWPAN), WirelessHART, MiWi, Thread, etc.; WiFi-direct; Bluetooth/Bluetooth Low Energy (BLE) protocols).

The UEs 1411, 1421 are capable of measuring various signals or determining/identifying various signal/channel characteristics. Signal measurement may be performed for cell selection, handover, network attachment, testing, and/or other purposes. The measurements collected by the UEs 1411, 1421 may include one or more of the following: a bandwidth (BW), network or cell load, latency, jitter, round trip time (RTT), number of interrupts, out-of-order delivery of data packets, transmission power, bit error rate, bit error ratio (BER), Block Error Rate (BLER), packet loss rate, packet reception rate (PRR), signal-to-noise ratio (SNR), signal-to-noise and interference ratio (SINR), signal-plus-noise-plus-distortion to noise-plus-distortion (SINAD) ratio, peak-to-average power ratio (PAPR), Reference Signal Received Power (RSRP), Received Signal Strength Indicator (RSSI), Reference Signal Received Quality (RSRQ), GNSS timing of cell frames for UE positioning for E-UTRAN or 5G/NR (e.g., a timing between a NAN 1431-1433 reference time and a GNSS-specific reference time for a given GNSS), GNSS code measurements (e.g., The GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurement, thermal noise power measurement, received interference power measurement, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR) and RSRP, RSSI, and/or RSRQ measurements of various beacon, Fast Initial Link Setup (FILS) discovery frames, or probe response frames for IEEE 802.11 WLAN/WiFi networks. Other measurements may be additionally or alternatively used, such as those discussed in 3GPP TS 36.214 v15.4.0 (2019-09), 3GPP TS 38.215, IEEE 802.11, Part 11: “Wireless LAN Medium Access Control (MAC) and Physical Layer (PHY) specifications, IEEE Std.”, and/or the like. The same or similar measurements may be measured or collected by the NANs 1431-1433.

The UE 1421b is shown to be configured to access an access point (AP) 1433 via a connection 1407. In this example, the AP 1433 is shown to be connected to the Internet without connecting to the CN 1442 of the wireless system. The connection 1407 can comprise a local wireless connection, such as a connection consistent with any IEEE 802.11 protocol, wherein the AP 1433 would comprise a wireless fidelity (WiFi®) router. In embodiments, the UEs 1421 and IoT devices 1411 can be configured to communicate using suitable communication signals with each other or with any of the AP 1433 over a single or multicarrier communication channel in accordance with various communication techniques, such as, but not limited to, an orthogonal frequency division multiplexing (OFDM) communication technique, a single-carrier frequency division multiple access (SC-FDMA) communication technique, and/or the like, although the scope of the embodiments is not limited in this respect. The communication technique may include a suitable modulation scheme such as Complementary Code Keying (CCK); Phase-Shift Keying (PSK) such as Binary PSK (BPSK), Quadrature PSK (QPSK), Differential PSK (DPSK), etc.; or Quadrature Amplitude Modulation (QAM) such as M-QAM; and/or the like.

The one or more NANs 1431 and 1432 that enable the connections 1403 may be referred to as “RAN nodes” or the like. The RAN nodes 1431, 1432 may comprise ground stations (e.g., terrestrial access points) or satellite stations providing coverage within a geographic area (e.g., a cell). The RAN nodes 1431, 1432 may be implemented as one or more of a dedicated physical device such as a macrocell base station, and/or a low power base station for providing femtocells, picocells or other like cells having smaller coverage areas, smaller user capacity, or higher bandwidth compared to macrocells. In this example, the RAN node 1431 is embodied as a NodeB, evolved NodeB (eNB), or a next generation NodeB (gNB), and the RAN nodes 1432 are embodied as relay nodes, distributed units, or Road Side Unites (RSUs). Any other type of NANs can be used.

Any of the RAN nodes 1431, 1432 can terminate the air interface protocol and can be the first point of contact for the UEs 1421 and IoT devices 1411. In some embodiments, any of the RAN nodes 1431/1432 can fulfill various logical functions for the RAN including, but not limited to, RAN function(s) (e.g., radio network controller (RNC) functions and/or NG-RAN functions) for radio resource management, admission control, uplink and downlink dynamic resource allocation, radio bearer management, data packet scheduling, etc. In embodiments, the UEs 1411, 1421 can be configured to communicate using OFDM communication signals with each other or with any of the NANs 1431, 1432 over a multicarrier communication channel in accordance with various communication techniques, such as, but not limited to, an OFDMA communication technique (e.g., for downlink communications) and/or an SC-FDMA communication technique (e.g., for uplink and ProSe or sidelink communications), although the scope of the embodiments is not limited in this respect.

For most cellular communication systems, the RAN function(s) operated by the RAN or individual NANs 1431-1432 organize downlink transmissions (e.g., from any of the RAN nodes 1431, 1432 to the UEs 1411, 1421) and uplink transmissions (e.g., from the UEs 1411, 1421 to RAN nodes 1431, 1432) into radio frames (or simply “frames”) with 10 millisecond (ms) durations, where each frame includes ten 1 ms subframes. Each transmission direction has its own resource grid that indicate physical resource in each slot, where each column and each row of a resource grid corresponds to one symbol and one subcarrier, respectively. The duration of the resource grid in the time domain corresponds to one slot in a radio frame. The resource grids comprises a number of resource blocks (RBs), which describe the mapping of certain physical channels to resource elements (REs). Each RB may be a physical RB (PRB) or a virtual RB (VRB) and comprises a collection of REs. An RE is the smallest time-frequency unit in a resource grid. The RNC function(s) dynamically allocate resources (e.g., PRBs and modulation and coding schemes (MCS)) to each UE 1411, 1421 at each transmission time interval (TTI). A TTI is the duration of a transmission on a radio link 1403, 1405, and is related to the size of the data blocks passed to the radio link layer from higher network layers.

The NANs 1431/1432 may be configured to communicate with one another via respective interfaces or links (not shown), such as an X2 interface for LTE implementations (e.g., when CN 1442 is an Evolved Packet Core (EPC)), an Xn interface for 5G or NR implementations (e.g., when CN 1442 is an Fifth Generation Core (5GC)), or the like. The NANs 1431 and 1432 are also communicatively coupled to CN 1442. In embodiments, the CN 1442 may be an evolved packet core (EPC) network, a NextGen Packet Core (NPC) network, a 5G core (5GC), or some other type of CN. The CN 1442 may comprise a plurality of network elements, which are configured to offer various data and telecommunications services to customers/subscribers (e.g., users of UEs 1421 and IoT devices 1411) who are connected to the CN 1442 via a RAN. The components of the CN 1442 may be implemented in one physical node or separate physical nodes including components to read and execute instructions from a machine-readable or computer-readable medium (e.g., a non-transitory machine-readable storage medium). In some embodiments, Network Functions Virtualization (NFV) may be utilized to virtualize any or all of the above-described network node functions via executable instructions stored in one or more computer-readable storage mediums (described in further detail infra). A logical instantiation of the CN 1442 may be referred to as a network slice, and a logical instantiation of a portion of the CN 1442 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more CN 1442 components/functions.

The CN 1442 is shown to be communicatively coupled to an application server 1450 and a network 1450 via an IP communications interface 1455. the one or more server(s) 1450 comprise one or more physical and/or virtualized systems for providing functionality (or services) to one or more clients (e.g., UEs 1421 and IoT devices 1411) over a network. The server(s) 1450 may include various computer devices with rack computing architecture component(s), tower computing architecture component(s), blade computing architecture component(s), and/or the like. The server(s) 1450 may represent a cluster of servers, a server farm, a cloud computing service, or other grouping or pool of servers, which may be located in one or more datacenters. The server(s) 1450 may also be connected to, or otherwise associated with one or more data storage devices (not shown). Moreover, the server(s) 1450 may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art. Generally, the server(s) 1450 offer applications or services that use IP/network resources. As examples, the server(s) 1450 may provide traffic management services, cloud analytics, content streaming services, immersive gaming experiences, social networking and/or microblogging services, and/or other like services. In addition, the various services provided by the server(s) 1450 may include initiating and controlling software and/or firmware updates for applications or individual components implemented by the UEs 1421 and IoT devices 1411. The server(s) 1450 can also be configured to support one or more communication services (e.g., Voice-over-Internet Protocol (VoIP) sessions, PTT sessions, group communication sessions, social networking services, etc.) for the UEs 1421 and IoT devices 1411 via the CN 1442.

The cloud 1444 may represent a cloud computing architecture/platform that provides one or more cloud computing services. Cloud computing refers to a paradigm for enabling network access to a scalable and elastic pool of shareable computing resources with self-service provisioning and administration on-demand and without active management by users. Computing resources (or simply “resources”) are any physical or virtual component, or usage of such components, of limited availability within a computer system or network. Examples of resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. Cloud computing provides cloud computing services (or cloud services), which are one or more capabilities offered via cloud computing that are invoked using a defined interface (e.g., an API or the like). Some capabilities of cloud 1444 include application capabilities type, infrastructure capabilities type, and platform capabilities type. A cloud capabilities type is a classification of the functionality provided by a cloud service to a cloud service customer (e.g., a user of cloud 1444), based on the resources used. The application capabilities type is a cloud capabilities type in which the cloud service customer can usethe cloud service provider's applications; the infrastructure capabilities type is a cloud capabilities type in which the cloud service customer can provision and use processing, storage or networking resources; and platform capabilities type is a cloud capabilities type in which the cloud service customer can deploy, manage and run customer-created or customer-acquired applications using one or more programming languages and one or more execution environments supported by the cloud service provider. Cloud services may be grouped into categories that possess some common set of qualities. Some cloud service categories that the cloud 1444 may provide include, for example,

Communications as a Service (CaaS), which is a cloud service category involving real time interaction and collaboration services; Compute as a Service (CompaaS), which is a cloud service category involving the provision and use of processing resources needed to deploy and run software; Database as a Service (DaaS), which is a cloud service category involving the provision and use of database system management services; Data Storage as a Service (DSaaS), which is a cloud service category involving the provision and use of data storage and related capabilities; Firewall as a Service (FaaS), which is a cloud service category involving providing firewall and network traffic management services; Infrastructure as a Service (IaaS), which is a cloud service category involving infrastructure capabilities type; Network as a Service (NaaS), which is a cloud service category involving transport connectivity and related network capabilities; Platform as a Service (PaaS), which is a cloud service category involving the platform capabilities type; Software as a Service (SaaS), which is a cloud service category involving the application capabilities type; Security as a Service, which is a cloud service category involving providing network and information security (infosec) services; Function as a Service (FaaS) to the applications running in the edge devices (e.g., smartphones or IoT) to accelerate their workloads and applications; Acceleration FaaS (AFaaS) an FaaS implementation where functions are implemented and executed in a hardware accelerator, which may be used to further improve edge FaaS capability; Conflict Analysis as a Service (CAaaS); crypto-services (e.g., TLS-aaS, DTLS-aaS); Edge-as-a-Service (EaaS)Orchestration as a Service (OaaS); and/or other like cloud services including various anything-as-a-service (X-aaS) offerings.

In some embodiments, the cloud 1444 may represent a network such as the Internet, a local area network (LAN) or a wide area network (WAN) including proprietary and/or enterprise networks for a company or organization, or combinations thereof. The cloud 1444 may be a network that comprises computers, network connections among the computers, and software routines to enable communication between the computers over network connections. In this regard, the cloud 1444 comprises one or more network elements that may include one or more processors, communications systems (e.g., including network interface controllers, one or more transmitters/receivers connected to one or more antennas, etc.), and computer readable media. Examples of such network elements may include wireless access points (WAPs), home/business servers (with or without RF communications circuitry), routers, switches, hubs, radio beacons, base stations, picocell or small cell base stations, backbone gateways, and/or any other like network device. Connection to the cloud 1444 may be via a wired or a wireless connection using the various communication protocols discussed infra. More than one network may be involved in a communication session between the illustrated devices. Connection to the cloud 1444 may require that the computers execute software routines which enable, for example, the seven layers of the OSI model of computer networking or equivalent in a wireless (cellular) phone network. Cloud 1444 may be used to enable relatively long-range communication such as, for example, between the one or more server(s) 1450 and one or more UEs 1421 and IoT devices 1411. In some embodiments, the cloud 1444 may represent the Internet, one or more cellular networks, local area networks, or wide area networks including proprietary and/or enterprise networks, TCP/Internet Protocol (IP)-based network, or combinations thereof. In such embodiments, the cloud 1444 may be associated with network operator who owns or controls equipment and other elements necessary to provide network-related services, such as one or more base stations or access points, one or more servers for routing digital data or telephone calls (e.g., a core network or backbone network), etc. The backbone links 1455 may include any number of wired or wireless technologies, and may be part of a LAN, a WAN, or the Internet. In one example, the backbone links 1455 are fiber backbone links that couple lower levels of service providers to the Internet, such as the CN 1412 and cloud 1444.

In embodiments, the edge compute nodes 1436 may include or be part of an edge system 1435 (or edge network 1435). The edge compute nodes 1436 may also be referred to as “edge hosts 1436” or “edge servers 1436.” The edge system 1435 includes a collection of edge servers 1436 (e.g., MEC hosts/servers) and edge management systems (not shown by FIG. 14) necessary to run edge computing applications (e.g., MEC Apps) within an operator network or a subset of an operator network. The edge servers 1436 are physical computer systems that may include an edge platform (e.g., an MEC platform) and/or virtualization infrastructure, and provide compute, storage, and network resources to edge computing applications. Each of the edge servers 1436 are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to intermediate nodes 1420 and/or endpoints 1410. The VI of the edge servers 1436 provide virtualized environments and virtualized resources for the edge hosts, and the edge computing applications may run as VMs and/or application containers on top of the VI. One example implementation of the edge system 1435 is a MEC system 1435. It should be understood that the disclosed MEC systems and services deployment examples are only one illustrative example of edge computing systems/networks 1435, and that the example embodiments discussed herein may be applicable to many other edge computing/networking technologies in various combinations and layouts of devices located at the edge of a network. Examples of such other edge computing/networking technologies that may implement the embodiments herein include Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used to practice the embodiments herein.

As shown by FIG. 14, each of the NANs 1431, 1432, and 1433 are co-located with edge compute nodes (or “edge servers”) 1436a, 1436b, and 1436c, respectively. These implementations may be small-cell clouds (SCCs) where an edge compute node 1436 is co-located with a small cell (e.g., pico-cell, femto-cell, etc.), or may be mobile micro clouds (MCCs) where an edge compute node 1436 is co-located with a macro-cell (e.g., an eNB, gNB, etc.). The edge compute node 1436 may be deployed in a multitude of arrangements other than as shown by FIG. 14. In a first example, multiple NANs 1431-1433 are co-located or otherwise communicatively coupled with one edge compute node 1436. In a second example, the edge servers 1436 may be co-located or operated by RNCs, which may be the case for legacy network deployments, such as 3G networks. In a third example, the edge servers 1436 may be deployed at cell aggregation sites or at multi-RAT aggregation points that can be located either within an enterprise or used in public coverage areas. In a fourth example, the edge servers 1436 may be deployed at the edge of CN 1442. These implementations may be used in follow-me clouds (FMC), where cloud services running at distributed data centers follow the UEs 1421 as they roam throughout the network.

In any of the aforementioned embodiments and/or implementations, the edge servers 1436 provide a distributed computing environment for application and service hosting, and also provide storage and processing resources so that data and/or content can be processed in close proximity to subscribers (e.g., users of UEs 1421, 1411) for faster response times The edge servers 1436 also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge servers 1436 from the UEs 1411/1421, CN 1442, cloud 1444, and/or server(s) 1450, or vice versa. For example, a device application or client application operating in a UE 1421/1411 may offload application tasks or workloads to one or more edge servers 1436. In another example, an edge server 1436 may offload application tasks or workloads to one or more UE 1421/1411 (e.g., for distributed ML computation or the like).

Internet-of-Things Architectures

The internet of things (IoT) is a concept in which a large number of computing devices are interconnected to each other and to the Internet to provide functionality and data acquisition at very low levels. As used herein, an IoT device may include a semiautonomous device performing a function, such as sensing or control, among others, in communication with other IoT devices and a wider network, such as the Internet. Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

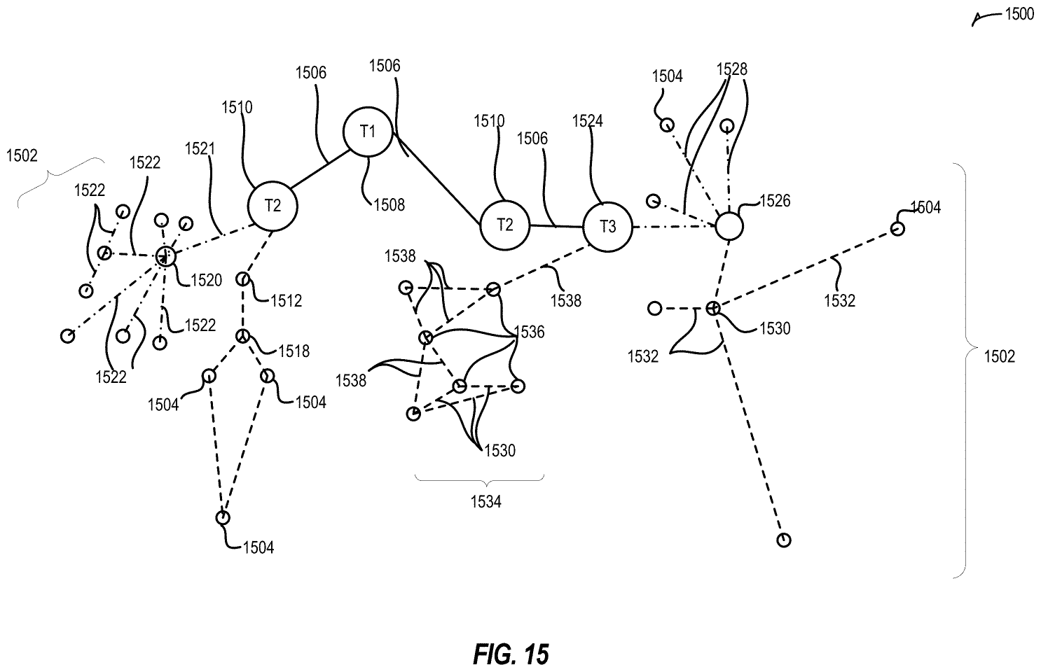

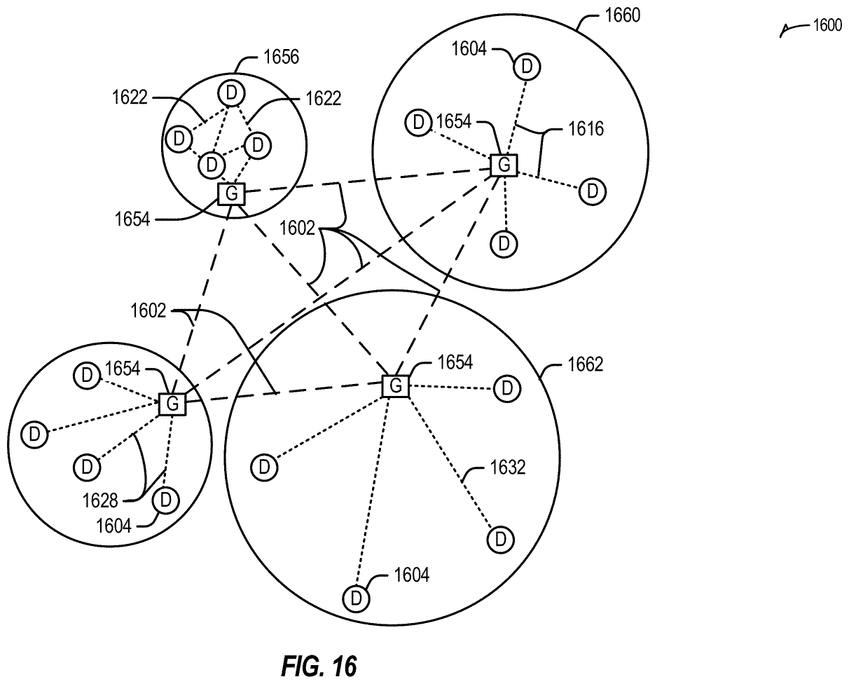

The future growth of the Internet may include very large numbers of IoT devices. Accordingly, as described herein, a number of innovations for the future Internet address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software. The services may be provided in accordance with the Quality of Service (QoS) terms specified in service level and service delivery agreements. The use of IoT devices and networks present a number of new challenges in a heterogeneous network of connectivity comprising a combination of wired and wireless technologies as depicted in FIGS. 15 and 16.

FIG. 15 illustrates an arrangement 1500 showing interconnections that may be present between the Internet and IoT networks, in accordance with various embodiments. The interconnections may couple smaller networks 1502, down to the individual IoT device 1504, to the fiber backbone 1506 of the Internet 1500. To simplify the drawing, not every device 1504, or other object, is labeled.

In FIG. 15, top-level providers, which may be termed tier 1 providers 1508, are coupled by the fiber backbone of the Internet to other providers, such as secondary or tier 2 providers 1510. In one example, a tier 2 provider 1510 may couple to a tower 1512 of an LTE cellular network, for example, by further fiber links, by microwave communications 1514, or by other communications technologies. The tower 1512 may couple to a mesh network including IoT devices 1504 through an LTE communication link 116, for example, through a central node 116. The communications between the individual IoT devices 1504 may also be based on LTE or NR communication links 1516. In another example, a high-speed uplink 1520 may couple a tier 2 provider 1510 to a gateway (GW) 1520. A number of IoT devices 1504 may communicate with the GW 1520, and with each other through the GW 1520, for example, over BLE links 1522.

The fiber backbone 1506 may couple lower levels of service providers to the Internet, such as tier 3 providers 124. A tier 3 provider 1524 may be considered a general Internet service provider (ISP), for example, purchasing access to the fiber backbone 1510 from a tier 2 provider 1510 and providing access to a corporate GW 1526 and other customers. From the corporate GW 1526, a wireless local area network (WLAN) can be used to communicate with IoT devices 1504 through Wi-Fi® links 1528. A Wi-Fi link 128 may also be used to couple to a low power wide area (LPWA) GW 1530, which can communicate with IoT devices 1504 over LPWA links 1532, for example, compatible with the LoRaWan specification promulgated by the LoRa alliance.

The tier 3 provider 1524 may also provide access to a mesh network 1534 through a coordinator device 1536 that communicates with the tier 3 provider 1524 using any number of communications links, such as an LTE cellular link, an LPWA link, or a link 1538 based on the IEEE 802.15.4 standard, such as Zigbee®. Other coordinator devices 1536 may provide a chain of links that forms cluster tree of linked devices.

IoT devices 1504 may be any object, device, sensor, or “thing” that is embedded with hardware and/or software components that enable the object, device, sensor, or “thing” capable of capturing and/or recording data associated with an event, and capable of communicating such data with one or more other devices over a network with little or no user intervention. For instance, in various embodiments, IoT devices 1504 may be abiotic devices such as autonomous sensors, gauges, meters, image capture devices, microphones, machine-type communications (MTC) devices, machine-to-machine (M2M) devices, light emitting devices, audio emitting devices, audio and/or video playback devices, electro-mechanical devices (e.g., switch, actuator, etc.), and the like. In some embodiments, IoT devices 1504 may be biotic devices such as monitoring implants, biosensors, biochips, and the like. In other embodiments, an IoT device 1504 may be a computer device that is embedded in a computer system and coupled with communications circuitry of the computer system. In such embodiments, the IoT device 1504 may be a system on chip (SoC), a universal integrated circuitry card (UICC), an embedded UICC (eUICC), and the like, and the computer system may be a mobile station (e.g., a smartphone) or user equipment, laptop PC, wearable device (e.g., a smart watch, fitness tracker, etc.), “smart” appliance (e.g., a television, refrigerator, a security system, etc.), and the like. As used herein, the term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

Each of the IoT devices 1504 may include one or more memory devices and one or more processors to capture and store/record data. Each of the IoT devices 1504 may include appropriate communications circuitry (e.g., transceiver(s), modem, antenna elements, etc.) to communicate (e.g., transmit and receive) captured and stored/recorded data. Further, each IoT device 1504 may include other transceivers for communications using additional protocols and frequencies. The wireless communications protocols may be any suitable set of standardized rules or instructions implemented by the IoT devices 1504 to communicate with other devices, including instructions for packetizing/depacketizing data, instructions for modulating/demodulating signals, instructions for implementation of protocols stacks, and the like. For example, IoT devices 1504 may include communications circuitry that is configurable to communicate in accordance with one or more person-to-person (P2P) or personal area network (PAN) protocols (e.g., IEEE 802.15.4 based protocols including ZigBee, IPv6 over Low power Wireless Personal Area Networks (6LoWPAN), WirelessHART, MiWi, Thread, etc.; WiFi-direct; Bluetooth/BLE protocols; ANT protocols; Z-Wave; LTE D2D or ProSe; UPnP; and the like); configurable to communicate using one or more LAN and/or WLAN protocols (e.g., Wi-Fi-based protocols or IEEE 802.11 protocols, such as IEEE 802.16 protocols); one or more cellular communications protocols (e.g., LTE/LTE-A, UMTS, GSM, EDGE, Wi-MAX, etc.); and the like. In embodiments, one or more of tower 1512, GW 1520, 1526, and 1530, coordinator device 136, and so forth, may also be incorporated with the embodiments described herein.

The technologies and networks may enable the exponential growth of devices and networks. As the technologies grow, the network may be developed for self-management, functional evolution, and collaboration, without needing direct human intervention. Thus, the technologies will enable networks to function without centralized controlled systems. The technologies described herein may automate the network management and operation functions beyond current capabilities.

FIG. 16 illustrates an example domain topology 1600 that may be used for a number of IoT networks coupled through backbone links 1602 to GWs 1604, in accordance with various embodiments. Like numbered items are as described with respect to FIG. 15. Further, to simplify the drawing, not every device 1604, or communications link 1516, 1522, 1528, or 1532 is labeled. The backbone links 1602 may include any number of wired or wireless technologies, and may be part of a local area network (LAN), a wide area network (WAN), or the Internet. Similar to FIG. 15, in embodiments, one or more of IoT devices 1604/1504, GWs 1604, and so forth, may be incorporated with embodiments described herein.

The network topology 1600 may include any number of types of IoT networks, such as a mesh network 1606 using BLE links 1522. Other IoT networks that may be present include a WLAN network 1608, a cellular network 1610, and an LPWA network 1612. Each of these IoT networks may provide opportunities for new developments, as described herein. For example, communications between IoT devices 1504, such as over the backbone links 1602, may be protected by a decentralized system for authentication, authorization, and accounting (AAA). In a decentralized AAA system, distributed payment, credit, audit, authorization, and authentication systems may be implemented across interconnected heterogeneous infrastructure. This allows systems and networks to move towards autonomous operations.

In these types of autonomous operations, machines may contract for human resources and negotiate partnerships with other machine networks. This may allow the achievement of mutual objectives and balanced service delivery against outlined, planned service level agreements as well as achieve solutions that provide metering, measurements and traceability and trackability. The creation of new supply chain structures and methods may enable a multitude of services to be created, mined for value, and collapsed without any human involvement.

The IoT networks may be further enhanced by the integration of sensing technologies, such as sound, light, electronic traffic, facial and pattern recognition, smell, vibration, into the autonomous organizations. The integration of sensory systems may allow systematic and autonomous communication and coordination of service delivery against contractual service objectives, orchestration and quality of service (QoS) based swarming and fusion of resources.

The mesh network 1606 may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 1608 may use systems that perform standards conversion to provide multi-standard connectivity, enabling IoT devices 1504 using different protocols to communicate. Further systems may provide seamless interconnectivity across a multi-standard infrastructure comprising visible Internet resources and hidden Internet resources. Communications in the cellular network 1610 may be enhanced by systems that offload data, extend communications to more remote devices, or both. The LPWA network 1612 may include systems that perform non-Internet protocol (IP) to IP interconnections, addressing, and routing.

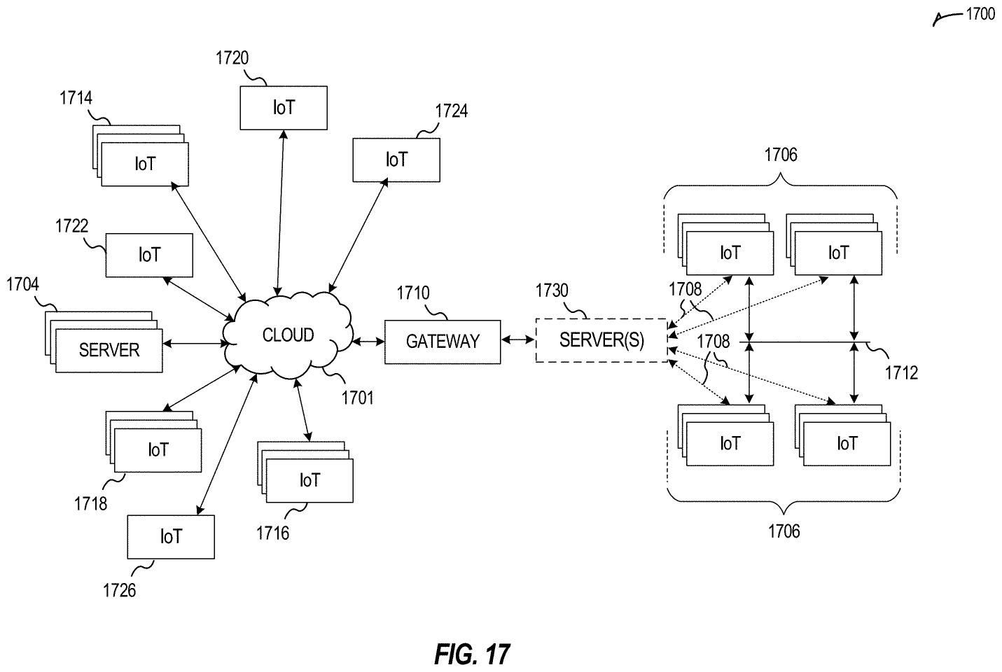

FIG. 17 illustrates an arrangement 1700 of an example cloud computing network, or cloud 1701, in communication with a number of Internet of Things (IoT) devices, in accordance with various embodiments. The cloud 1701 may represent the Internet, one or more cellular networks, a local area network (LAN) or a wide area network (WAN) including proprietary and/or enterprise networks for a company or organization, or combinations thereof. Cloud 1701 may correspond to cloud 1501 of FIG. 17. Components used for such communications system can depend at least in part upon the type of network and/or environment selected. Protocols and components for communicating via such networks are well known and will not be discussed herein in detail. However, it should be appreciated that cloud 1701 may be associated with network operator who owns or controls equipment and other elements necessary to provide network-related services, such as one or more base stations or access points, and one or more servers for routing digital data or telephone calls (for example, a core network or backbone network).

The IoT devices in FIG. 17 may be the same or similar to the IoT devices 1504 discussed with regard to FIGS. 15-16. The IoT devices may include any number of different types of devices, grouped in various combinations, such as IoT group 1706 that may include IoT devices that provide one or more services for a particular user, customer, organizations, etc. A service provider may deploy the IoT devices in the IoT group 1706 to a particular area (e.g., a geolocation, building, etc.) in order to provide the one or more services. In one example, the IoT group 306 may be a traffic control group where the IoT devices in the IoT group 1706 may include stoplights, traffic flow monitors, cameras, weather sensors, and the like, to provide traffic control and traffic analytics services for a particular municipality or other like entity. Similar to FIGS. 15-16, in embodiments, one or more of IoT devices 1714-1724, GW 1710, and so forth, may be incorporated with the various embodiments described herein. For example, in some embodiments, the IoT group 1706, or any of the IoT groups discussed herein, may include the components, devices, systems, and/or functionality discussed with regard to FIGS. 14-19.

The IoT group 1706, or other subgroups, may be in communication with the cloud 1701 through wireless links 1708, such as LPWA links, and the like. Further, a wired or wireless sub-network 1712 may allow the IoT devices to communicate with each other, such as through a local area network, a wireless local area network, and the like. The IoT devices may use another device, such as a GW 1710 to communicate with the cloud 1701. Other groups of IoT devices may include remote weather stations 1714, local information terminals 1716, alarm systems 1716, automated teller machines 1720, alarm panels 1722, or moving vehicles, such as emergency vehicles 1724 or other vehicles 1726, among many others. Each of these IoT devices may be in communication with other IoT devices, with servers 1704, or both.

As can be seen from FIG. 17, a large number of IoT devices may be communicating through the cloud 1701. This may allow different IoT devices to request or provide information to other devices autonomously. For example, the IoT group 1706 may request a current weather forecast from a group of remote weather stations 1714, which may provide the forecast without human intervention. Further, an emergency vehicle 1724 may be alerted by an automated teller machine 1720 that a burglary is in progress. As the emergency vehicle 1724 proceeds towards the automated teller machine 1720, it may access the traffic control group 1706 to request clearance to the location, for example, by lights turning red to block cross traffic at an intersection in sufficient time for the emergency vehicle 1724 to have unimpeded access to the intersection.

In another example, the IoT group 1706 may be an industrial control group (also referred to as a “connected factory”, an “industry 4.0” group, and the like) where the IoT devices in the IoT group 1706 may include machines or appliances with embedded IoT devices, radiofrequency identification (RFID) readers, cameras, client computer devices within a manufacturing plant, and the like, to provide production control, self-optimized or decentralized task management services, analytics services, etc. for a particular manufacturer or factory operator. In this example, the IoT group 1706 may communicate with the servers 1704 via GW 1710 and cloud 1701 to provide captured data, which may be used to provide performance monitoring and analytics to the manufacturer or factory operator. Additionally, the IoT devices in the IoT group 1706 may communicate among each other, and/or with other IoT devices of other IoT groups, to make decisions on their own and to perform their tasks as autonomously as possible.

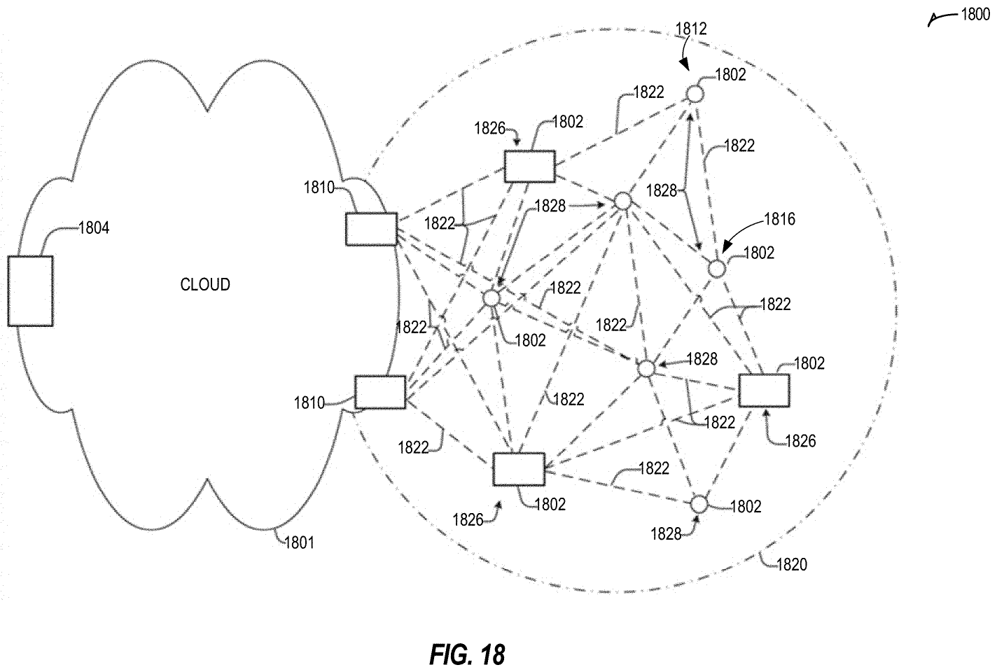

Clusters of IoT devices, such as the IoT groups depicted by FIG. 17, may be equipped to communicate with other IoT devices as well as with the cloud 1701. This may allow the IoT devices to form an ad-hoc network between the devices, allowing them to function as a single device, which may be termed a fog device. This is discussed further with respect to FIG. 18.

FIG. 18 illustrates an arrangement 1800 of a cloud computing network, or cloud 1801, in communication with a mesh network of IoT devices, which may be termed a fog device 1820 or fog 1820, operating at the edge of the cloud 1801, in accordance with various embodiments. Cloud 1801 may be the same or similar to cloud 1501 of FIG. 15 and cloud 1701 of FIG. 17. Like numbered items are as described with respect to FIGS. 15-17. In this example, the fog 1820 is a group of IoT devices at an intersection. The fog 1820 may be established in accordance with specifications released by the OpenFog Consortium (OFC), the Open Connectivity Foundation™ (OCF), among others.

In embodiments, fog computing systems, such as fog 1820, may be mechanisms for bringing cloud computing functionality closer to data generators and consumers wherein various network devices run cloud application logic on their native architecture. Fog computing systems may be used to perform low-latency computation/aggregation on the data while routing it to a central cloud computing service for performing heavy computations or computationally burdensome tasks. On the other hand, edge cloud computing consolidates human-operated, voluntary resources such as desktop PCs, tablets, smartphones, nano data centers as a cloud. In various implementations, resources in the edge cloud may be in one to two-hop proximity to the IoT devices 1804, which may result in reducing overhead related to processing data and may reduce network delay.

In some embodiments, the fog 1820 may be a consolidation of IoT devices 1804 and/or networking devices, such as routers and switches, with high computing capabilities and the ability to run cloud application logic on their native architecture. Fog resources may be manufactured, managed, and deployed by cloud vendors, and may be interconnected with highspeed, reliable links. Moreover, Fog resources reside farther from the edge of the network when compared to edge systems but closer than a central cloud infrastructure. Fog devices are used to effectively handle computationally intensive tasks offloaded by edge resources.

In embodiments, the fog 1820 may operate at the edge of the cloud 1801. In some embodiments, the fog 1820 operating at the edge of the cloud 1801 may overlap or be subsumed into an edge network of the cloud 1801. In embodiments, the edge network of the cloud 1801 may overlap with the fog 1820, or become a part of the fog 1820. Furthermore, the fog 1820 may be an edge-fog network that includes an edge layer and a fog layer. The edge layer of the edge-fog network includes a collection of loosely coupled, voluntary and human-operated resources (e.g., the aforementioned edge devices). The Fog layer resides on top of the edge layer and is a consolidation of networking devices such as those discussed herein.

Data may be captured, stored/recorded, and communicated among the IoT devices 1804. Analysis of the traffic flow and control schemes may be implemented by aggregators 1826 that are in communication with the IoT devices 1804 and each other through a mesh network. Data may be uploaded to the cloud 1801, and commands received from the cloud 1801, through GWs 1810 that are in communication with the IoT devices 1804 and the aggregators 1806 through the mesh network. Unlike the traditional cloud computing model, in some implementations, the cloud 1801 may have little or no computational capabilities and only serves as a repository for archiving data recorded and processed by the fog 1820. In these implementations, the cloud 1801 centralized data storage system and provides reliability and access to data by the computing resources in the fog 1820 and/or edge devices. Being at the core of the architecture, the Data Store is accessible by both Edge and Fog layers of the aforementioned edge-fog network.

Similar to FIGS. 15-17, in embodiments, one or more of IoT devices 1804, aggregators 1826, and so forth, may be incorporated with the various embodiments described herein, in particular, with references to FIGS. 14-19. For example, in some embodiments, the fog 1820, or any of grouping of devices discussed herein, may include the one or more components, devices systems, etc. discussed infra with regard to FIGS. 14-19.

Any number of communications links may be used in the fog 1820. Shorter-range links 1808, for example, compatible with IEEE 802.15.4 may provide local communications between IoT devices that are proximate to one another or other devices. Longer-range links 1810, for example, compatible with LPWA standards, may provide communications between the IoT devices and the GWs 1810. To simplify the diagram, not every communications link 1808 or 1810 is labeled with a reference number.

The fog 1820 may be considered to be a massively interconnected network wherein a number of IoT devices are in communications with each other, for example, by the communication links 1822. In various embodiments, the communication links 1822 may include wired communication links, wireless communication links, and/or a combination of wired and wireless communication links. Not all communication links are shown and/or labeled for clarity. In some embodiments, one or more of the communication links 1822 may be radio communication links. The cloud 1801 and the fog 1820 may be established using the open interconnect consortium (OIC) standard specification 1.0 released by the Open Connectivity Foundation™ (OCF) on Dec. 23, 2015. This standard allows devices to discover each other and establish communications for interconnects. Other interconnection protocols may also be used, including, for example, the AllJoyn protocol from the AllSeen alliance, the optimized link state routing (OLSR) Protocol, or the better approach to mobile ad-hoc networking (B.A.T.M.A.N), among many others.

Three types of IoT devices 1802 are shown in this example, GWs 1810, data aggregators 1826, and sensors 1828, although any suitable combination of IoT devices 1802 and functionality may be used in various embodiments. The GWs 1810 may correspond to a computer system or platform having components and/or functionality described with respect to FIG. 19. The GWs 1810 may be edge devices that provide communications between the cloud 1801 and the fog 1820, and may also provide a backend process function for data obtained from the sensors 1828, such as motion data, flow data, temperature data, and the like. The data aggregators 1826 may collect data from any number of the sensors 1828, and may perform the back end processing function for the analysis. The results, raw data, or both may be passed along to the cloud 1801 through the GWs 1810. The sensors 1828 may be full IoT devices 1802 in some embodiments, capable of both collecting data and processing the data. In some embodiments, the sensors 1828 may be more limited in functionality and may collect the data but may allow the data aggregators 1826 or GWs 1810 to process the data. In some embodiments, one or more of the data aggregators 1826 or other components of the fog 1820 may be or include components of a managed client.

Communications from any IoT device may be passed along the most convenient path between any of the IoT devices to reach the GWs 1810. In these networks, the number of interconnections may provide substantial redundancy, allowing communications to be maintained, even with the loss of a number of IoT devices. Further, the use of a mesh network may allow IoT devices 1802 that are very low power or located at a distance from infrastructure to be used, as the range to connect to another IoT device 1802 may be much less than the range to connect to the GWs 1810 in some embodiments

Not all of the IoT devices may be permanent members of the fog 1820. In the example of FIG. 18, three transient IoT devices have joined the fog 1820, a first mobile device 1812, a second mobile device 1814, and a third mobile device 1816. The fog 1820 may be presented to clients in the cloud 1801, such as the server 1804, as a single device located at the edge of the cloud 1801. In this example, the control communications to specific resources in the fog 1820 may occur without identifying any specific IoT device 1804 within the fog 1820. Accordingly, if any IoT device 1804 fails, other IoT devices 1804 may be able to discover and control a resource. For example, the IoT devices 1804 may be wired so as to allow any one of the IoT devices 1804 to control measurements, inputs, outputs, etc., for the other IoT devices 1804. The aggregators 1826 may also provide redundancy in the control of the IoT devices 1804 and other functions of the fog 1820.

In some examples, the IoT devices may be configured using an imperative programming style, e.g., with each IoT device having a specific function and communication partners. However, the IoT devices forming the fog 1820 may be configured in a declarative programming style, allowing the IoT devices to reconfigure their operations and communications, such as to determine needed resources in response to conditions, queries, and device failures. This may be performed as transient IoT devices, such as the devices 1812, 1814, 1816, join the fog 1820. As transient or mobile IoT devices enter or leave the fog f420, the fog 1820 may reconfigure itself to include those devices. This may be performed by forming a temporary group of the devices 1812 and 1814 and the third mobile device 1816 to control or otherwise communicate with the IoT devices 1804. If one or both of the devices 1812, 1814 are autonomous, the temporary group may provide instructions to the devices 1812, 1814. As the transient devices 1812, 1814, and 1816, leave the vicinity of the fog 1820, it may reconfigure itself to eliminate those IoT devices from the network. The fog 1820 may also divide itself into functional units, such as the IoT devices 1804 and other IoT devices proximate to a particular area or geographic feature, or other IoT devices that perform a particular function. This type of combination may enable the formation of larger IoT constructs using resources from the fog 1820.

As illustrated by the fog 1820, the organic evolution of IoT networks is central to maximizing the utility, availability and resiliency of IoT implementations. Further, the example indicates the usefulness of strategies for improving trust and therefore security. The local identification of devices may be important in implementations, as the decentralization of identity ensures a central authority cannot be exploited to allow impersonation of objects that may exist within the IoT networks. Further, local identification lowers communication overhead and latency.

Example Computing Devices, Systems, and Platforms

FIG. 19 illustrates an example of a computing platform 1900 (also referred to as “system 1900,” “device 1900,” “appliance 1900,” or the like) in accordance with various embodiments. In embodiments, the platform 1900 may be suitable for use as intermediate nodes 1420 and/or endpoints 1410 of FIG. 14, IoT devices 1504-1804 of FIGS. 15-18, and/or any other element/device discussed herein with regard any other figure shown and described herein. Platform 1900 may also be implemented in or as a server computer system or some other element, device, or system discussed herein. The platform 1900 may include any combinations of the components shown in the example. The components of platform 1900 may be implemented as integrated circuits (ICs), portions thereof, discrete electronic devices, or other modules, logic, hardware, software, firmware, or a combination thereof adapted in the computer platform 1900, or as components otherwise incorporated within a chassis of a larger system. The example of FIG. 19 is intended to show a high level view of components of the computer platform 1900. However, some of the components shown may be omitted, additional components may be present, and different arrangement of the components shown may occur in other implementations.

The platform 1900 includes processor circuitry 1902. The processor circuitry 1902 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1902 may include one or more hardware accelerators, which may be microprocessors, programmable processing devices (e.g., FPGA, ASIC, etc.), or the like. The one or more hardware accelerators may include, for example, computer vision and/or deep learning accelerators. In some implementations, the processor circuitry 1902 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of processor circuitry 1902 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, or any suitable combination thereof. The processors (or cores) of the processor circuitry 1902 may be coupled with or may include memory/storage and may be configured to execute instructions stored in the memory/storage to enable various applications or operating systems to run on the platform 1900. In these embodiments, the processors (or cores) of the processor circuitry 1902 is configured to operate application software to provide a specific service to a user of the platform 1900. In some embodiments, the processor circuitry 1902 may be a special-purpose processor/controller to operate according to the various embodiments herein.

As examples, the processor circuitry 1902 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, Calif. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor circuitry 1902 may be a part of a system on a chip (SoC), System-in-Package (SiP), a multi-chip package (MCP), and/or the like, in which the processor circuitry 1902 and other components are formed into a single integrated circuit, or a single package, such as the Edison™ or Galileo™ SoC boards from Intel® Corporation. Other examples of the processor circuitry 1902 are mentioned elsewhere in the present disclosure.

Additionally or alternatively, processor circuitry 1902 may include circuitry such as, but not limited to, one or more FPDs such as FPGAs and the like; PLDs such as CPLDs, HCPLDs, and the like; ASICs such as structured ASICs and the like; PSoCs; and the like. In such embodiments, the circuitry of processor circuitry 1902 may comprise logic blocks or logic fabric including and other interconnected resources that may be programmed to perform various functions, such as the procedures, methods, functions, etc. of the various embodiments discussed herein. In such embodiments, the circuitry of processor circuitry 1902 may include memory cells (e.g., EPROM, EEPROM, flash memory, static memory (e.g., SRAM, anti-fuses, etc.) used to store logic blocks, logic fabric, data, etc. in LUTs and the like.

The processor circuitry 1902 may communicate with system memory circuitry 1904 over an interconnect 1906 (e.g., a bus). Any number of memory devices may be used to provide for a given amount of system memory. As examples, the memory circuitry 1904 may be random access memory (RAM) in accordance with a Joint Electron Devices Engineering Council (JEDEC) design such as the DDR or mobile DDR standards (e.g., LPDDR, LPDDR2, LPDDR3, or LPDDR4), dynamic RAM (DRAM), and/or synchronous DRAM (SDRAM)). The memory circuitry 1904 may also include nonvolatile memory (NVM) such as high-speed electrically erasable memory (commonly referred to as “flash memory”), phase change RAM (PRAM), resistive memory such as magnetoresistive random access memory (MRAM), etc., and may incorporate three-dimensional (3D) cross-point (XPOINT) memories from Intel® and Micron®. The memory circuitry 1904 may also comprise persistent storage devices, which may be temporal and/or persistent storage of any type, including, but not limited to, non-volatile memory, optical, magnetic, and/or solid state mass storage, and so forth.

The individual memory devices of memory circuitry 1904 may be implemented as one or more of solder down packaged integrated circuits, socketed memory modules, and plug-in memory cards. The memory circuitry 1904 may be implemented as any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs. In embodiments, the memory circuitry 1904 may be disposed in or on a same die or package as the processor circuitry 1902 (e.g., a same SoC, a same SiP, or soldered on a same MCP as the processor circuitry 1902).

To provide for persistent storage of information such as data, applications, operating systems (OS), and so forth, a storage circuitry 1908 may also couple to the processor circuitry 1902 via the interconnect 1906. In an example, the storage circuitry 1908 may be implemented via a solid-state disk drive (SSDD). Other devices that may be used for the storage circuitry 1908 include flash memory cards, such as SD cards, microSD cards, xD picture cards, and the like, and USB flash drives. In low power implementations, the storage circuitry 1908 may be on-die memory or registers associated with the processor circuitry 1902. However, in some examples, the storage circuitry 1908 may be implemented using a micro hard disk drive (HDD). Further, any number of new technologies may be used for the storage circuitry 1908 in addition to, or instead of, the technologies described, such resistance change memories, phase change memories, holographic memories, or chemical memories, among others.

The storage circuitry 1908 store computational logic 1983 (or “modules 1983”) in the form of software, firmware, or hardware commands to implement the techniques described herein. The computational logic 1983 may be employed to store working copies and/or permanent copies of computer programs, or data to create the computer programs, for the operation of various components of platform 1900 (e.g., drivers, etc.), an OS of platform 1900 and/or one or more applications for carrying out the embodiments discussed herein. The computational logic 1983 may be stored or loaded into memory circuitry 1904 as instructions 1982, or data to create the instructions 1982, for execution by the processor circuitry 1902 to provide the functions described herein. The various elements may be implemented by assembler instructions supported by processor circuitry 1902 or high-level languages that may be compiled into such instructions (e.g., instructions 1970, or data to create the instructions 1970). The permanent copy of the programming instructions may be placed into persistent storage devices of storage circuitry 1908 in the factory or in the field through, for example, a distribution medium (not shown), through a communication interface (e.g., from a distribution server (not shown)), or over-the-air (OTA).

In an example, the instructions 1982 provided via the memory circuitry 1904 and/or the storage circuitry 1908 of FIG. 19 are embodied as one or more non-transitory computer readable storage media (see e.g., NTCRSM 1960) including program code, a computer program product or data to create the computer program, with the computer program or data, to direct the processor circuitry 1902 of platform 1900 to perform electronic operations in the platform 1900, and/or to perform a specific sequence or flow of actions, for example, as described with respect to the flowchart(s) and block diagram(s) of operations and functionality depicted previously. The processor circuitry 1902 accesses the one or more non-transitory computer readable storage media over the interconnect 1906.

In alternate embodiments, programming instructions (or data to create the instructions) may be disposed on multiple NTCRSM 1960. In alternate embodiments, programming instructions (or data to create the instructions) may be disposed on computer-readable transitory storage media, such as, signals. The instructions embodied by a machine-readable medium may further be transmitted or received over a communications network using a transmission medium via a network interface device utilizing any one of a number of transfer protocols (e.g., HTTP). Any combination of one or more computer usable or computer readable medium(s) may be utilized. The computer-usable or computer-readable medium may be, for example but not limited to, one or more electronic, magnetic, optical, electromagnetic, infrared, or semiconductor systems, apparatuses, devices, or propagation media. For instance, the NTCRSM 1960 may be embodied by devices described for the storage circuitry 1908 and/or memory circuitry 1904. More specific examples (a non-exhaustive list) of a computer-readable medium would include the following: an electrical connection having one or more wires, a portable computer diskette, a hard disk, a random access memory (RAM), a read-only memory (ROM), an erasable programmable read-only memory (EPROM, Flash memory, etc.), an optical fiber, a portable compact disc read-only memory (CD-ROM), an optical storage device and/or optical disks, a transmission media such as those supporting the Internet or an intranet, a magnetic storage device, or any number of other hardware devices. Note that the computer-usable or computer-readable medium could even be paper or another suitable medium upon which the program (or data to create the program) is printed, as the program (or data to create the program) can be electronically captured, via, for instance, optical scanning of the paper or other medium, then compiled, interpreted, or otherwise processed in a suitable manner, if necessary, and then stored in a computer memory (with or without having been staged in or more intermediate storage media). In the context of this document, a computer-usable or computer-readable medium may be any medium that can contain, store, communicate, propagate, or transport the program (or data to create the program) for use by or in connection with the instruction execution system, apparatus, or device. The computer-usable medium may include a propagated data signal with the computer-usable program code (or data to create the program code) embodied therewith, either in baseband or as part of a carrier wave. The computer usable program code (or data to create the program) may be transmitted using any appropriate medium, including but not limited to wireless, wireline, optical fiber cable, RF, etc.

In various embodiments, the program code (or data to create the program code) described herein may be stored in one or more of a compressed format, an encrypted format, a fragmented format, a packaged format, etc. Program code (or data to create the program code) as described herein may require one or more of installation, modification, adaptation, updating, combining, supplementing, configuring, decryption, decompression, unpacking, distribution, reassignment, etc. in order to make them directly readable and/or executable by a computing device and/or other machine. For example, the program code (or data to create the program code) may be stored in multiple parts, which are individually compressed, encrypted, and stored on separate computing devices, wherein the parts when decrypted, decompressed, and combined form a set of executable instructions that implement the program code (the data to create the program code such as that described herein. In another example, the Program code (or data to create the program code) may be stored in a state in which they may be read by a computer, but require addition of a library (e.g., a dynamic link library), a software development kit (SDK), an application programming interface (API), etc. in order to execute the instructions on a particular computing device or other device. In another example, the program code (or data to create the program code) may need to be configured (e.g., settings stored, data input, network addresses recorded, etc.) before the program code (or data to create the program code) can be executed/used in whole or in part. In this example, the program code (or data to create the program code) may be unpacked, configured for proper execution, and stored in a first location with the configuration instructions located in a second location distinct from the first location. The configuration instructions can be initiated by an action, trigger, or instruction that is not co-located in storage or execution location with the instructions enabling the disclosed techniques. Accordingly, the disclosed program code (or data to create the program code) are intended to encompass such machine readable instructions and/or program(s) (or data to create such machine readable instruction and/or programs) regardless of the particular format or state of the machine readable instructions and/or program(s) when stored or otherwise at rest or in transit.

Computer program code for carrying out operations of the present disclosure (e.g., computational logic 1983, instructions 1982, 1970 discussed previously) may be written in any combination of one or more programming languages, including an object oriented programming language such as Python, Ruby, Scala, Smalltalk, Java™, C++, C#, or the like; a procedural programming languages, such as the “C” programming language, the Go (or “Golang”) programming language, or the like; a scripting language such as JavaScript, Server-Side JavaScript (SSJS), JQuery, PHP, Pearl, Python, Ruby on Rails, Accelerated Mobile Pages Script (AMPscript), Mustache Template Language, Handlebars Template Language, Guide Template Language (GTL), PHP, Java and/or Java Server Pages (JSP), Node.js, ASP.NET, JAMscript, and/or the like; a markup language such as Hypertext Markup Language (HTML), Extensible Markup Language (XML), Java Script Object Notion (JSON), Apex®, Cascading Stylesheets (CSS), JavaServer Pages (JSP), MessagePack™, Apache® Thrift, Abstract Syntax Notation One (ASN.1), Google® Protocol Buffers (protobuf), or the like; some other suitable programming languages including proprietary programming languages and/or development tools, or any other languages tools. The computer program code for carrying out operations of the present disclosure may also be written in any combination of the programming languages discussed herein. The program code may execute entirely on the system 1900, partly on the system 1900, as a stand-alone software package, partly on the system 1900 and partly on a remote computer or entirely on the remote computer or server. In the latter scenario, the remote computer may be connected to the system 1900 through any type of network, including a LAN or WAN, or the connection may be made to an external computer (e.g., through the Internet using an Internet Service Provider).

In an example, the instructions 1970 on the processor circuitry 1902 (separately, or in combination with the instructions 1982 and/or logic/modules 1983 stored in computer-readable storage media) may configure execution or operation of a trusted execution environment (TEE) 1990. The TEE 1990 operates as a protected area accessible to the processor circuitry 1902 to enable secure access to data and secure execution of instructions. In some embodiments, the TEE 1990 may be a physical hardware device that is separate from other components of the system 1900 such as a secure-embedded controller, a dedicated SoC, or a tamper-resistant chipset or microcontroller with embedded processing devices and memory devices. Examples of such embodiments include a Desktop and mobile Architecture Hardware (DASH) compliant Network Interface Card (NIC), Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology (AMT) and/or Intel® vPro™ Technology; AMD® Platform Security coProcessor (PSP), AMD® PRO A-Series Accelerated Processing Unit (APU) with DASH manageability, Apple® Secure Enclave coprocessor; IBM® Crypto Express3®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II (DRAC II), integrated Dell™ Remote Assistant Card (iDRAC), and the like.

In other embodiments, the TEE 1990 may be implemented as secure enclaves, which are isolated regions of code and/or data within the processor and/or memory/storage circuitry of the system 1900. Only code executed within a secure enclave may access data within the same secure enclave, and the secure enclave may only be accessible using the secure application (which may be implemented by an application processor or a tamper-resistant microcontroller). Various implementations of the TEE 1990, and an accompanying secure area in the processor circuitry 1902 or the memory circuitry 1904 and/or storage circuitry 1908 may be provided, for instance, through use of Intel® Software Guard Extensions (SGX), ARM® TrustZone® hardware security extensions, Keystone Enclaves provided by Oasis Labs™, and/or the like. Other aspects of security hardening, hardware roots-of-trust, and trusted or protected operations may be implemented in the device 1900 through the TEE 1990 and the processor circuitry 1902.

In some embodiments, the memory circuitry 1904 and/or storage circuitry 1908 may be divided into isolated user-space instances such as containers, partitions, virtual environments (VEs), etc. The isolated user-space instances may be implemented using a suitable OS-level virtualization technology such as Docker® containers, Kubernetes® containers, Solaris® containers and/or zones, OpenVZ® virtual private servers, DragonFly BSD® virtual kernels and/or jails, chroot jails, and/or the like. Virtual machines could also be used in some implementations. In some embodiments, the memory circuitry 1904 and/or storage circuitry 1908 may be divided into one or more trusted memory regions for storing applications or software modules of the TEE 1990.

Although the instructions 1982 are shown as code blocks included in the memory circuitry 1904 and the computational logic 1983 is shown as code blocks in the storage circuitry 1908, it should be understood that any of the code blocks may be replaced with hardwired circuits, for example, built into an FPGA, ASIC, or some other suitable circuitry. For example, where processor circuitry 1902 includes (e.g., FPGA based) hardware accelerators as well as processor cores, the hardware accelerators (e.g., the FPGA cells) may be pre-configured (e.g., with appropriate bit streams) with the aforementioned computational logic to perform some or all of the functions discussed previously (in lieu of employment of programming instructions to be executed by the processor core(s)).

The memory circuitry 1904 and/or storage circuitry 1908 may store program code of an operating system (OS), which may be a general purpose OS or an OS specifically written for and tailored to the computing platform 1900. For example, the OS may be Unix or a Unix-like OS such as Linux e.g., provided by Red Hat Enterprise, Windows 10™ provided by Microsoft Corp.®, macOS provided by Apple Inc.®, or the like. In another example, the OS may be a mobile OS, such as Android® provided by Google Inc.®, iOS® provided by Apple Inc.®, Windows 10 Mobile® provided by Microsoft Corp.®, KaiOS provided by KaiOS Technologies Inc., or the like. In another example, the OS may be a real-time OS (RTOS), such as Apache Mynewt provided by the Apache Software Foundation®, Windows 10 For IoT® provided by Microsoft Corp.®, Micro-Controller Operating Systems (“MicroC/OS” or “μC/OS”) provided by Micrium®, Inc., FreeRTOS, VxWorks® provided by Wind River Systems, Inc.®, PikeOS provided by Sysgo AG®, Android Things® provided by Google Inc.®, QNX® RTOS provided by BlackBerry Ltd., or any other suitable RTOS, such as those discussed herein.

The OS may include one or more drivers that operate to control particular devices that are embedded in the platform 1900, attached to the platform 1900, or otherwise communicatively coupled with the platform 1900. The drivers may include individual drivers allowing other components of the platform 1900 to interact or control various I/O devices that may be present within, or connected to, the platform 1900. For example, the drivers may include a display driver to control and allow access to a display device, a touchscreen driver to control and allow access to a touchscreen interface of the platform 1900, sensor drivers to obtain sensor readings of sensor circuitry 1921 and control and allow access to sensor circuitry 1921, actuator drivers to obtain actuator positions of the actuators 1922 and/or control and allow access to the actuators 1922, a camera driver to control and allow access to an embedded image capture device, audio drivers to control and allow access to one or more audio devices. The OSs may also include one or more libraries, drivers, APIs, firmware, middleware, software glue, etc., which provide program code and/or software components for one or more applications to obtain and use the data from a secure execution environment, trusted execution environment, and/or management engine of the platform 1900 (not shown).

The components may communicate over the IX 1906. The IX 1906 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidlO™ system IXs, CCIX, Gen-Z Consortium IXs, a HyperTransport interconnect, NVLink provided by NVIDIA®, a Time-Trigger Protocol (TTP) system, a FlexRay system, and/or any number of other IX technologies. The IX 1906 may be a proprietary bus, for example, used in a SoC based system.

The interconnect 1906 couples the processor circuitry 1902 to the communication circuitry 1909 for communications with other devices. The communication circuitry 1909 is a hardware element, or collection of hardware elements, used to communicate over one or more networks (e.g., cloud 1901) and/or with other devices (e.g., mesh devices/fog 1964). The communication circuitry 1909 includes baseband circuitry 1910 (or “modem 1910”) and RF circuitry 1911 and 1912.

The baseband circuitry 1910 includes one or more processing devices (e.g., baseband processors) to carry out various protocol and radio control functions. Baseband circuitry 1910 may interface with application circuitry of platform 1900 (e.g., a combination of processor circuitry 1902, memory circuitry 1904, and/or storage circuitry 1908) for generation and processing of baseband signals and for controlling operations of the RF circuitry 1911 or 1912. The baseband circuitry 1910 may handle various radio control functions that enable communication with one or more radio networks via the RF circuitry 1911 or 1912. The baseband circuitry 1910 may include circuitry such as, but not limited to, one or more single-core or multi-core processors (e.g., one or more baseband processors) or control logic to process baseband signals received from a receive signal path of the RF circuitry 1911 and/or 1912, and to generate baseband signals to be provided to the RF circuitry 1911 or 1912 via a transmit signal path. In various embodiments, the baseband circuitry 1910 may implement an RTOS to manage resources of the baseband circuitry 1910, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein.

Although not shown by FIG. 19, in one embodiment, the baseband circuitry 1910 includes individual processing device(s) to operate one or more wireless communication protocols (e.g., a “multi-protocol baseband processor” or “protocol processing circuitry”) and individual processing device(s) to implement PHY functions. In this embodiment, the protocol processing circuitry operates or implements various protocol layers/entities of one or more wireless communication protocols. In a first example, the protocol processing circuitry may operate LTE protocol entities and/or 5G)/NR protocol entities when the communication circuitry 1909 is a cellular radiofrequency communication system, such as millimeter wave (mmWave) communication circuitry or some other suitable cellular communication circuitry. In the first example, the protocol processing circuitry 1902 would operate MAC, RLC, PDCP, SDAP, RRC, and NAS functions. In a second example, the protocol processing circuitry may operate one or more IEEE-based protocols when the communication circuitry 1909 is WiFi communication system. In the second example, the protocol processing circuitry would operate WiFi MAC and LLC)functions. The protocol processing circuitry may include one or more memory structures (not shown) to store program code and data for operating the protocol functions, as well as one or more processing cores (not shown) to execute the program code and perform various operations using the data. The protocol processing circuitry provides control functions for the baseband circuitry 1910 and/or RF circuitry 1911 and 1912. The baseband circuitry 1910 may also support radio communications for more than one wireless protocol.

Continuing with the aforementioned embodiment, the baseband circuitry 1910 includes individual processing device(s) to implement PHY including HARQ functions, scrambling and/or descrambling, (en)coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, radio frequency shifting, and other related functions. etc. The modulation/demodulation functionality may include Fast-Fourier Transform (FFT), precoding, or constellation mapping/demapping functionality. The (en)coding/decoding functionality may include convolution, tail-biting convolution, turbo, Viterbi, or Low Density Parity Check (LDPC) coding. Embodiments of modulation/demodulation and encoder/decoder functionality are not limited to these examples and may include other suitable functionality in other embodiments.

The communication circuitry 1909 also includes RF circuitry 1911 and 1912 to enable communication with wireless networks using modulated electromagnetic radiation through a non-solid medium. Each of the RF circuitry 1911 and 1912 include a receive signal path, which may include circuitry to convert analog RF signals (e.g., an existing or received modulated waveform) into digital baseband signals to be provided to the baseband circuitry 1910. Each of the RF circuitry 1911 and 1912 also include a transmit signal path, which may include circuitry configured to convert digital baseband signals provided by the baseband circuitry 1910 to be converted into analog RF signals (e.g., modulated waveform) that will be amplified and transmitted via an antenna array including one or more antenna elements (not shown). The antenna array may be a plurality of microstrip antennas or printed antennas that are fabricated on the surface of one or more printed circuit boards. The antenna array may be formed in as a patch of metal foil (e.g., a patch antenna) in a variety of shapes, and may be coupled with the RF circuitry 1911 or 1912 using metal transmission lines or the like.

The RF circuitry 1911 (also referred to as a “mesh transceiver”) is used for communications with other mesh or fog devices 1964. The mesh transceiver 1911 may use any number of frequencies and protocols, such as 2.4 GHz transmissions under the IEEE 802.15.4 standard, using the Bluetooth® low energy (BLE) standard, as defined by the Bluetooth® Special Interest Group, or the ZigBee® standard, among others. Any number of RF circuitry 1911, configured for a particular wireless communication protocol, may be used for the connections to the mesh devices 1964. For example, a WLAN unit may be used to implement WiFi™ communications in accordance with the IEEE 802.11 standard. In addition, wireless wide area communications, for example, according to a cellular or other wireless wide area protocol, may occur via a WWAN unit.

The mesh transceiver 1911 may communicate using multiple standards or radios for communications at different ranges. For example, the platform 1900 may communicate with close/proximate devices, e.g., within about 10 meters, using a local transceiver based on BLE, or another low power radio, to save power. More distant mesh devices 1964, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

The RF circuitry 1912 (also referred to as a “wireless network transceiver,” a “cloud transceiver,” or the like) may be included to communicate with devices or services in the cloud 1901 via local or wide area network protocols. The wireless network transceiver 1912 includes one or more radios to communicate with devices in the cloud 1901. The cloud 1901 may be the same or similar to cloud 144 discussed previously. The wireless network transceiver 1912 may be a LPWA transceiver that follows the IEEE 802.15.4, or IEEE 802.15.4g standards, among others, such as those discussed herein. The platform 1900 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 1002.15.4e specification may be used.

Any number of other radio communications and protocols may be used in addition to the systems mentioned for the mesh transceiver 1911 and wireless network transceiver 1912, as described herein. For example, the radio transceivers 1911 and 1912 may include an LTE or other cellular transceiver that uses spread spectrum (SPA/SAS) communications for implementing high-speed communications. Further, any number of other protocols may be used, such as WiFi® networks for medium speed communications and provision of network communications.

The transceivers 1911 and 1912 may include radios that are compatible with, and/or may operate according to any one or more of the following radio communication technologies and/or standards including but not limited to those discussed herein.

Network interface circuitry/controller (NIC) 1916 may be included to provide wired communication to the cloud 1901 or to other devices, such as the mesh devices 1964 using a standard network interface protocol. The standard network interface protocol may include Ethernet, Ethernet over GRE Tunnels, Ethernet over Multiprotocol Label Switching (MPLS), Ethernet over USB, or may be based on other types of network protocols, such as Controller Area Network (CAN), Local Interconnect Network (LIN), DeviceNet, ControlNet, Data Highway+, PROFIBUS, or PROFINET, among many others. Network connectivity may be provided to/from the platform 1900 via NIC 1916 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The NIC 1916 may include one or more dedicated processors and/or FPGAs to communicate using one or more of the aforementioned network interface protocols. In some implementations, the NIC 1916 may include multiple controllers to provide connectivity to other networks using the same or different protocols. For example, the platform 1900 may include a first NIC 1916 providing communications to the cloud over Ethernet and a second NIC 1916 providing communications to other devices over another type of network.

The interconnect 1906 may couple the processor circuitry 1902 to an external interface 1918 (also referred to as “I/O interface circuitry” or the like) that is used to connect external devices or subsystems. The external devices include, inter alia, sensor circuitry 1921, actuators 1922, and positioning circuitry 1945.

The sensor circuitry 1921 may include devices, modules, or subsystems whose purpose is to detect events or changes in its environment and send the information (sensor data) about the detected events to some other a device, module, subsystem, etc. Examples of such sensors 1921 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; etc.

The external interface 1918 connects the platform 1900 to actuators 1922, allow platform 1900 to change its state, position, and/or orientation, or move or control a mechanism or system. The actuators 1922 comprise electrical and/or mechanical devices for moving or controlling a mechanism or system, and converts energy (e.g., electric current or moving air and/or liquid) into some kind of motion. The actuators 1922 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 1922 may include one or more electromechanical devices such as pneumatic actuators, hydraulic actuators, electromechanical switches including electromechanical relays (EMRs), motors (e.g., DC motors, stepper motors, servomechanisms, etc.), wheels, thrusters, propellers, claws, clamps, hooks, an audible sound generator, and/or other like electromechanical components. The platform 1900 may be configured to operate one or more actuators 1922 based on one or more captured events and/or instructions or control signals received from a service provider and/or various client systems.

The positioning circuitry 1945 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 1945 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 1945 may include a Micro-Technology for Positioning, Navigation, and Timing (Micro-PNT) IC that uses a master timing clock to perform position tracking/estimation without GNSS assistance. The positioning circuitry 1945 may also be part of, or interact with, the communication circuitry 1909 to communicate with the nodes and components of the positioning network. The positioning circuitry 1945 may also provide position data and/or time data to the application circuitry, which may use the data to synchronize operations with various infrastructure (e.g., radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation (e.g., EGNOS) and/or ground based positioning augmentation (e.g., DGPS).

In some implementations, the positioning circuitry 1945 is, or includes an INS, which is a system or device that uses sensor circuitry 1921 (e.g., motion sensors such as accelerometers, rotation sensors such as gyroscopes, and altimimeters, magentic sensors, and/or the like to continuously calculate (e.g., using dead by dead reckoning, triangulation, or the like) a position, orientation, and/or velocity (including direction and speed of movement) of the platform 1900 without the need for external references.

In some examples, various I/O devices may be present within, or connected to, the platform 1900, which are referred to as input device circuitry 1986 and output device circuitry 1984 in FIG. 19. The input device circuitry 1986 and output device circuitry 1984 include one or more user interfaces designed to enable user interaction with the platform 1900 and/or peripheral component interfaces designed to enable peripheral component interaction with the platform 1900. Input device circuitry 1986 may include any physical or virtual means for accepting an input including, inter alia, one or more physical or virtual buttons (e.g., a reset button), a physical keyboard, keypad, mouse, touchpad, touchscreen, microphones, scanner, headset, and/or the like.

The output device circuitry 1984 may be included to show information or otherwise convey information, such as sensor readings, actuator position(s), or other like information. Data and/or graphics may be displayed on one or more user interface components of the output device circuitry 1984. Output device circuitry 1984 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 1900. The output device circuitry 1984 may also include speakers or other audio emitting devices, printer(s), and/or the like. In some embodiments, the sensor circuitry 1921 may be used as the input device circuitry 1986 (e.g., an image capture device, motion capture device, or the like) and one or more actuators 1922 may be used as the output device circuitry 1984 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

A battery 1924 may be coupled to the platform 1900 to power the platform 1900, which may be used in embodiments where the platform 1900 is not in a fixed location. The battery 1924 may be a lithium ion battery, a lead-acid automotive battery, or a metal-air battery, such as a zinc-air battery, an aluminum-air battery, a lithium-air battery, a lithium polymer battery, and/or the like. In embodiments where the platform 1900 is mounted in a fixed location, the platform 1900 may have a power supply coupled to an electrical grid. In these embodiments, the platform 1900 may include power tee circuitry to provide for electrical power drawn from a network cable to provide both power supply and data connectivity to the platform 1900 using a single cable.

PMIC 1926 may be included in the platform 1900 to track the state of charge (SoCh) of the battery 1924, and to control charging of the platform 1900. The PMIC 1926 may be used to monitor other parameters of the battery 1924 to provide failure predictions, such as the state of health (SoH) and the state of function (SoF) of the battery 1924. The PMIC 1926 may include voltage regulators, surge protectors, power alarm detection circuitry. The power alarm detection circuitry may detect one or more of brown out (under-voltage) and surge (over-voltage) conditions. The PMIC 1926 may communicate the information on the battery 1924 to the processor circuitry 1902 over the interconnect 1906. The PMIC 1926 may also include an analog-to-digital (ADC) convertor that allows the processor circuitry 1902 to directly monitor the voltage of the battery 1924 or the current flow from the battery 1924. The battery parameters may be used to determine actions that the platform 1900 may perform, such as transmission frequency, mesh network operation, sensing frequency, and the like. As an example, the PMIC 1926 may be a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex.

A power block 1928, or other power supply coupled to a grid, may be coupled with the PMIC 1926 to charge the battery 1924. In some examples, the power block 1928 may be replaced with a wireless power receiver to obtain the power wirelessly, for example, through a loop antenna in the platform 1900. A wireless battery charging circuit, such as an LTC4020 chip from Linear Technologies of Milpitas, Calif., among others, may be included in the PMIC 1926. The specific charging circuits chosen depend on the size of the battery 1924, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

Terminology

The following terms and definitions may be applicable to certain examples and embodiments described throughout this disclosure. The terminology used herein is for the purpose of describing particular embodiments only and is not intended to be limiting of the disclosure.

As used herein, the singular forms “a,” “an” and “the” may include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” may refer to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an ASIC, a FPGA, PLD, CPLD, HCPLD, SoC, SiP, MCP, DSP, etc., that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” as used herein may refer to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” as used herein may refer to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data.

The term “computer-readable medium” may include, but is not limited to, memory, portable or fixed storage devices, optical storage devices, and various other mediums capable of storing, containing or carrying instructions or data.

The term “interface circuitry” as used herein may refer to, be part of, or include circuitry that enables the exchange of information between two or more components or devices. The term “interface circuitry” may refer to one or more hardware interfaces, for example, buses, I/O interfaces, peripheral component interfaces, network interface cards, and/or the like.

The term “computer system” as used herein may refer to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “architecture” as used herein may refer to a computer architecture or a network architecture. A “network architecture” may refer to a physical and logical design or arrangement of software and/or hardware elements in a network including communication protocols, interfaces, and media transmission. A “computer architecture” may refer to a physical and logical design or arrangement of software and/or hardware elements in a computing system or platform including technology standards for interactions therebetween.

The term “appliance,” “computer appliance,” or the like, as used herein may refer to a computer device or computer system with program code (e.g., software or firmware) that is specifically designed to provide a specific computing resource. A “virtual appliance” may refer to a virtual machine image to be implemented by a hypervisor-equipped device that virtualizes or emulates a computer appliance or otherwise is dedicated to provide a specific computing resource.

The term “cloud computing,” “cloud service,” or “cloud” may refer to a paradigm for enabling network access to a scalable and elastic pool of shareable computing resources with self-service provisioning and administration on-demand and without active management by users. Cloud computing may provide cloud computing services (or cloud services), which may include one or more capabilities offered via cloud computing that are invoked using a defined interface (e.g., an API or the like).

The term “computing resource” or simply “resource” may refer to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “edge computing” may refer to a distributed computing paradigm where computing processes and/or workloads is/are allocated to computing instances and data storage located at (or closer to) the network edge in order to provide desired service levels, for example, by improving response times and/or to conserve bandwidth. The “edge” of the communication network refers to the outermost part of a communication network that a client or user equipment connects to, which may include the client or user equipment itself. The edge of a network, or “network edge” may also refer to one or more locations within a network domain in close adjacency to the source of the data producer/consumer.

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes an edge computing device for performing decision tree training and inference, comprising: interface circuitry to: receive training data corresponding to a plurality of labeled instances of a feature set, wherein the training data is captured at least partially by one or more sensors; and receive inference data corresponding to an unlabeled instance of the feature set, wherein the inference data is captured at least partially by the one or more sensors; and processing circuitry to: compute, based on the training data, a set of feature value checkpoints for training a decision tree model, wherein the set of feature value checkpoints is to indicate, for each feature of the feature set, a subset of potential feature values to be evaluated for splitting tree nodes of the decision tree model; train the decision tree model based on the training data and the set of feature value checkpoints, wherein the decision tree model is to be trained to predict a target variable corresponding to the feature set; and perform inference using the decision tree model to predict the target variable for the unlabeled instance of the feature set.

Example 2 includes the edge computing device of Example 1, wherein: the decision tree model is to be trained to predict failures associated with the edge computing device; and the target variable is to indicate whether a failure is predicted for the edge computing device.

Example 3 includes the edge computing device of Example 1, wherein the processing circuitry to compute, based on the training data, the set of feature value checkpoints for training the decision tree model is further to: for each feature of the feature set: determine an optimal bin size for binning a set of feature values contained in the training data for a corresponding feature of the feature set; bin the set of feature values into a plurality of bins based on the optimal bin size; and identify feature value checkpoints for the corresponding feature based on the plurality of bins.

Example 4 includes the edge computing device of Example 3, wherein the processing circuitry to determine the optimal bin size for binning the set of feature values contained in the training data for the corresponding feature of the feature set is further to: identify a plurality of possible bin sizes for binning the set of feature values; compute a plurality of performance costs for the plurality of possible bin sizes; and select the optimal bin size from the plurality of possible bin sizes, wherein the optimal bin size corresponds to a lowest performance cost of the plurality of performance costs.

Example 5 includes the edge computing device of Example 1, wherein: the decision tree model comprises a random forest model, wherein the random forest model comprises a plurality of decision trees; and the processing circuitry to train the decision tree model based on the training data and the set of feature value checkpoints is further to: generate the plurality of decision trees for the random forest model based on the training data and the set of feature value checkpoints.

Example 6 includes the edge computing device of Example 5, wherein the processing circuitry to generate the plurality of decision trees for the random forest model based on the training data and the set of feature value checkpoints is further to: extract, from the training data, a random training sample for generating a first decision tree of the plurality of decision trees; generate a root node for the first decision tree based on the random training sample; select, from the feature set, a random subset of features to be evaluated for splitting the root node; obtain, from the set of feature value checkpoints, a subset of feature value checkpoints for the random subset of features; compute a plurality of impurity values for the subset of feature value checkpoints; select, from the subset of feature value checkpoints, a corresponding feature value for splitting the root node, wherein the corresponding feature value is selected based on the plurality of impurity values; and split the root node into a set of child nodes based on the corresponding feature value.

Example 7 includes the edge computing device of Example 6, wherein the plurality of impurity values comprises a plurality of Gini indexes.

Example 8 includes the edge computing device of Example 1, wherein the processing circuitry comprises: a host processor to: compute, based on the training data, the set of feature value checkpoints for training the decision tree model; and an artificial intelligence accelerator to: train the decision tree model based on the training data and the set of feature value checkpoints; and perform inference using the decision tree model to predict the target variable for the unlabeled instance of the feature set.

Example 9 includes the edge computing device of Example 8, wherein the artificial intelligence accelerator is implemented on a field-programmable gate array of the edge computing device.

Example 10 includes an artificial intelligence accelerator to perform decision tree training and inference for a host processor, comprising: a host interface to communicate with the host processor; and processing circuitry to: receive, from the host processor via the host interface, training data corresponding to a plurality of labeled instances of a feature set, wherein the training data is captured at least partially by one or more sensors; receive, from the host processor via the host interface, a set of feature value checkpoints corresponding to the training data, wherein the set of feature value checkpoints is for training a decision tree model, and wherein the set of feature value checkpoints is to indicate, for each feature of the feature set, a subset of potential feature values to be evaluated for splitting tree nodes of the decision tree model; train the decision tree model based on the training data and the set of feature value checkpoints, wherein the decision tree model is to be trained to predict a target variable corresponding to the feature set; receive, from the host processor via the host interface, inference data corresponding to an unlabeled instance of the feature set, wherein the inference data is captured at least partially by the one or more sensors; perform inference using the decision tree model to generate a predicted value of the target variable for the unlabeled instance of the feature set; and send, to the host processor via the host interface, the predicted value of the target variable for the unlabeled instance of the feature set.

Example 11 includes the artificial intelligence accelerator of Example 10, wherein: the decision tree model is to be trained to predict failures associated with an edge computing device; and the target variable is to indicate whether a failure is predicted for the edge computing device.

Example 12 includes the artificial intelligence accelerator of Example 10, wherein the set of feature value checkpoints is computed by the host processor based on binning a set of feature values for each feature of the feature set using an optimal bin size.

Example 13 includes the artificial intelligence accelerator of Example 10, wherein: the decision tree model comprises a random forest model, wherein the random forest model comprises a plurality of decision trees; and the processing circuitry to train the decision tree model based on the training data and the set of feature value checkpoints is further to: generate the plurality of decision trees for the random forest model based on the training data and the set of feature value checkpoints.

Example 14 includes the artificial intelligence accelerator of Example 13, wherein the processing circuitry to generate the plurality of decision trees for the random forest model based on the training data and the set of feature value checkpoints is further to: extract, from the training data, a random training sample for generating a first decision tree of the plurality of decision trees; generate a root node for the first decision tree based on the random training sample; select, from the feature set, a random subset of features to be evaluated for splitting the root node; obtain, from the set of feature value checkpoints, a subset of feature value checkpoints for the random subset of features; compute a plurality of impurity values for the subset of feature value checkpoints; select, from the subset of feature value checkpoints, a corresponding feature value for splitting the root node, wherein the corresponding feature value is selected based on the plurality of impurity values; and split the root node into a set of child nodes based on the corresponding feature value.

Example 15 includes the artificial intelligence accelerator of Example 14, wherein the plurality of impurity values comprises a plurality of Gini indexes.

Example 16 includes at least one non-transitory machine-readable storage medium having instructions stored thereon, wherein the instructions, when executed on processing circuitry, cause the processing circuitry to: receive, via interface circuitry, training data corresponding to a plurality of labeled instances of a feature set, wherein the training data is captured at least partially by one or more sensors; compute, based on the training data, a set of feature value checkpoints for training a decision tree model, wherein the set of feature value checkpoints is to indicate, for each feature of the feature set, a subset of potential feature values to be evaluated for splitting tree nodes of the decision tree model; train the decision tree model based on the training data and the set of feature value checkpoints, wherein the decision tree model is to be trained to predict a target variable corresponding to the feature set; receive, via the interface circuitry, inference data corresponding to an unlabeled instance of the feature set, wherein the inference data is captured at least partially by the one or more sensors; and perform inference using the decision tree model to predict the target variable for the unlabeled instance of the feature set.

Example 17 includes the storage medium of Example 16, wherein: the decision tree model is to be trained to predict failures associated with an edge computing device; and the target variable is to indicate whether a failure is predicted for the edge computing device.

Example 18 includes the storage medium of Example 16, wherein the instructions that cause the processing circuitry to compute, based on the training data, the set of feature value checkpoints for training the decision tree model further cause the processing circuitry to: for each feature of the feature set: determine an optimal bin size for binning a set of feature values contained in the training data for a corresponding feature of the feature set; bin the set of feature values into a plurality of bins based on the optimal bin size; and identify feature value checkpoints for the corresponding feature based on the plurality of bins.

Example 19 includes the storage medium of Example 18, wherein the instructions that cause the processing circuitry to determine the optimal bin size for binning the set of feature values contained in the training data for the corresponding feature of the feature set further cause the processing circuitry to: identify a plurality of possible bin sizes for binning the set of feature values; compute a plurality of performance costs for the plurality of possible bin sizes; and select the optimal bin size from the plurality of possible bin sizes, wherein the optimal bin size corresponds to a lowest performance cost of the plurality of performance costs.

Example 20 includes the storage medium of Example 16, wherein: the decision tree model comprises a random forest model, wherein the random forest model comprises a plurality of decision trees; and the instructions that cause the processing circuitry to train the decision tree model based on the training data and the set of feature value checkpoints further cause the processing circuitry to: generate the plurality of decision trees for the random forest model based on the training data and the set of feature value checkpoints.

Example 21 includes the storage medium of Example 20, wherein the instructions that cause the processing circuitry to generate the plurality of decision trees for the random forest model based on the training data and the set of feature value checkpoints further cause the processing circuitry to: extract, from the training data, a random training sample for generating a first decision tree of the plurality of decision trees; generate a root node for the first decision tree based on the random training sample; select, from the feature set, a random subset of features to be evaluated for splitting the root node; obtain, from the set of feature value checkpoints, a subset of feature value checkpoints for the random subset of features; compute a plurality of impurity values for the subset of feature value checkpoints; select, from the subset of feature value checkpoints, a corresponding feature value for splitting the root node, wherein the corresponding feature value is selected based on the plurality of impurity values; and split the root node into a set of child nodes based on the corresponding feature value.

Example 22 includes the storage medium of Example 21, wherein the plurality of impurity values comprises a plurality of Gini indexes.

Example 23 includes a method of performing decision tree training and inference on an edge computing device, comprising: receiving, via interface circuitry, training data corresponding to a plurality of labeled instances of a feature set, wherein the training data is captured at least partially by one or more sensors; computing, based on the training data, a set of feature value checkpoints for training a decision tree model, wherein the set of feature value checkpoints is to indicate, for each feature of the feature set, a subset of potential feature values to be evaluated for splitting tree nodes of the decision tree model; training the decision tree model based on the training data and the set of feature value checkpoints, wherein the decision tree model is to be trained to predict a target variable corresponding to the feature set; receiving, via the interface circuitry, inference data corresponding to an unlabeled instance of the feature set, wherein the inference data is captured at least partially by the one or more sensors; and performing inference using the decision tree model to predict the target variable for the unlabeled instance of the feature set.

Example 24 includes the method of Example 23, wherein computing, based on the training data, the set of feature value checkpoints for training the decision tree model comprises: for each feature of the feature set: determining an optimal bin size for binning a set of feature values contained in the training data for a corresponding feature of the feature set; binning the set of feature values into a plurality of bins based on the optimal bin size; and identifying feature value checkpoints for the corresponding feature based on the plurality of bins.

Example 25 includes the method of Example 24, wherein determining the optimal bin size for binning the set of feature values contained in the training data for the corresponding feature of the feature set comprises: identifying a plurality of possible bin sizes for binning the set of feature values; computing a plurality of performance costs for the plurality of possible bin sizes; and selecting the optimal bin size from the plurality of possible bin sizes, wherein the optimal bin size corresponds to a lowest performance cost of the plurality of performance costs.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. An edge computing device for performing decision tree training and inference, comprising:
interface circuitry to:
receive training data corresponding to a plurality of labeled instances of a feature set, wherein the training data is captured at least partially by one or more sensors; and
receive inference data corresponding to an unlabeled instance of the feature set, wherein the inference data is captured at least partially by the one or more sensors; and
processing circuitry to:
compute, based on the training data, a set of feature value checkpoints for training a decision tree model, wherein the set of feature value checkpoints is to indicate, for each feature of the feature set, a subset of potential feature values to be evaluated for splitting tree nodes of the decision tree model;
train the decision tree model based on the training data and the set of feature value checkpoints, wherein the decision tree model is to be trained to predict a target variable corresponding to the feature set; and
perform inference using the decision tree model to predict the target variable for the unlabeled instance of the feature set.

2. The edge computing device of claim 1, wherein:
the decision tree model is to be trained to predict failures associated with the edge computing device; and
the target variable is to indicate whether a failure is predicted for the edge computing device.

3. The edge computing device of claim 1, wherein the processing circuitry to compute, based on the training data, the set of feature value checkpoints for training the decision tree model is further to:
for each feature of the feature set:
determine an optimal bin size for binning a set of feature values contained in the training data for a corresponding feature of the feature set;
bin the set of feature values into a plurality of bins based on the optimal bin size; and
identify feature value checkpoints for the corresponding feature based on the plurality of bins.

4. The edge computing device of claim 3, wherein the processing circuitry to determine the optimal bin size for binning the set of feature values contained in the training data for the corresponding feature of the feature set is further to:
identify a plurality of possible bin sizes for binning the set of feature values;
compute a plurality of performance costs for the plurality of possible bin sizes; and
select the optimal bin size from the plurality of possible bin sizes, wherein the optimal bin size corresponds to a lowest performance cost of the plurality of performance costs.

5. The edge computing device of claim 1, wherein:
the decision tree model comprises a random forest model, wherein the random forest model comprises a plurality of decision trees; and
the processing circuitry to train the decision tree model based on the training data and the set of feature value checkpoints is further to:
generate the plurality of decision trees for the random forest model based on the training data and the set of feature value checkpoints.

6. The edge computing device of claim 5, wherein the processing circuitry to generate the plurality of decision trees for the random forest model based on the training data and the set of feature value checkpoints is further to:
extract, from the training data, a random training sample for generating a first decision tree of the plurality of decision trees;
generate a root node for the first decision tree based on the random training sample;
select, from the feature set, a random subset of features to be evaluated for splitting the root node;
obtain, from the set of feature value checkpoints, a subset of feature value checkpoints for the random subset of features;
compute a plurality of impurity values for the subset of feature value checkpoints;
select, from the subset of feature value checkpoints, a corresponding feature value for splitting the root node, wherein the corresponding feature value is selected based on the plurality of impurity values; and
split the root node into a set of child nodes based on the corresponding feature value.

7. The edge computing device of claim 6, wherein the plurality of impurity values comprises a plurality of Gini indexes.

8. The edge computing device of claim 1, wherein the processing circuitry comprises:
a host processor to:
compute, based on the training data, the set of feature value checkpoints for training the decision tree model; and
an artificial intelligence accelerator to:
train the decision tree model based on the training data and the set of feature value checkpoints; and
perform inference using the decision tree model to predict the target variable for the unlabeled instance of the feature set.

9. The edge computing device of claim 8, wherein the artificial intelligence accelerator is implemented on a field-programmable gate array of the edge computing device.

10. An artificial intelligence accelerator to perform decision tree training and inference for a host processor, comprising:
a host interface to communicate with the host processor; and
processing circuitry to:
receive, from the host processor via the host interface, training data corresponding to a plurality of labeled instances of a feature set, wherein the training data is captured at least partially by one or more sensors;
receive, from the host processor via the host interface, a set of feature value checkpoints corresponding to the training data, wherein the set of feature value checkpoints is for training a decision tree model, and wherein the set of feature value checkpoints is to indicate, for each feature of the feature set, a subset of potential feature values to be evaluated for splitting tree nodes of the decision tree model;
train the decision tree model based on the training data and the set of feature value checkpoints, wherein the decision tree model is to be trained to predict a target variable corresponding to the feature set;
receive, from the host processor via the host interface, inference data corresponding to an unlabeled instance of the feature set, wherein the inference data is captured at least partially by the one or more sensors;
perform inference using the decision tree model to generate a predicted value of the target variable for the unlabeled instance of the feature set; and
send, to the host processor via the host interface, the predicted value of the target variable for the unlabeled instance of the feature set.

11. The artificial intelligence accelerator of claim 10, wherein:
the decision tree model is to be trained to predict failures associated with an edge computing device; and
the target variable is to indicate whether a failure is predicted for the edge computing device.

12. The artificial intelligence accelerator of claim 10, wherein the set of feature value checkpoints is computed by the host processor based on binning a set of feature values for each feature of the feature set using an optimal bin size.

13. The artificial intelligence accelerator of claim 10, wherein:
the decision tree model comprises a random forest model, wherein the random forest model comprises a plurality of decision trees; and
the processing circuitry to train the decision tree model based on the training data and the set of feature value checkpoints is further to:
generate the plurality of decision trees for the random forest model based on the training data and the set of feature value checkpoints.

14. The artificial intelligence accelerator of claim 13, wherein the processing circuitry to generate the plurality of decision trees for the random forest model based on the training data and the set of feature value checkpoints is further to:
extract, from the training data, a random training sample for generating a first decision tree of the plurality of decision trees;
generate a root node for the first decision tree based on the random training sample;
select, from the feature set, a random subset of features to be evaluated for splitting the root node;
obtain, from the set of feature value checkpoints, a subset of feature value checkpoints for the random subset of features;
compute a plurality of impurity values for the subset of feature value checkpoints;
select, from the subset of feature value checkpoints, a corresponding feature value for splitting the root node, wherein the corresponding feature value is selected based on the plurality of impurity values; and
split the root node into a set of child nodes based on the corresponding feature value.

15. The artificial intelligence accelerator of claim 14, wherein the plurality of impurity values comprises a plurality of Gini indexes.

16. At least one non-transitory machine-readable storage medium having instructions stored thereon, wherein the instructions, when executed on processing circuitry, cause the processing circuitry to:
receive, via interface circuitry, training data corresponding to a plurality of labeled instances of a feature set, wherein the training data is captured at least partially by one or more sensors;
compute, based on the training data, a set of feature value checkpoints for training a decision tree model, wherein the set of feature value checkpoints is to indicate, for each feature of the feature set, a subset of potential feature values to be evaluated for splitting tree nodes of the decision tree model;
train the decision tree model based on the training data and the set of feature value checkpoints, wherein the decision tree model is to be trained to predict a target variable corresponding to the feature set;
receive, via the interface circuitry, inference data corresponding to an unlabeled instance of the feature set, wherein the inference data is captured at least partially by the one or more sensors; and
perform inference using the decision tree model to predict the target variable for the unlabeled instance of the feature set.

17. The storage medium of claim 16, wherein:
the decision tree model is to be trained to predict failures associated with an edge computing device; and
the target variable is to indicate whether a failure is predicted for the edge computing device.

18. The storage medium of claim 16, wherein the instructions that cause the processing circuitry to compute, based on the training data, the set of feature value checkpoints for training the decision tree model further cause the processing circuitry to:
for each feature of the feature set:
determine an optimal bin size for binning a set of feature values contained in the training data for a corresponding feature of the feature set;
bin the set of feature values into a plurality of bins based on the optimal bin size; and
identify feature value checkpoints for the corresponding feature based on the plurality of bins.

19. The storage medium of claim 18, wherein the instructions that cause the processing circuitry to determine the optimal bin size for binning the set of feature values contained in the training data for the corresponding feature of the feature set further cause the processing circuitry to:
identify a plurality of possible bin sizes for binning the set of feature values;
compute a plurality of performance costs for the plurality of possible bin sizes; and
select the optimal bin size from the plurality of possible bin sizes, wherein the optimal bin size corresponds to a lowest performance cost of the plurality of performance costs.

20. The storage medium of claim 16, wherein:
the decision tree model comprises a random forest model, wherein the random forest model comprises a plurality of decision trees; and
the instructions that cause the processing circuitry to train the decision tree model based on the training data and the set of feature value checkpoints further cause the processing circuitry to:
generate the plurality of decision trees for the random forest model based on the training data and the set of feature value checkpoints.

21. The storage medium of claim 20, wherein the instructions that cause the processing circuitry to generate the plurality of decision trees for the random forest model based on the training data and the set of feature value checkpoints further cause the processing circuitry to:
extract, from the training data, a random training sample for generating a first decision tree of the plurality of decision trees;
generate a root node for the first decision tree based on the random training sample;
select, from the feature set, a random subset of features to be evaluated for splitting the root node;
obtain, from the set of feature value checkpoints, a subset of feature value checkpoints for the random subset of features;
compute a plurality of impurity values for the subset of feature value checkpoints;
select, from the subset of feature value checkpoints, a corresponding feature value for splitting the root node, wherein the corresponding feature value is selected based on the plurality of impurity values; and
split the root node into a set of child nodes based on the corresponding feature value.

22. The storage medium of claim 21, wherein the plurality of impurity values comprises a plurality of Gini indexes.

23. A method of performing decision tree training and inference on an edge computing device, comprising:
receiving, via interface circuitry, training data corresponding to a plurality of labeled instances of a feature set, wherein the training data is captured at least partially by one or more sensors;
computing, based on the training data, a set of feature value checkpoints for training a decision tree model, wherein the set of feature value checkpoints is to indicate, for each feature of the feature set, a subset of potential feature values to be evaluated for splitting tree nodes of the decision tree model;
training the decision tree model based on the training data and the set of feature value checkpoints, wherein the decision tree model is to be trained to predict a target variable corresponding to the feature set;
receiving, via the interface circuitry, inference data corresponding to an unlabeled instance of the feature set, wherein the inference data is captured at least partially by the one or more sensors; and
performing inference using the decision tree model to predict the target variable for the unlabeled instance of the feature set.

24. The method of claim 23, wherein computing, based on the training data, the set of feature value checkpoints for training the decision tree model comprises:
for each feature of the feature set:
determining an optimal bin size for binning a set of feature values contained in the training data for a corresponding feature of the feature set;
binning the set of feature values into a plurality of bins based on the optimal bin size; and
identifying feature value checkpoints for the corresponding feature based on the plurality of bins.

25. The method of claim 24, wherein determining the optimal bin size for binning the set of feature values contained in the training data for the corresponding feature of the feature set comprises:
identifying a plurality of possible bin sizes for binning the set of feature values;
computing a plurality of performance costs for the plurality of possible bin sizes; and
selecting the optimal bin size from the plurality of possible bin sizes, wherein the optimal bin size corresponds to a lowest performance cost of the plurality of performance costs.
